(19) United States
(12) Patent Application Publication
(10) Pub. No.: US 2004/0264767 A1
(43) Pub. Date: Dec. 30, 2004

(54) Image processing

(75) Inventor: Daniel Pettigrew, Pacific Palisades, CA (US)

Correspondence Address: GATES & COOPER LLP, HOWARD HUGHES CENTER, 6701 CENTER DRIVE WEST, SUITE 1050, LOS ANGELES, CA, 90045, US

(73) Assignee: Autodesk Canada Inc., Montreal (CA)

(21) Appl. No.: 10/818,123

(22) Filed: Apr. 5, 2004

(30) Foreign Application Priority Data
Apr. 5, 2003 (GB) GB0307950.6

(51) Int. Cl. G06K 9/00; G06K 9/40

(52) U.S. Cl. 382/162; 382/254

(57) ABSTRACT

A method, apparatus, and article of manufacture provide the ability to process three-dimensional image data. A color transformation to be applied to image data is received from the user and concatenated with previous transformations. The concatenated transformations are applied to pixel values for the image data. Thereafter, the values of various parameters are evaluated to obtain and display updated pixel values. A matte may also be extracted and/or defined. For example, a reference color and various parameters may be obtained and used to calculate a transformation that transforms the reference color to an specified point (e.g., an origin) of the 3D space. The transformation may then be applied to each pixel so that each pixel is assigned a matte value according to its transformed values (and selected parameters), and therefore according to its position with respect to the specified reference color.

### CROSS-REFERENCE TO RELATED APPLICATIONS

This application claims the benefit under 35 U.S.C. §119 of the following co-pending and commonly assigned foreign patent application, which application is incorporated by reference herein:

United Kingdom Application No. 03 07 950.6, entitled “IMAGE PROCESSING”, by Daniel Pettigrew, filed on Apr. 5, 2003.

### FIELD OF THE INVENTION

The invention relates to producing and adjusting a matte of a foreground image and a composite of the foreground image and a background image.

### DESCRIPTION OF THE RELATED ART

Methods of producing a matte and using it to composite two images together are known. The process is usually referred to as keying. However, they usually involve creating a complex shape around a set of points and for each pixel deciding whether it is inside or outside the shape. It is an object of the present invention to transforming pixel colors such that simple measurements can be taken to produce a matte value. It is a further object to allow easy adjustments to be made to the matte and also allow the creation of patches, the removal of blue spill or balancing of the edges, also using simple measurements.

Additionally, color warpers are known for use before the matte extraction that allow the foreground and background images to be matched. However, many of these do not allow a user to return an image to its pre-warped state simply by resetting the parameter controls. It is an object of the present invention to provide this functionality.

### BRIEF SUMMARY OF THE INVENTION

According to aspects of the invention, there is provided a color warper, a process for matte extraction and processes for adjusting said matte and processes for adjusting the color of composited image data.

### BRIEF DESCRIPTION OF THE SEVERAL VIEWS OF THE DRAWINGS

FIG. 1 illustrates an image processing environment;

FIG. 2 shows an image processing system illustrated in FIG. 1;

FIG. 3 shows the steps carried out by the user of the processing system shown in FIG. 2 to load and edit image data;

FIG. 4 is a representation of an application embodying the present invention;

FIG. 5 shows steps carried out during FIG. 3 to edit image data;

FIG. 6 illustrates a graphical user interface (GUI) displayed on the VDU shown in FIG. 1 that allows the user color warp images loaded during FIG. 3;

FIG. 7 details steps carried out during FIG. 5 to color warp an image;

FIG. 8 details steps carried out during FIG. 7 to retrieve a transform matrix;

FIG. 9 details steps carried out in FIG. 8 to evaluate the white and black level of an initial matrix;

FIG. 10 details steps carried out in FIG. 8 to obtain a transform matrix for parameters black level and white level;

FIG. 11 shows matrices used during FIG. 10;

FIG. 12 details steps carried out in FIG. 8 to retrieve a transform matrix for the parameters white and black balance;

FIG. 13 shows matrices used during steps carried out in FIG. 12;

FIG. 14 details steps carried out in FIG. 8 to obtain a transform matrix for the parameters saturation and hue shift;

FIG. 15 shows matrices used during steps carried out in FIG. 14;

FIG. 16 details steps carried out during FIG. 7 to calculate and display results of applying a color warp to an image;

FIG. 17 details carried out in FIG. 7 to evaluate the current parameter levels;

FIG. 18 details steps carried out during FIG. 17 to evaluate black balance, black level, white balance and white level parameters;

FIG. 19 details steps carried during FIG. 17 to evaluate saturation and hue shift levels;

FIG. 20 shows a matrix used during steps carried out in FIG. 19;

FIG. 21 shows steps carried out during FIG. 5 to extract a matte from a foreground image and use it to composite the foreground image and a background image;

FIG. 22 illustrates a GUI displayed on the VDU shown in FIG. 1 to allow a user to specify parameters for steps carried out in FIG. 21;

FIG. 23 illustrates a co-ordinate system in which colors may be compared with a reference color in order to extract a matte;

FIG. 24 shows the composition of a matrix used to obtain the transformation shown in FIG. 23;

FIG. 25 details steps carried out during FIG. 21 to obtain values used in the matrices-shown in FIG. 24;

FIG. 26 details steps carried out during FIG. 21 to display a matte and a composite image;

FIG. 27 details steps carried out during FIG. 26 to obtain a matte value for a pixel;

FIG. 28 details steps carried out during FIG. 27 to obtain a first value required for a pixel's matte value;

FIG. 29 details steps carried out during FIG. 27 to obtain a second value used to calculate a pixel's matte value;

FIG. 30 details steps carried out during FIG. 27 to obtain a third value used to calculate a pixel's matte value;

FIG. 31 illustrates the GUI shown in FIG. 22 with a matte calculated and displayed;

FIG. 32 illustrates the GUI shown in FIG. 22 with a composite image calculated and displayed;

FIG. 33 details steps carried out during FIG. 21 to allow adjustments to the parameters used to extract a matte;

FIG. 34 details steps carried out during FIG. 33 to automatically select parameters having a high impact on a selected pixel;

FIG. 35 details steps carried out during FIG. 34 to assign an impact index to a parameter;

FIG. 36 details steps carried our during FIG. 35 to select a frontier associated with an impact index;

FIG. 37 details steps carried out during FIG. 35 to determine whether an impact index should be entered in one of a first two parameter arrays;

FIG. 38 details steps carried out during FIG. 35 to decide whether an impact index should be entered in one of a second four parameter arrays;

FIG. 39 details steps carried out during FIG. 35 to decide whether an impact index should be entered in one of a final two parameter arrays;

FIG. 40 details steps carried-out during FIG. 34 to select the two parameters having the highest impact index;

FIG. 41 details steps carried out during FIG. 40 to select a first parameter;

FIG. 42 details steps carried out during FIG. 40 to select a second parameter;

FIG. 43 details steps carried out during FIG. 42 to check a set of parameters for an impact index;

FIG. 44 details steps carried out during FIG. 34 to automatically adjust selected parameters in response to movement of the stylus shown in

FIG. 45 details steps carried out during FIG. 5 to apply a patch to the matte extracted during FIG. 21;

FIG. 46 illustrates a GUI displayed on the VDU shown in FIG. 1 that allows the user to specify patches for use during FIG. 45;

FIG. 47 details steps carried out during FIG. 45 to define a patch;

FIG. 48 details steps carried out during FIG. 47 to calculate a matrix required during further steps in FIG. 47;

FIG. 49 details steps carried out during FIG. 47 to automatically select a type of path;

FIG. 50 details steps carried out during FIG. 49 to obtain a distance from a reference color for a pixel in a selected region;

FIG. 51 illustrates a minimal volume used during FIG. 45;

FIG. 52 details steps carried out during FIG. 47 to obtain a matrix used during steps carried out in FIG. 45;

FIG. 53 details steps carried out during FIG. 52 to reorientate the matrix obtained from steps carried out in FIG. 48;

FIG. 54 shows matrices used during steps carried out in FIG. 53;

FIG. 55 details steps carried out during FIG. 52 to use the matrix reorientated during steps carried out in FIG. 53 to obtain the required matrix;

FIG. 56 shows matrices used during steps carried out in FIG. 55;

FIG. 57 details steps carried out during FIG. 45 to adjust the matte according to a patch defined during steps carried out in FIG. 47;

FIG. 58 details steps carried out during FIG. 57 to determine whether a pixel should have a patch applied to it or not;

FIG. 59 details steps carried out during FIG. 5 to apply edge balancing to the matte and composite image obtained during FIG. 21;

FIG. 60 illustrates a GUI displayed on the VDU shown in FIG. 21 that allows the user to specify parameters for the edge balancing carried out during FIG. 59;

FIG. 61 illustrates a co-ordinate system in which colors may be compared with a reference color in order to perform edge balancing;

FIG. 62 illustrates a second example of the co-ordinate system shown in FIG. 61;

FIG. 63 shows the construction of a matrix required to obtain the co-ordinate system shown in FIGS. 61 and 62;

FIG. 64 details steps carried out during FIG. 59 to obtain further parameters required for the matrix shown in FIG. 63;

FIG. 65 details steps carried out during FIG. 64 to set a frontier;

FIG. 66 details steps carried out FIG. 59 to perform the edge balancing;

FIG. 67 details steps carried out during FIG. 56 to determine the amount of edge balancing to be applied to a pixel;

FIG. 68 shows a matrix used during steps carried out in FIG. 67;

FIG. 69 illustrates the effect of blue spill removal on pixels in foreground image; and

FIG. 70 illustrates the effect of luminance edge balancing on pixels in the foreground image.

### WRITTEN DESCRIPTION OF THE BEST MODE FOR CARRYING OUT THE INVENTION

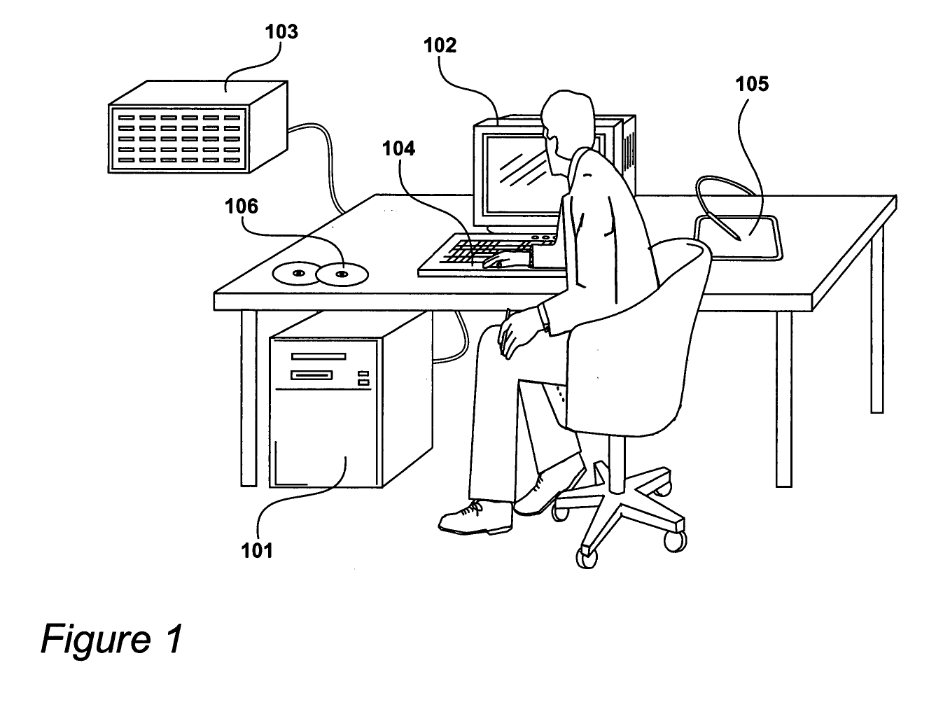

FIG. 1

An example of apparatus according to the present invention is shown in FIG. 1 which illustrates an image processing environment, such as an online editing station. A processing system 101, in this example an Octane™ produced by Silicon Graphics Inc., supplies image signals to a video display unit (VDU) 102. Image data is stored on a redundant array of inexpensive disks (RAID) 103. The RAID is configured in such a way as to store a large volume of data, and to supply this data to processing system 102, when required, at a high bandwidth. The operator controls the image processing environment formed by the processing system 101, the VDU 102 and the RAID 103 by means of a keyboard 104 and a stylus-operated graphics tablet 105. The environment shown in FIG. 1 is optimal for the purpose of processing image and other high-bandwidth data.

Instructions controlling the processing system 101 may be installed from a physical medium such as a CD-ROM disk 106, or over a network, including the Internet. These instructions enable the processing system 101 to interpret user commands from the keyboard 104 and the graphics tablet 105 such that data may be viewed, edited and processed.

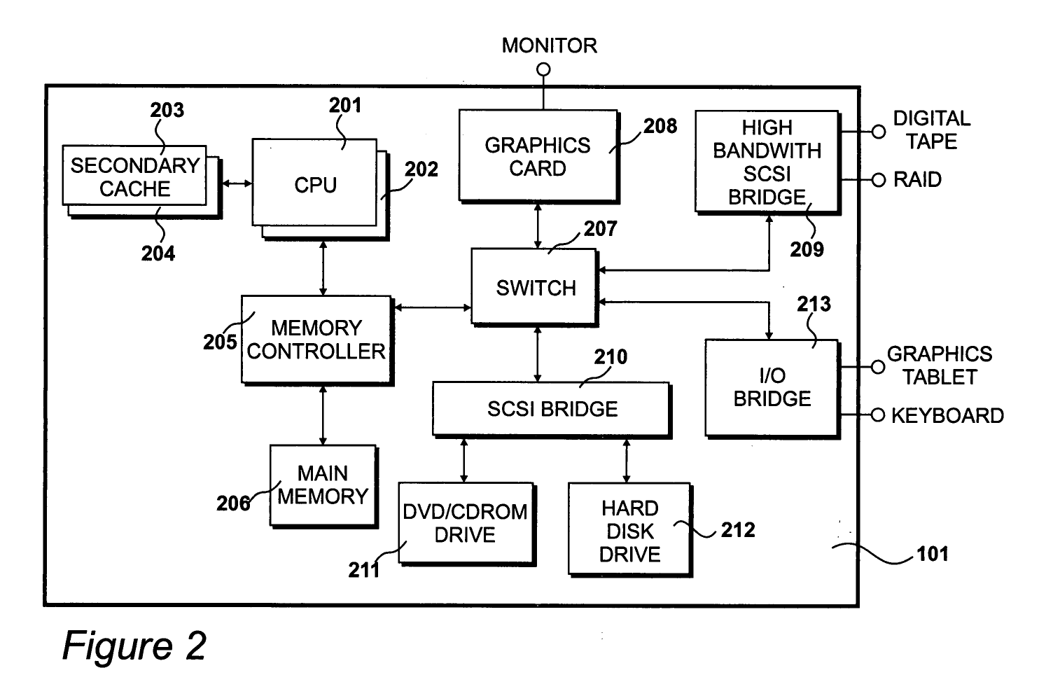

FIG. 2

The processing system 101 shown in FIG. 1 is detailed in FIG. 2. The processing system comprises two central processing units (CPUs) 201 and 202 operating in parallel. Each of these processors is a MIPS R11000 manufactured by MIPS Technologies Incorporated, of Mountain View, Calif. Each of these CPUs 201 and 202 has a dedicated secondary cache memory 203 and 204 that facilitates per-CPU storage of frequently used instructions and data. Each CPU 201 and 202 further includes separate primary instruction and data cache memory circuits on the same chip, thereby facilitating a further level of processing improvement. A memory controller 205 provides a common connection between the CPUs 201 and 202 and a main memory 206. The main memory 206 comprises two gigabytes of dynamic RAM.

The memory controller 205 further facilitates connectivity between the aforementioned components of the processing system 101 and a high bandwidth non-blocking crossbar switch 207. The switch makes it possible to provide a direct high capacity connection between any of several attached circuits. These include a graphics card 208. The graphics card 208 generally receives instructions from the CPUs 201 and 202 to perform various types of graphical image rendering processes, resulting in images, clips and scenes being rendered in real time on the monitor 102. A high bandwidth SCSI bridge 209 provides an interface to the RAID 103, and also, optionally, to a digital tape device, for use as backup.

A second SCSI bridge 210 facilitates connection between the crossbar switch 207 and a DVD/CD-ROM drive 211. The CD-ROM drive provides a convenient way of receiving large quantities of instructions and data, and is typically used to install instructions for the processing system 101 onto a hard disk drive 212. Once installed, instructions located on the hard disk drive 212 may be fetched into main memory 206 and then executed by the CPUs 201 and 202. An input/output bridge 213 provides an interface for the graphics tablet 105 and the keyboard 104, through which the user is able to provide instructions to the processing system 101.

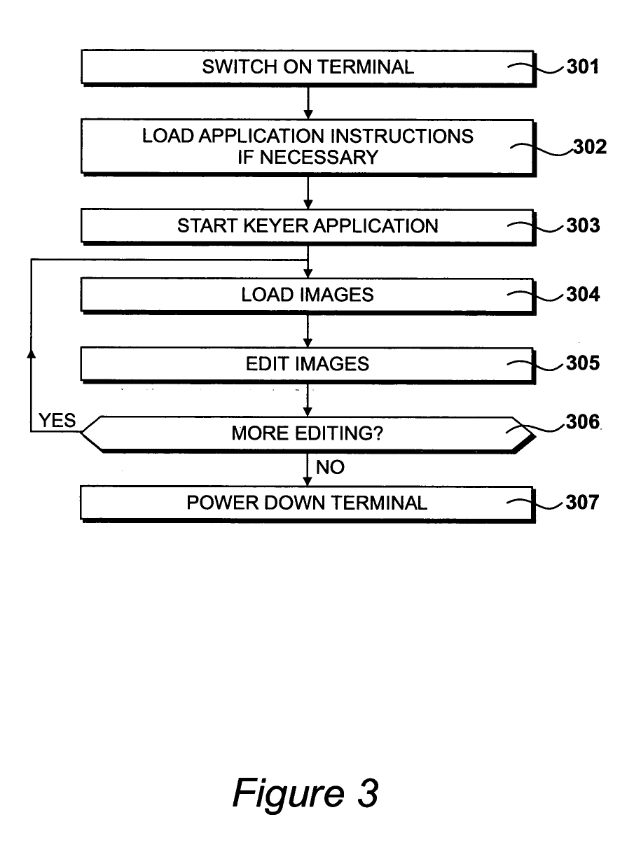

FIG. 3

FIG. 3 shows steps carried out by the user of processing system 101 in accordance with the present invention.

At step 301 the system is powered up and at step 302 application instructions are loaded as necessary. At step 303 the application is started and at step 304 the user selects and loads image data. This image data represents, in the current embodiment, two pictures that are to be composited together, and at step 305 this is carried out.

At step 306 a question is asked as to whether more images are to be edited and if this question is answered in the affirmative then control is returned to step 304. If this is answered in the negative then the processing system is switched off at step 307.

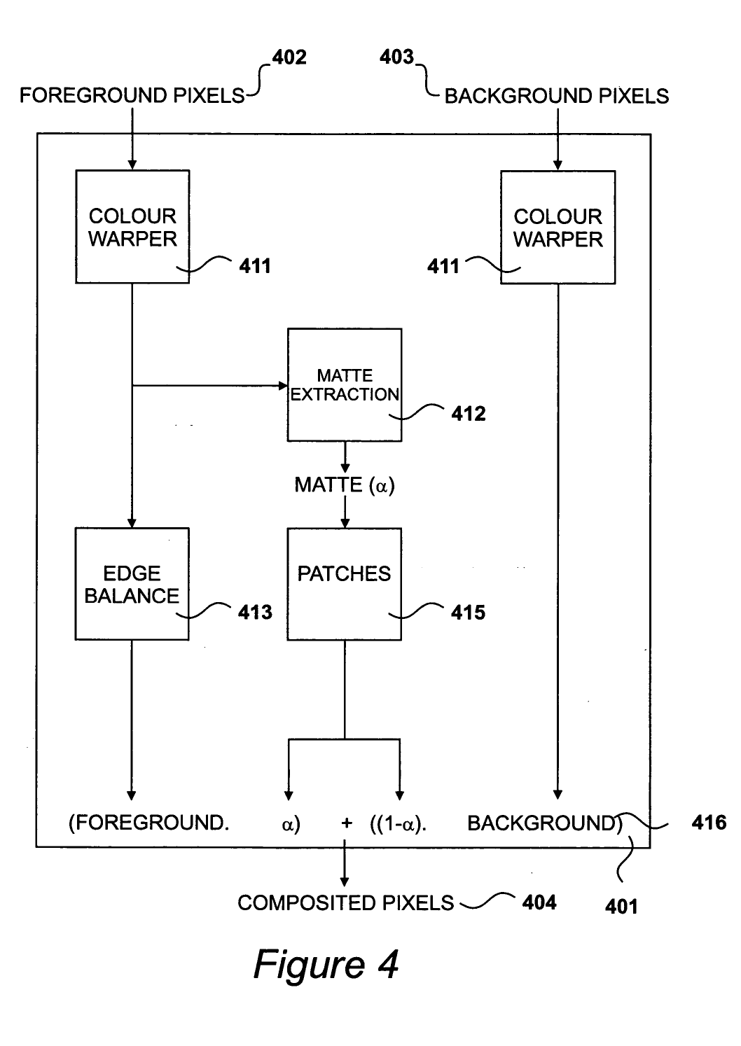

FIG. 4

FIG. 4 is a representation of the keyer application that embodies the current invention. Application 401 has inputs of foreground pixels 402 and background pixels 403, and the single output of composited pixels 404. The pixel data is in the form of a column vector having four elements. The first three represent the red, green and blue (RGB) components of a color and the fourth Iis available to store data representing a matte or alpha channel. The RGB components are normally supplied as a number between zero and two hundred and fifty-five, zero being the complete absence of that color. Values may also be supplied between zero and one or between any two other limits. The embodiment herein described assumes values between zero and one, but it will be appreciated that it can be altered to accept values between any other two limits.

As shown in FIG. 4, the foreground pixels and the background pixels may first be color warped by process 411. This changes the RGB values of the pixels but does not alter the fourth value, which at this point is set to unity.

The color-warped pixels are then input into matte extraction process 412 which produces a matte value, also known as an alpha channel, for each foreground pixel. This value becomes the fourth value of the pixel. A matte is used to composite a foreground and background image together. Usually a foreground is an object or actor, known as the talent, filmed against a blue or green screen. A matte is a black and white image that controls how a final composited image appears. In areas where the matte is completely black only the background image shows, in areas where the matte is completely white only the foreground image shows and in areas where it is a shade of grey a proportional amount of the foreground and background are mixed together. Thus, for each foreground pixel, its alpha or matte value controls the RGB values of the composited pixel at that position. A value of zero means the background pixel is used, a value of one means the foreground pixel is used and a value between zero and one means that the two are mixed together.

Parameters within matte extraction process 412 allow the user to control the matte, and two further processes allow for further adjustment. Edge balancing process 413 changes the RGB values of pixels around the edge of the talent, usually because they are too bright, too dark or have reflections from a blue screen on them. Patches process 415 adjusts the matte value of a foreground pixel in response to the user indicating that, notwithstanding the previous parameter settings, pixels of a particular color should have their matte value adjusted. This may happen, for example, when the talent contains some color that is very close to the color of the blue or green screen.

Equation 416 is the classical compositing equation, which states that each pixel in the composited image is a combination of the RGB values of the foreground pixel in that position multiplied by that pixel's matte value, and the RGB value of the background pixel in that position multiplied by one minus the matte value of the foreground pixel. This equation applied to every pixel gives the composited pixels 404.

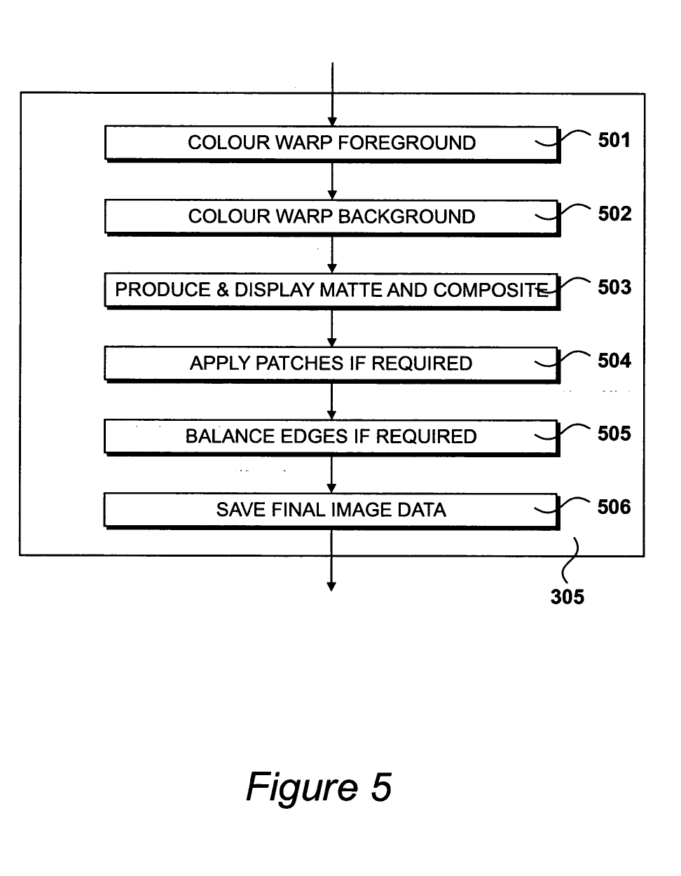

FIG. 5

FIG. 5 shows step 305, at which the images loaded at step 304 are edited according to application 401. At step 501 the foreground image is color-warped and at step 502 the background image is color-warped. Color warping is usually carried out to match the colors of the foreground and background together, since even if the talent is carefully lit it will often look wrong when composited with a background. For example it may be too light or the colors may be too saturated.

At step 503 a matte is produced and displayed to the user along with a composite image of the foreground and background according to the matte. At step 504 the user may specify patches to be applied to alter the matte and at step 505 he may specify areas in which the edge between the talent and the background is to be balanced. After every adjustment made during steps 503, 504 and 505 the matte and the composite image are recalculated and re-displayed and so the final composited pixel values on completing step 505 are saved at step 506. This concludes editing step 305.

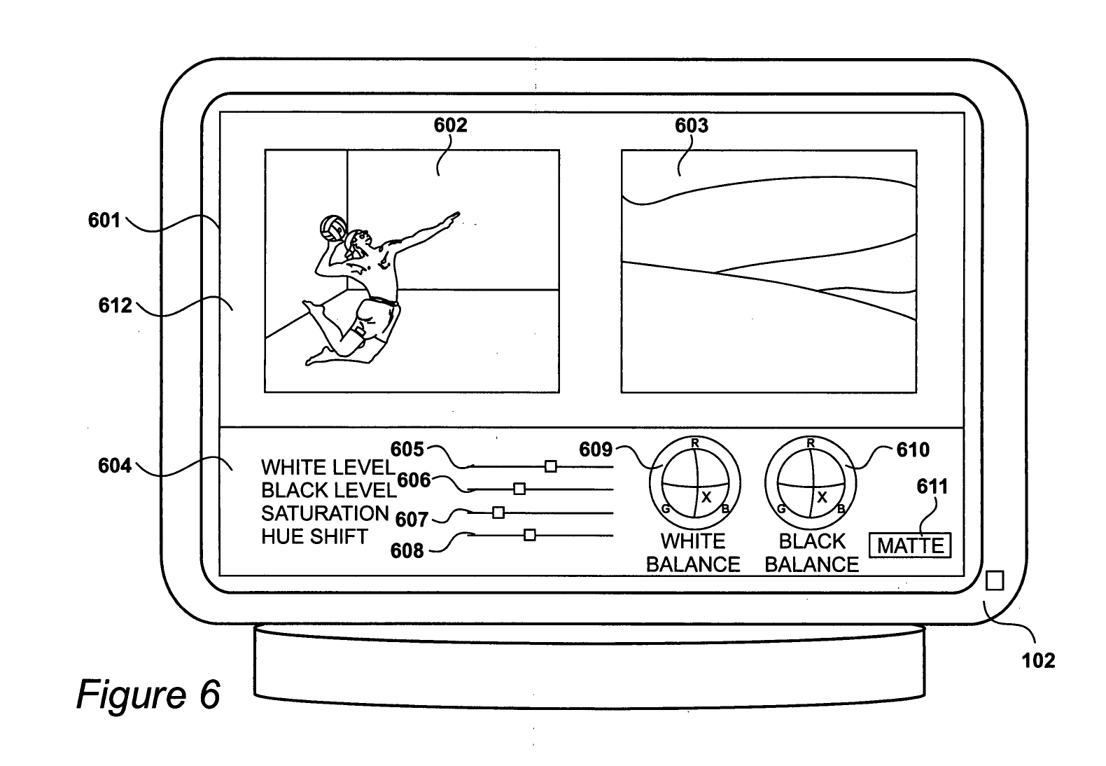

FIG. 6

FIG. 6 illustrates a GUI 601 displayed to the user of processing system 101 on VDU 102 during steps 501 and 502, at which the foreground and background images are color warped. GUI comprises first area 612 that contains foreground image and background image 603. The user initiates step 501 by clicking on the foreground 602 and initiates step 502 by clicking on the background 603.

In addition GUI 601 includes second area 604 that contains controls to adjust the color warp parameters. White level parameter 605, black level parameter 606, saturation parameter 607 and hue shift parameter 608 are controlled by sliders that allow the parameters to vary between zero and one. White balance parameter 609 and black balance parameter 610 comprise two-dimensional chrominance data and so are controlled by widgets. Button 611 initiates step 503 when the user has completed the color warping steps.

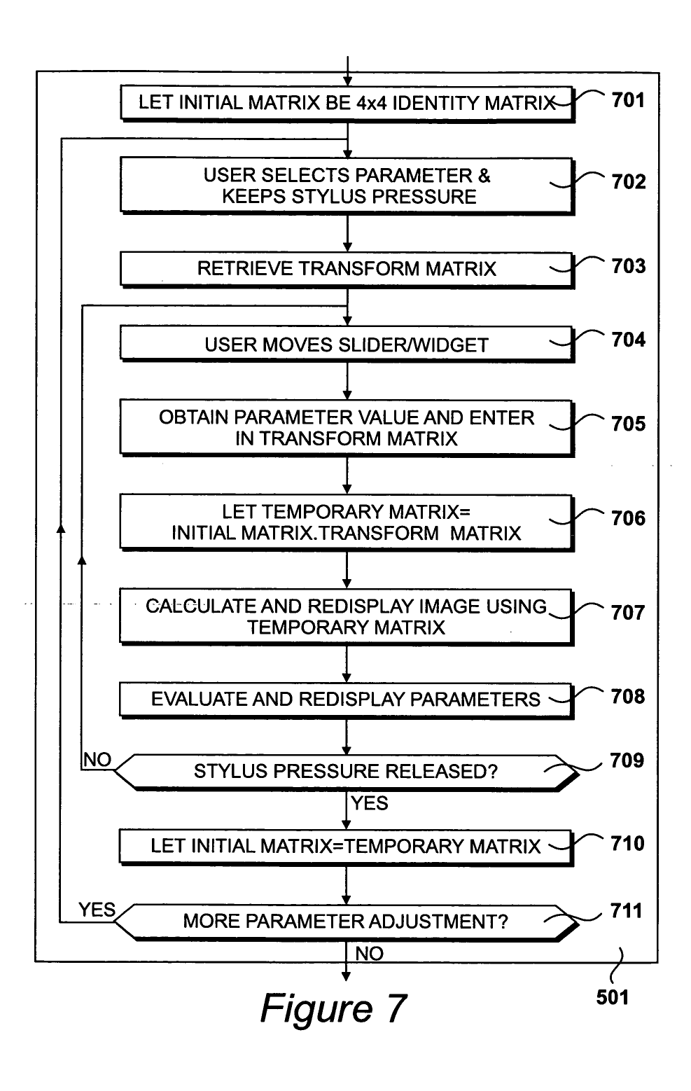

FIG. 7

FIG. 7 shows step 501 at which the foreground image is color-warped. Step 502 is identical except that the background image pixels are changed instead of the foreground image pixels.

At step 701 an initial matrix is set to be the 4×4 identity matrix. At any point during step 501 the initial matrix is a concatenation of all previous transformations carried out on the image and so during the first iteration it contains no information at all.

At step 702 the user selects a parameter control by placing a cursor displayed on VDU 102, which is controlled by stylus 105, over the appropriate control and putting pressure on the stylus. Alternatively, if a mouse is used, the user presses the button on the mouse. The user must keep pressure on the stylus in order to keep the selection of the control valid and thus change the parameters.

At step 702 a transform matrix appropriate to the selected parameter is retrieved and at step 704 the user moves the control. Movement is detected in increments and so as soon as a first increment is reached the value of the parameter at that point is obtained and entered in the transform matrix. At step 706 a temporary matrix is set to be the transform matrix multiplied by the initial matrix. Note that in the homogenous matrix notation used in this specification is read from right to left.

At step 707 the temporary matrix is used to calculate the changed pixel values of the image and redisplay the image and at step 707 the other parameters are evaluated and redisplayed, since changes in one parameter can affect others.

At step 709 a question is asked as to whether the user has released pressure on the stylus and if this question is answered in the negative then control is returned to step 704 to await the next incremented movement. However, if it is answered in the affirmative then at step 710 the new initial matrix is set to be the final temporary matrix. Thus after the first iteration the initial matrix contains the first transformation according to the first parameter adjustments made by the user, after the second iteration it contains the first two transformations, and so on.

At step 711 a question is asked as to whether there is to be more adjustment to the parameters. This question is answered in the affirmative by the user selecting any one of parameters 605 to 610, in which case control is returned to step 702. However, if the user clicks on background image 603 or button 611 then the question is answered in the negative and control proceeds to step 502 or 503 as indicated.

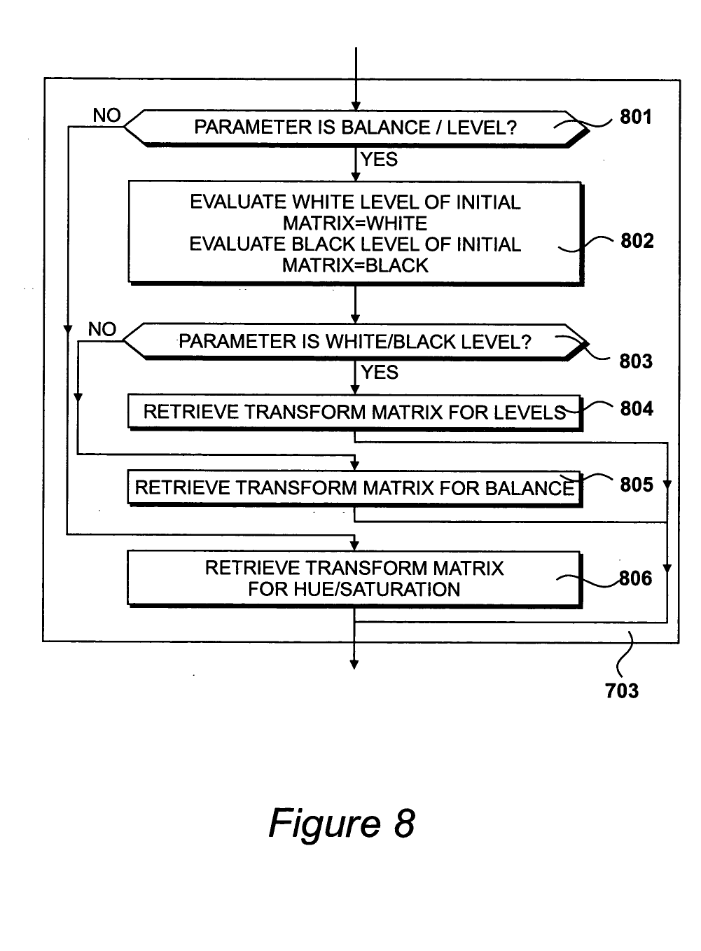

FIG. 8

FIG. 8 details step 703 at which the transform matrix appropriate for the selected parameter is retrieved. At step 801 a question is asked as to whether the parameter selected is one of parameters 605, 606, 609 or 610, that is white or black level or balance. If this question is answered in the affirmative then at step 802 a variable WHITE is set to be an evaluation of the white level of the initial matrix and a parameter BLACK is set to be the evaluated black level of the initial matrix. These two parameters indicate the changes made to the white and black levels respectively by all the previous transformations made to the image. They are needed for obtaining the transform matrices for parameters 605, 606, 609 and 610.

At step 803 a question is asked as to whether the selected parameter is either white level parameter 605 or black level parameter 606, and if this question is answered in the affirmative then at step 804 a transform matrix appropriate to these parameters is retrieved. If it is answered in the negative then at step 805 a transform matrix suitable for black and white balance parameters 609 and 610 is retrieved.

If the question asked at step 801 is answered in the negative, to the effect that the selected parameter is not one of parameters 605, 606, 609 or 610, then it must be one of parameters 607 and 608 and so at step 806 a transform matrix suitable for these is retrieved.

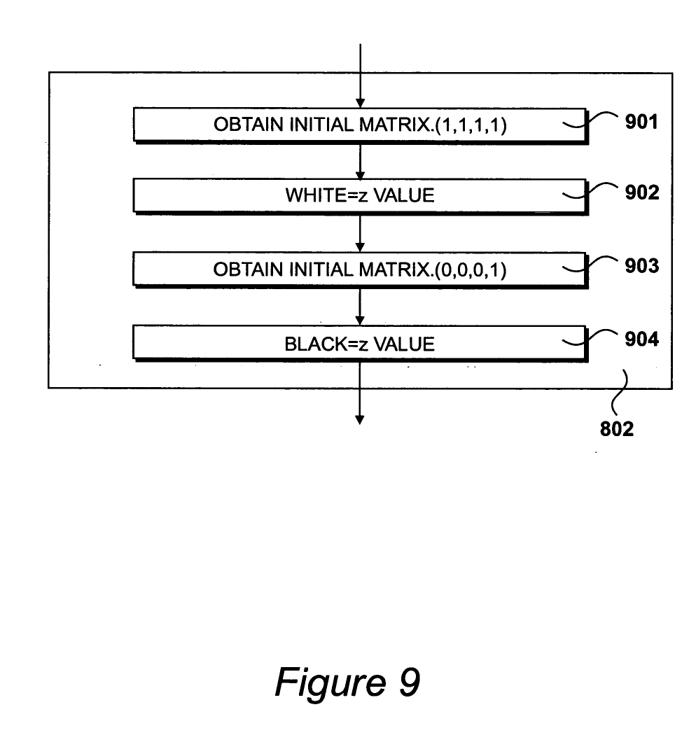

FIG. 9

FIG. 9 details step 802 at which the variables WHITE and BLACK are evaluated. At step 901 the point (1, 1, 1, 1), which represents white in RGB, is multiplied first by a matrix F1 and then by the initial matrix.

In this specification all pixel values are column vectors made up of four values. The first three are measurements on the x, y and z axes respectively of a co-ordinate system, while the fourth is either set to unity or contains matte data (which may also take the value 1). However, the pixel values are constantly transformed and the x, y and z values do not always mean the same thing. In particular, when a pixel has RGB values its measurement on the x-axis represents the amount of red in the color, the y value represents the amount of green and the z value represents the amount of blue.

However, all transformations in the present invention are carried out in PbPrY space or a slightly transformed version of it. This is a different color space in which measurements on the x-axis represent Pb values, measurements on the y-axis represent Pr values and measurements on the z-axis represent y values. Pb and Pr are called the chrominance values and any transformation purely in these two dimensions affects only the color, that is the hue or saturation, of a pixel y is the luminance and so any transformation purely in this dimension affects only the perceived brightness of the pixel. F1 is the matrix that transforms a pixel having RGB values into a pixel having PbPrY values. (An alternative way of thinking of this is that the point stays in the same place but the co-ordinate system is transformed. In order to produce this effect the matrix transformations must be reversed.)

Thus the transformation carried out at step 901 first transforms white, as defined in RGB space, to white as defined in PbPrY space. It is still white. The initial matrix is then applied to it such that it is transformed in the same way as the pixels in the foreground image have been transformed. The value on the z-axis of the product of this step is thus the luminance of white when it has been warped in the same way as the image. This is defined as the white level of the image at step 902.

Similarly, at step 903 black in RGB co-ordinates is multiplied by F1 and then the initial matrix and at step 904 the variable BLACK is set to be the z value thus obtained.

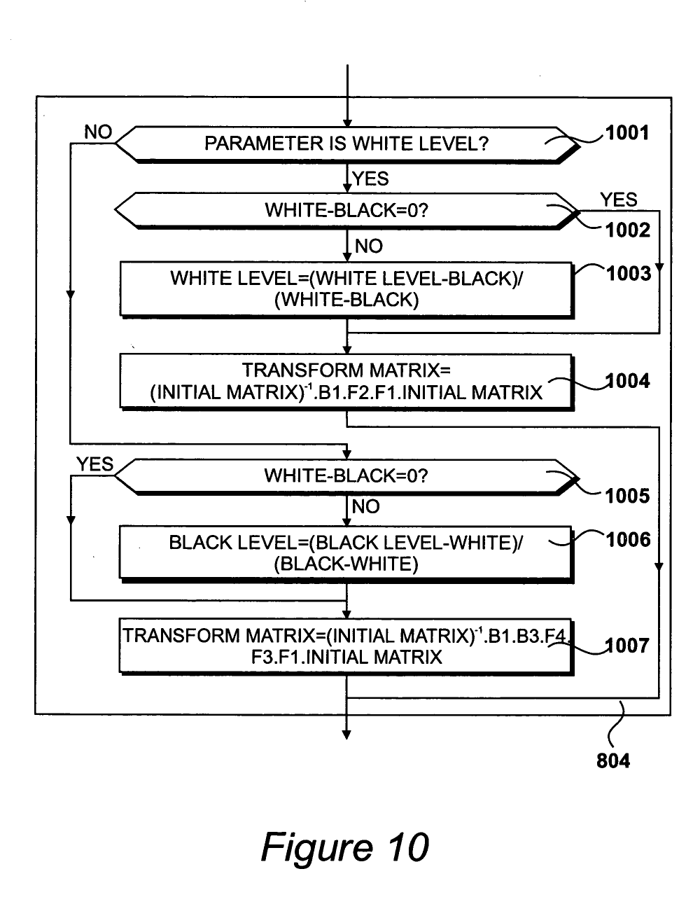

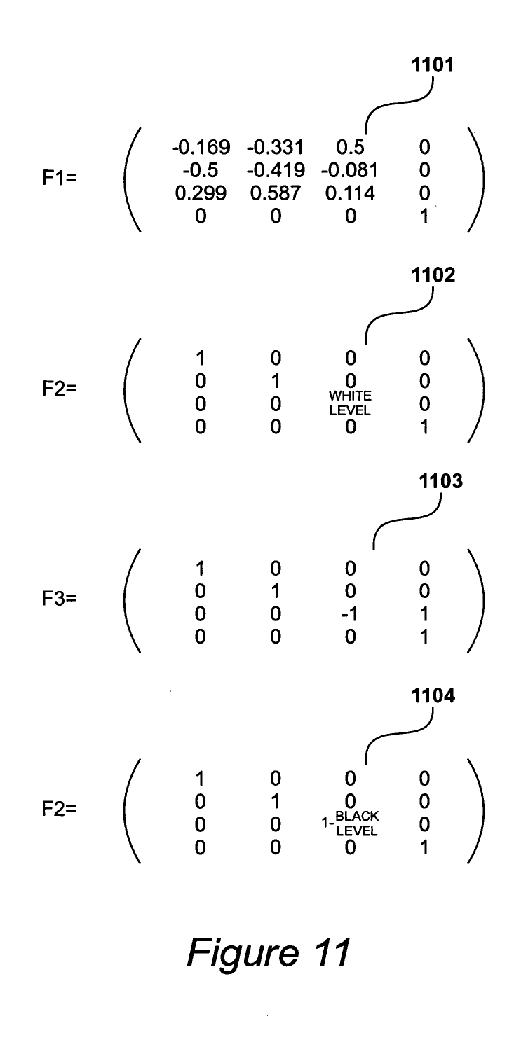

FIGS. 10 and 11

FIG. 10 details step 804 at which a transformation matrix suitable for white level parameter 605 or black level parameter 606 is retrieved. At step 1001 a question is asked as to whether the selected parameter is white level parameter 605. If this question is answered in the affirmative then at step 1002 a second question is asked as to whether the variable BLACK subtracted from the variable WHITE is equal to zero. If this question is answered in the negative then at step 1003 the value of the parameter, as indicated by the user's movement of the control at step 704, is changed. The new white level is set to be the old white level minus variable BLACK, all divided by variable BLACK subtracted from variable WHITE. This adjusts the parameter value to take account of the fact that the white level may have been already adjusted in previous transforms. However, if the question asked at step 1002 is answered in the affirmative then step 1003 would give an answer of infinity and is therefore bypassed. This is actually unlikely to happen since it would mean that black and white in the image have the same luminance value.

At step 1004 the transform matrix is set to be the initial matrix multiplied by the matrix F1 multiplied by a matrix F2 multiplied by a matrix B1 multiplied by the inverse of the initial matrix. FIG. 11 shows matrix F1 at 1101 and matrix F2 at 1102. Matrix B1 is the inverse of F1, and this notation is used throughout this specification. For example, B3 is the inverse of F3 and so on.

As previously explained, F1 is the transformation that takes a pixel's x, y and z values that are defined in RGB space and transforms them to x, y and z values that are defined in PbPrY space. It does not change the actual color of the pixel. As can be seen in FIG. 11, the luminance of a pixel in PbPrY is most affected by the amount of green it contains and least affected by the amount of blue it contains. This corresponds to the human perception of luminance, in which pure green is more luminous than pure red which in its turn is more luminous than pure blue. It is for this reason that transformations are carried out on pixels that have PbPrY values. Also, working with PbPrY values means that to adjust the chrominance of a pixel you only need work in the two dimensions represented by the x and y axes. This makes calculations much easier. Black is represented by (0, 0, 0, 1) in both systems.

Matrix 1102 carries out the white level transformation by scaling the z-axis by the value of white level parameter 605, thus altering the luminance of pixels in the image, with pixels of high luminance being altered more than those with low luminance.

Thus the transform matrix retrieved at step 1004 is the concatenation of all previous transforms, represented by the initial matrix, then the transformation to PbPrY co-ordinates, then the scaling of the z-axis by the white level parameter value, followed by a transformation back into RGB co-ordinates and finally the inverse of the initial matrix. Referring back to FIG. 7, at step 706 the temporary matrix is set to be the transform matrix multiplied by the initial matrix, cancelling out the final inverse of the initial matrix. Thus the transform matrix applies all previous transformations and then the current one.

At step 1005 a question is asked again as to whether the variable BLACK subtracted from the variable WHITE is equal to zero and if it is answered in the negative then at step 1006 the value of black level parameter 606 is changed. Again this has the effect of making sure that the transformation takes account of previous black and white level changes. If the question asked at step 1005 is answered in the affirmative then step 1006 is bypassed.

At step 1007 the transform matrix for black level parameter 606 is defined as the initial matrix multiplied by matrix 1101 multiplied by matrix F3 (shown in FIG. 11 at 1103) multiplied by matrix F4 (shown in FIG. 11 as matrix 1104), followed by the inverse of matrix 1103, the inverse of matrix 1101, and finally the inverse of the initial matrix. Again, this final inverse of the initial matrix will cancel out with the initial matrix supplied at step 706.

Matrix 1103 has the effect of scaling a pixel by −1 down the z-axis and translating up the z-axis by 1. Basically, this inverts pixels on the z-axis, such that pixels of a high luminance now have low z values while pixels of a low luminance now have high z values. The scaling transformation applied by matrix 1104 multiplies the z values of pixels by one minus the black level parameter value, as adjusted at step 1006. This is because adjustments to the white level are generally made by decreasing it from one, whereas adjustments to the black level are made by increasing it from zero.

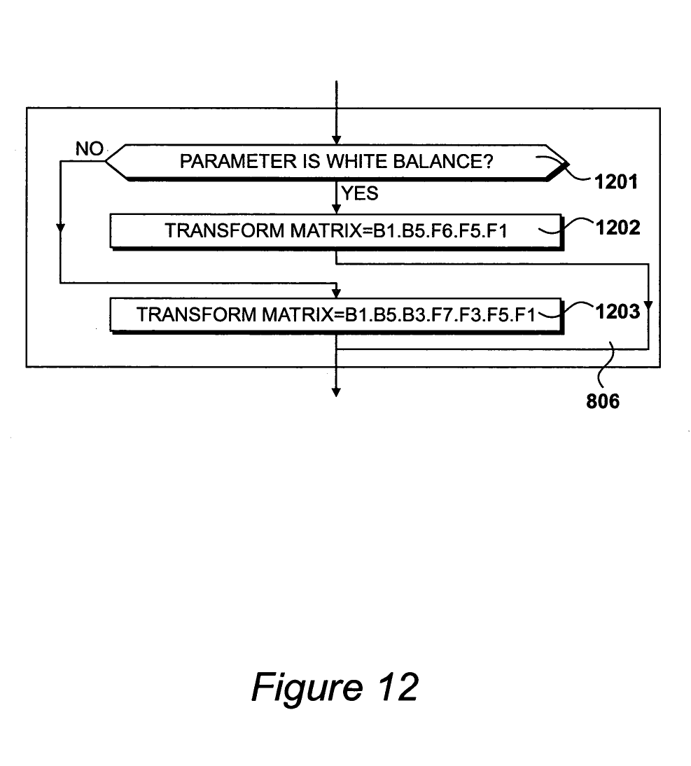

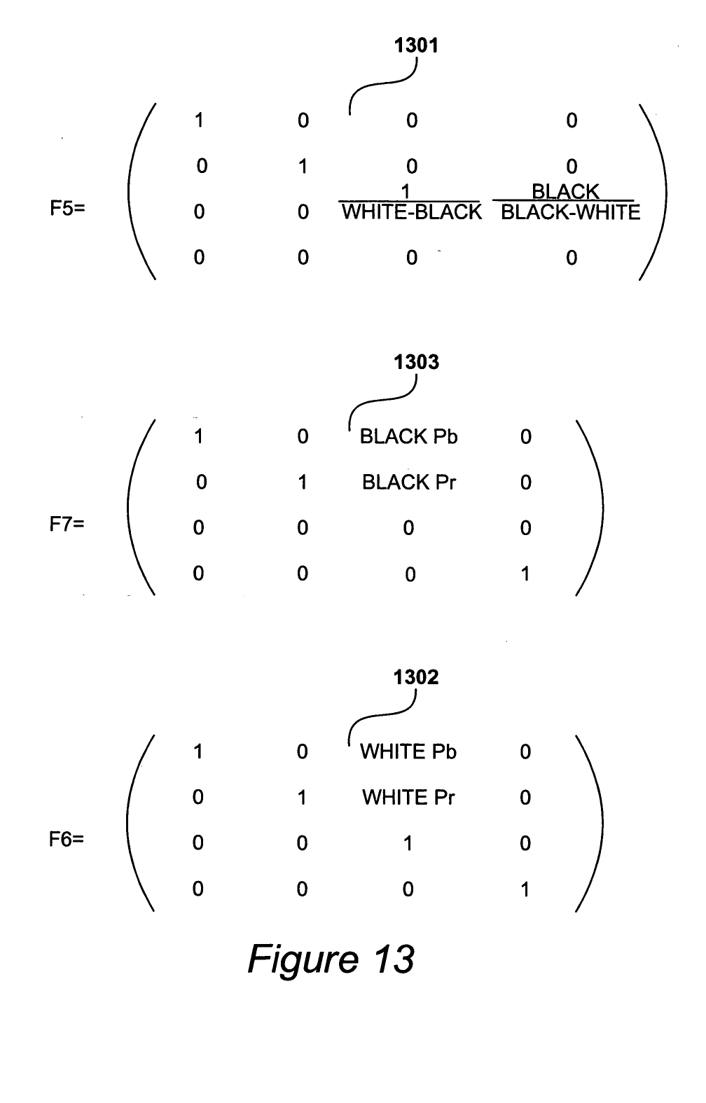

FIGS. 12 and 13

FIG. 12 details step 806 at which the transform matrix for white balance parameter 609 or black balance parameter is retrieved. At step 1201 a question is asked as to whether the selected parameter is white balance parameter 609 and if this question is answered in the affirmative then the transform matrix is set accordingly at step 1202. The parameter value for white balance consists of two chrominance values obtained by the user moving a marker over the widget shown in FIG. 6. This two-dimensional data is already in PbPrY and so there is no need to adjust it.

However, white and black balance are calculated slightly differently from the other parameters. The effect of changing the white balance is to perform a shear on pixels in the image, that is to say moving them along the x- and y-axes by a factor of their z values. Thus the chrominance only of a pixel is changed, according to the white balance parameter value, but it is changed more if the pixel is more luminous. Conversely, if the black balance is adjusted then it is changed more if the pixel is less luminous.

If a pixel has already had a hue shift applied to it, that is a rotation around the z-axis, then performing a white or black balance produces unexpected effects. Thus a white or black balance transform is always applied to the original pixel values, with the concatenated previous transformations, as contained in the initial matrix, applied afterwards. However, black and white balance is affected by the black and white levels and so firstly the luminance of each pixel's original values in the image must be changed to reflect the current black and white levels.

Thus the transform matrix defined at step 1202 consists of matrix 1101, followed by matrix F5 (defined in FIG. 13 as matrix 1301), followed by matrix F6 (defined in FIG. 13 as matrix 1302). The inverse of matrix 1301 followed by the inverse of matrix 1101 is then applied. Thus the RGB pixel values are first transformed into PbPrY values by matrix 1101. Their luminance is then affected by matrix 1301, which first translates a pixel up the z-axis by the value BLACK and then scales it on the z-axis by the reciprocal of variable BLACK subtracted from variable WHITE. This gives a pixel the same luminance as it would have if it had been transformed by the initial matrix.

The white balance transformation is then applied by matrix 1302, which shears a pixel along the x-axis by its z value multiplied by the Pb part of white balance parameter, and along the y-axis by its z value multiplied by the Pr part of the white balance parameter. The inverse of matrix 1301 is then applied to return the luminance to its previous level and the inverse of matrix 1101 gives RGB values. Thus the transform matrix for white balance does not contain the initial matrix. However, the temporary matrix applies the initial matrix to the transform matrix at step 706 and thus the previous transformations are applied after the white balance.

If the question asked at step 1201 is answered in the negative, to the effect that the parameter is black balance parameter 610, then at step 1203 the transform matrix is set to be the concatenation of matrix 1101, which gives PbPrY values, followed by matrix 1301 which scales the luminance of the pixel according to the black and white levels of the initial matrix, followed by matrix 1103 shown in FIG. 11 which again inverts the luminance value of the pixel (as is also done for black level parameter 606) followed by matrix F7 (defined in FIG. 13 as matrix 1303) which applies the current black balance transformation, using the Pb and Pr input from the widget. This is then followed by the inverse of matrix 1103, the inverse of matrix 1301 and the inverse of matrix 1101 to return the pixels to RGB values. At 706 the initial matrix is then concatenated with the transform matrix to apply the previous transformations.

Thus a black or white balance adjustment is always performed before any other transformations but is adjusted to take account of the black and white levels of the initial matrix.

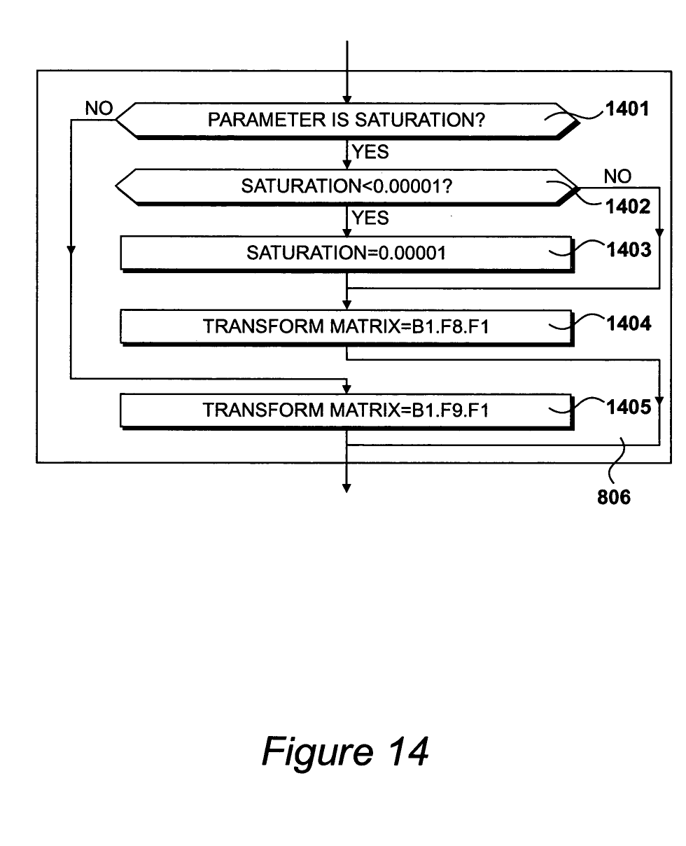

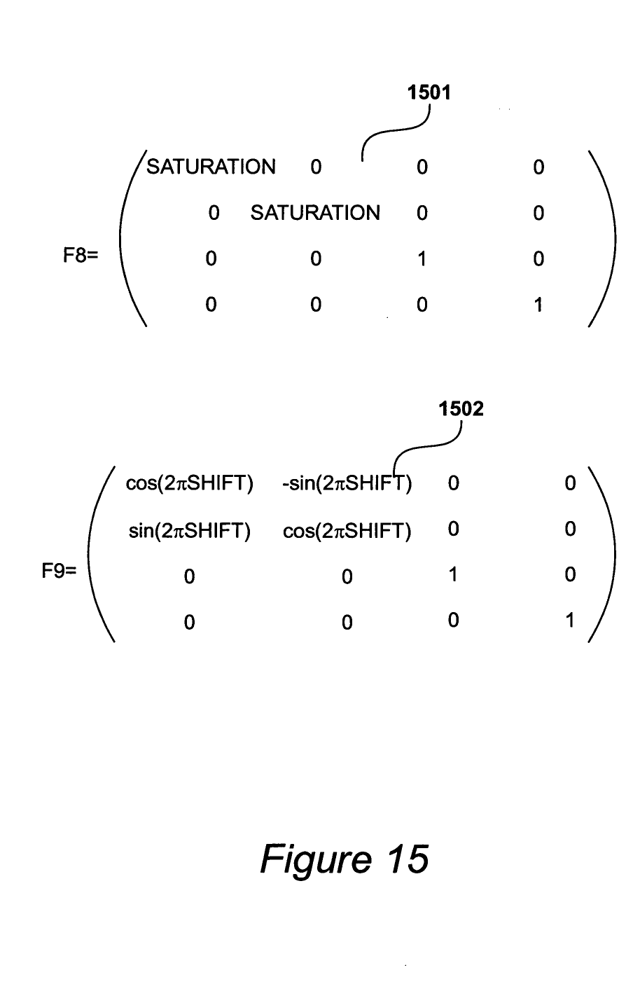

FIGS. 14 and 15

FIG. 14 details step 806 at which a transform matrix suitable for hue shift or saturation adjustment is retrieved. At step 1401 a question is asked as to whether the selected parameter is saturation parameter 607 and if this question is answered in the affirmative then a further question is asked at step 1402 as to whether the value of the parameter is less than 0.00001. If this question is answered in the affirmative then the actual value of the parameter is ignored and it is set to be 0.00001. This is to ensure that the saturation adjustment can be undone. At step 1404 the transform matrix is set to be matrix 1101 followed by matrix F8, defined in FIG. 15 at 1501. This is then followed by the inverse of matrix 1101. As shown in FIG. 15, a pixel whose x, y and z values represent PbPrY has its saturation changed by a multiplication of the x and y values by the value of saturation parameter 607, as indicated by the user's movement of the slider. Thus, without step 1403, if the user set the slider to zero this would change the x and y values of every pixel in the image to zero, thus rendering the image black and white. Moving the saturation parameter slider would then have absolutely no effect on any pixels since a multiplication by zero is always zero. This is prevented by the clamping of the value of saturation parameter 607 at step 1402 and 1403. A similar precaution could be taken with the black and white level parameters 605 and 606 but this is unnecessary since in practice the white level is never set to zero and the black level is never set to one.

If the question asked at step 1401 is answered in the negative, to the effect that the parameter being adjusted is not saturation parameter 607 but is therefore hue shift parameter 608, then at step 1405 the transform matrix is set to be matrix 1101 multiplied by matrix F9 (defined in FIG. 15 at 1502) multiplied by the inverse of matrix 1101. As shown in FIG. 15, matrix 1502 applies a rotation about the z-axis by the value of hue shift parameter 608, as indicated by the current position of the slider, multiplied by 2 times pi (=3.1415.). This is because the slider goes from zero to one and rotations are measured in radians.

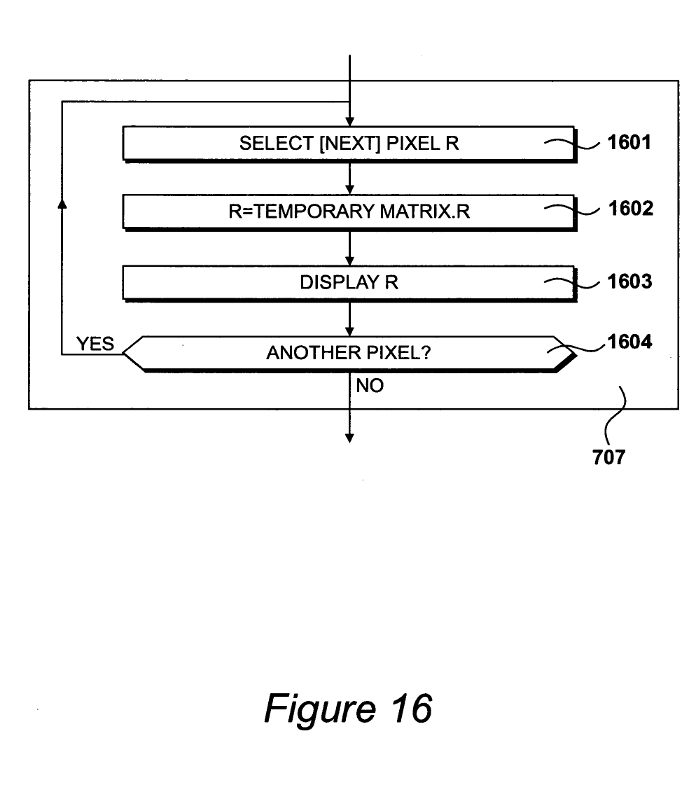

FIG. 16

FIG. 16 details step 707 at which the image is redisplayed according to the change made in the selected parameter. At step 1601 the first pixel in the foreground (or the background if that is being adjusted) is selected and at step 1602 its values are multiplied by the temporary matrix defined at step 706, ie the transform matrix followed by the initial matrix. At step 1602 the transformed pixel is displayed in the correct position in the image and at step 1604 a question is asked as to whether there is another pixel in the image. If this question is answered in the affirmative then control is returned to step 1601 and the next pixel is selected, while if it is answered in the negative then all pixels have been transformed and step 707 is concluded.

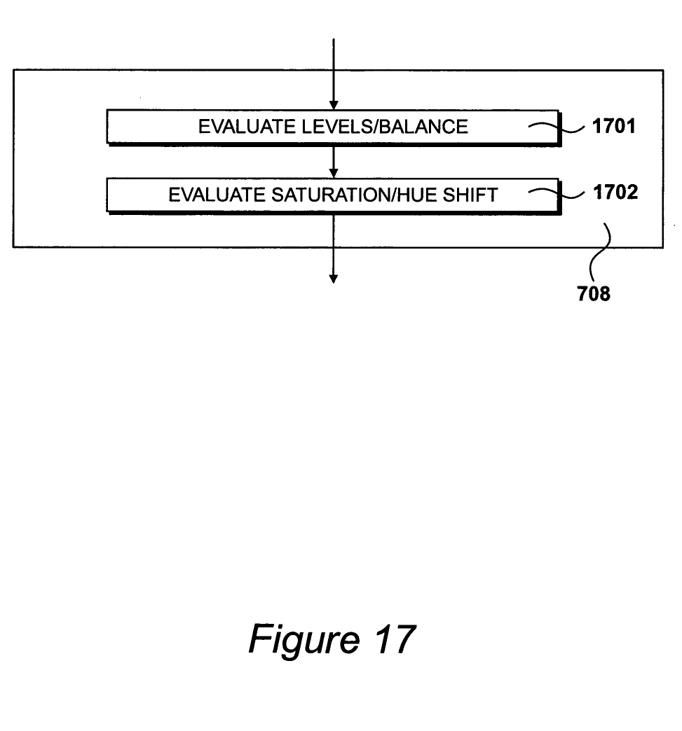

FIG. 17

FIG. 17 details step 708 at which the parameters are evaluated and redisplayed, since a transformation according to one parameter can affect the other parameters. If the value of a parameter has been changed by a transformation that must be reflected in the GUI 601, thus ensuring if all the controls are returned to their original positions the image is also returned to its original state. This is not possible in prior art color warpers in which every control is re-set to its original position after a parameter has been changed. Thus every control is in the same place whether the image has been transformed or not and so it is very difficult to return the image to its original state, often necessitating abandoning the current process and reloading the original image.

Thus at step 1701 parameters 605, 606, 609 and 610 are evaluated and redisplayed and at step 1702 parameters 607 and 608 are evaluated and redisplayed.

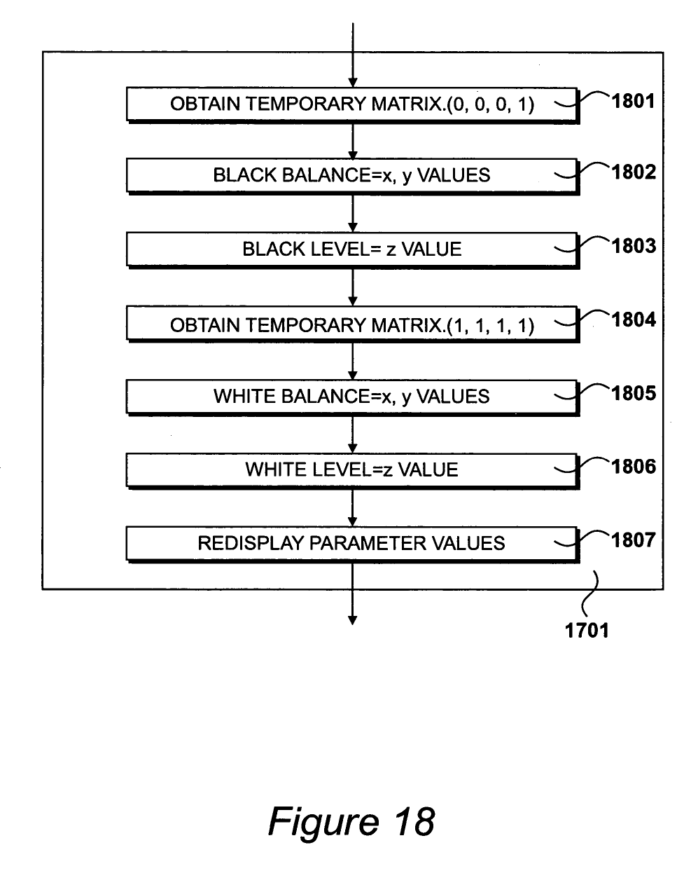

FIG. 18

FIG. 18 details step 1701 at which the white and black levels and balance parameters are evaluated. It will be recalled from the discussion of FIG. 9 that the white level of an image is obtained by finding the luminance of the color white which has been transformed in the same way as the image, while the black level is found by taking the luminance of black transformed in the same way. Similarly, white and black balance levels of an image are found by obtaining the chrominance values of white and black transformed by the current transformations.

Thus at step 1801 the color black in RGB, which has values (0, 0, 0, 1) is multiplied first by the temporary matrix defined at step 707 and then by matrix 1101 which transforms the adjusted RGB values into PbPrY. At step 1802 the x and y values of the product of step 1801 are set to be the current black balance and at step 1803 the z value is set to be the black level.

Similarly, at step 1804 white in RGB is multiplied by the temporary matrix and then by matrix 1101 and the x and y values of the product are set to be the white balance at step 1805, while at step 1806 the z value is set to be the white level of the image.

At step 1807 the parameter values are redisplayed in GUI 601.

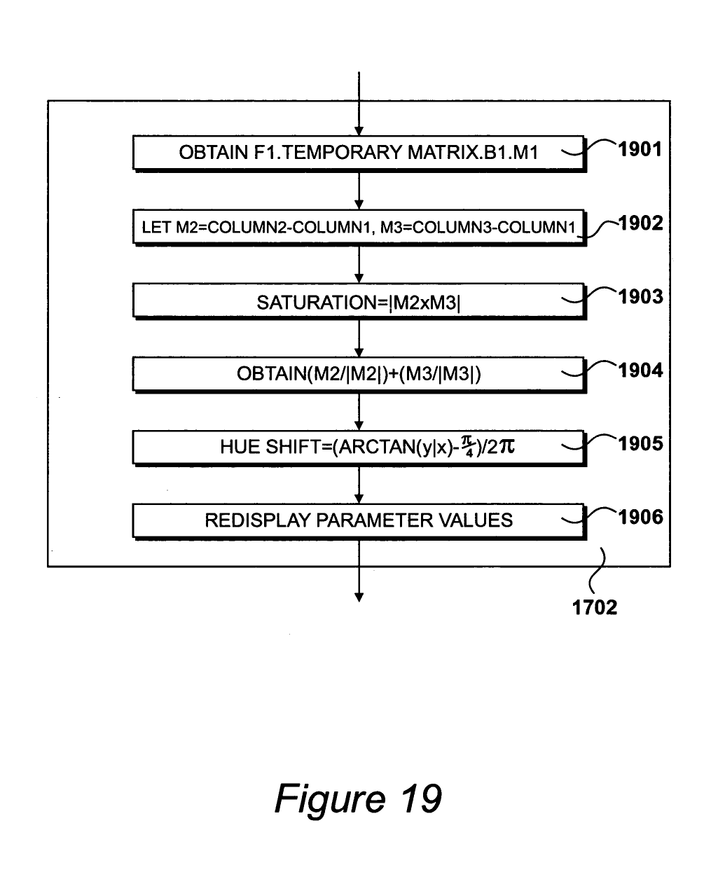

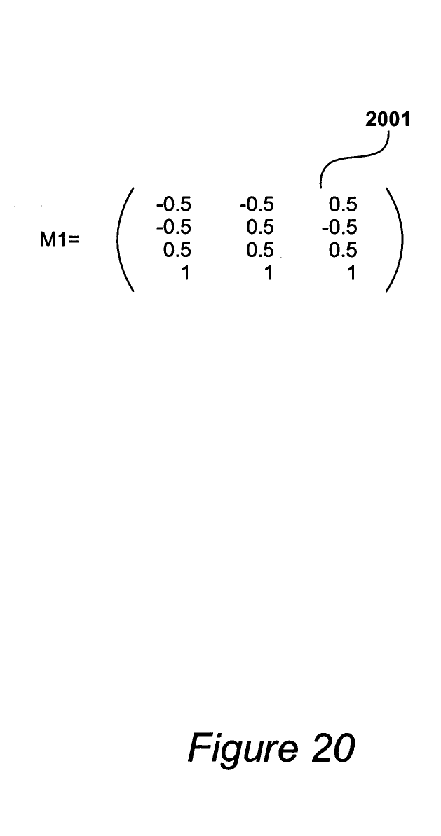

FIGS. 19 and 20

FIG. 19 details step 1702 at which the new values of saturation parameter 607 and hue shift-parameter 608 are evaluated. The saturation level of an image is obtained by measuring how the area of a specified two-dimensional volume defined in PbPrY is changed by the current transformations. Thus a matrix M1, which is shown in FIG. 20 at 2001 and contains the points defining this volume, is first transformed by the inverse of the matrix 1101. This takes the points, which are originally defined in PbPrY, to RGB. The temporary matrix defined at step 706 is then applied and the points are then sent back to PbPrY by applying matrix 1101. The product of step 1901 is thus a matrix containing three columns, each representing a transformed point of matrix 2001. Thus at step 1902 a vector M2 is set to be the distance between the first two points, as defined in the first two columns of this product, and a vector M3 is set to be the distance between the first and third points, as defined by the first and third columns of the product. At step 1903 the length of the cross (or vector) product of these two vectors is obtained. The result of this step is a single variable which describes how the area defined by the points in matrix 2001 has been scaled. This variable is therefore equal to the saturation level.

The hue shift of an image is obtained by finding how much a known point has rotated around the z-axis. This known point is the point (0.5, 0.5, 0.5, 1) in PbPrY space. To find the angle by which it has been rotated, the vectors M2 and M3 are normalised and are added together. If, for example, the temporary matrix contained no transformations at all the result of steps 1904 would be the point previously specified. This is at an angle of forty-five degrees (measured anti-clockwise) from the x-axis. Thus, to find out by how much the point has been rotated and thus to find out by how much every pixel in the image has been rotated, the angle between the point that is the product of step 1904 and the x-axis, measured anticlockwise, is obtained and forty-five degrees subtracted from it. The result is divided by 2 pi to give a hue shift parameter value between zero and one at step 1905.

The evaluated saturation and hue shift parameter values are then redisplayed at step 1906 by adjusting the display of the controls in GUI 601 on VDU 102.

Thus at the end of step 708 the values of all of parameters 605 to 610 have been evaluated and redisplayed if necessary. They can then be changed by the user if required.

This completes the description of the color warping steps 501 and 502.

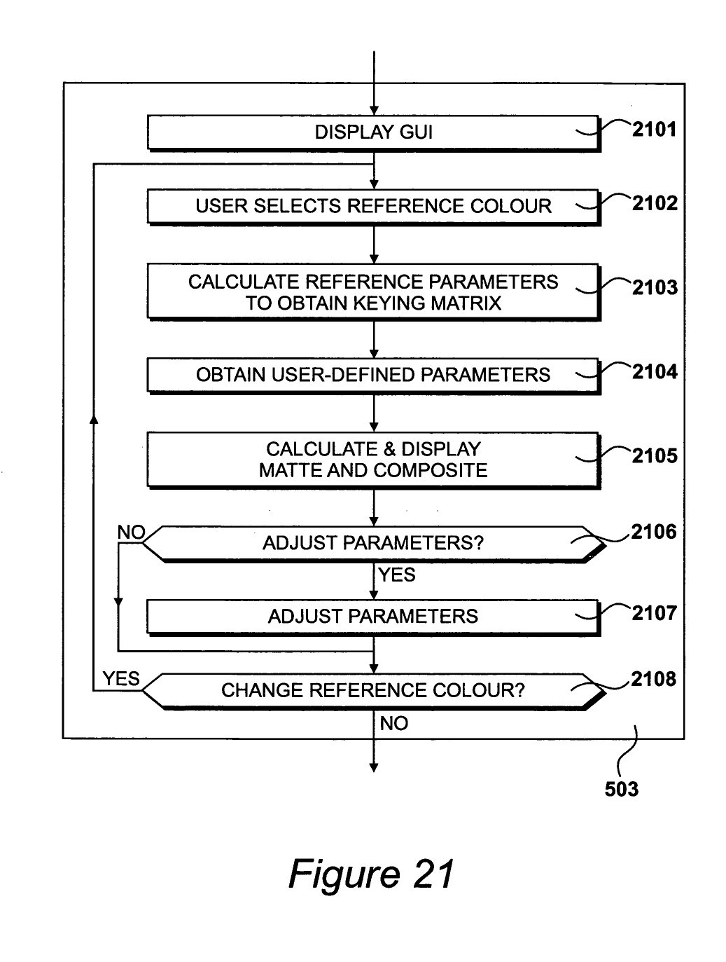

FIG. 21

FIG. 21 shows step 503 at which the matte of a foreground image, such as foreground image 602 is produced and displayed. The composite of the foreground and background images according to the matte is also displayed if required.

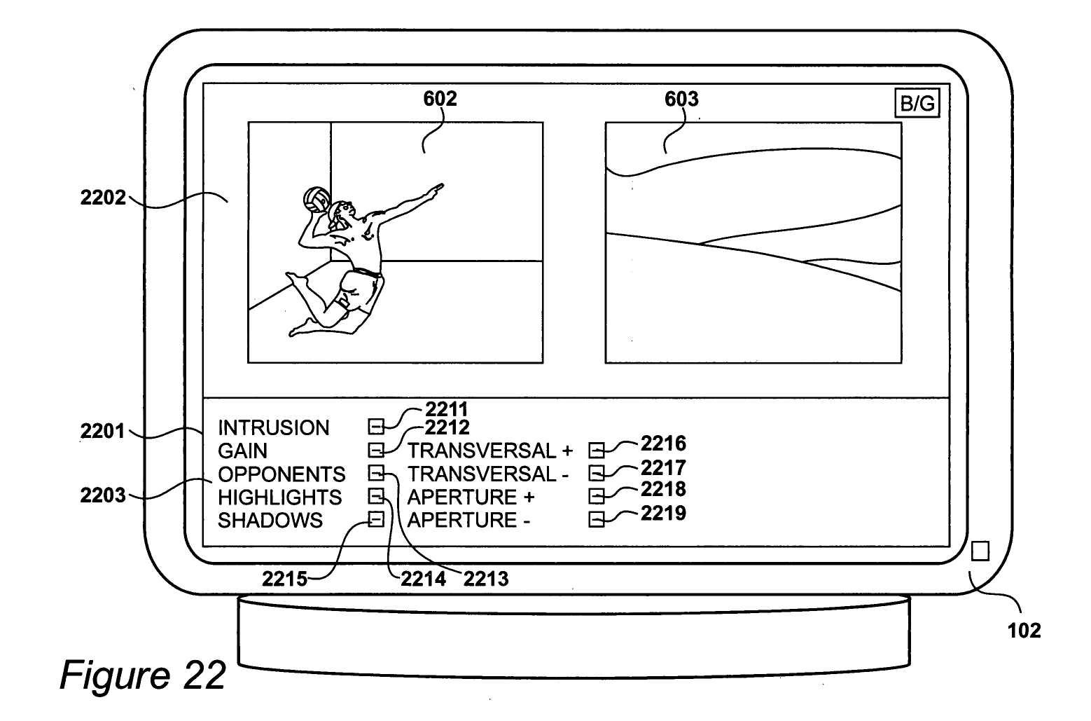

At step 2101 a graphical user interface (GUI) is displayed to the user, which will be discussed further with reference to FIG. 22. At step 2102 the user selects a reference color by clicking on the blue or green screen of the foreground and at step 2103 the reference color is used to calculate the parameters that define a keying matrix.

At step 2104 user-defined parameters are obtained from the GUI, which on the first iteration are default parameters set by the application. At step 2105 these parameters and the keying matrix are used to calculate and display the matte and the composite image and at step 2106 the question is asked as to whether the user wishes to adjust the parameters. This is answered in the affirmative by the user selecting either a parameter value or a control button that allows automatic parameter adjustment. In either case, the parameters are adjusted at step 2107.

The question asked at step 2106 is answered in the negative by the user selecting anywhere else within the GUI and at step 2107 the question is asked as to whether the reference color is to be changed. This question is answered in the affirmative if the user has selected a button that allows this change, and control is returned to step 2102 where the user selects another——reference color. If the question asked at step 2108 is answered in the negative then the user has selected the only other available button, which concludes step 503 and allows the application to proceed to step 504 at which patches are applied.

FIG. 22

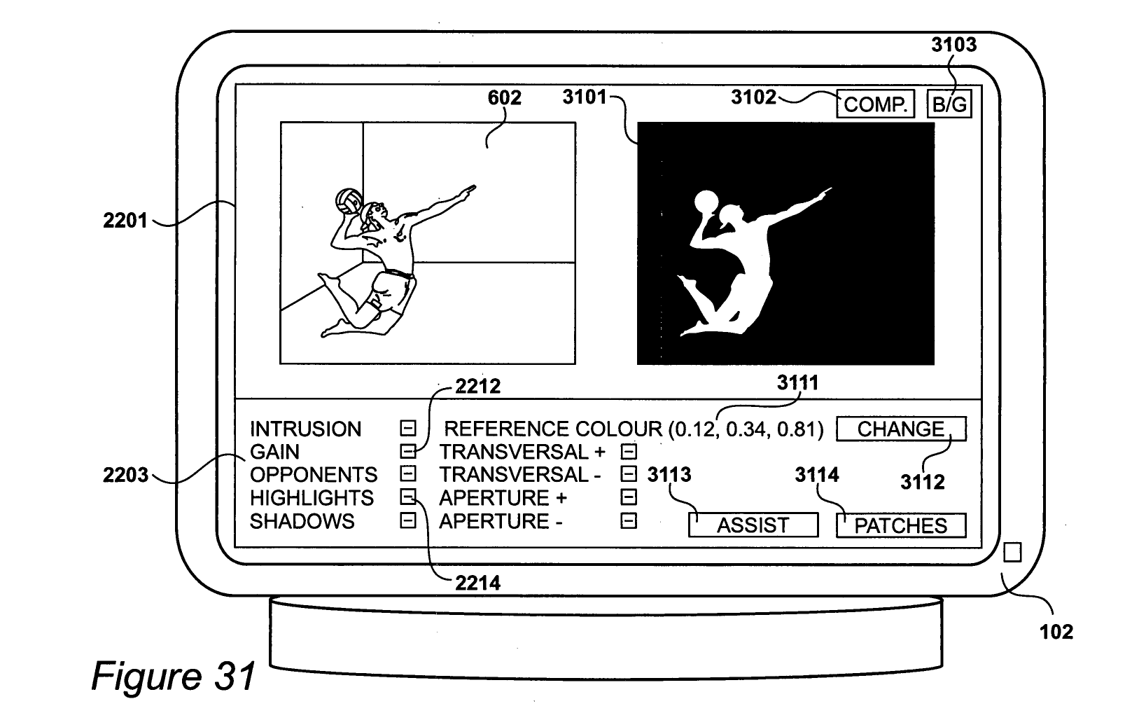

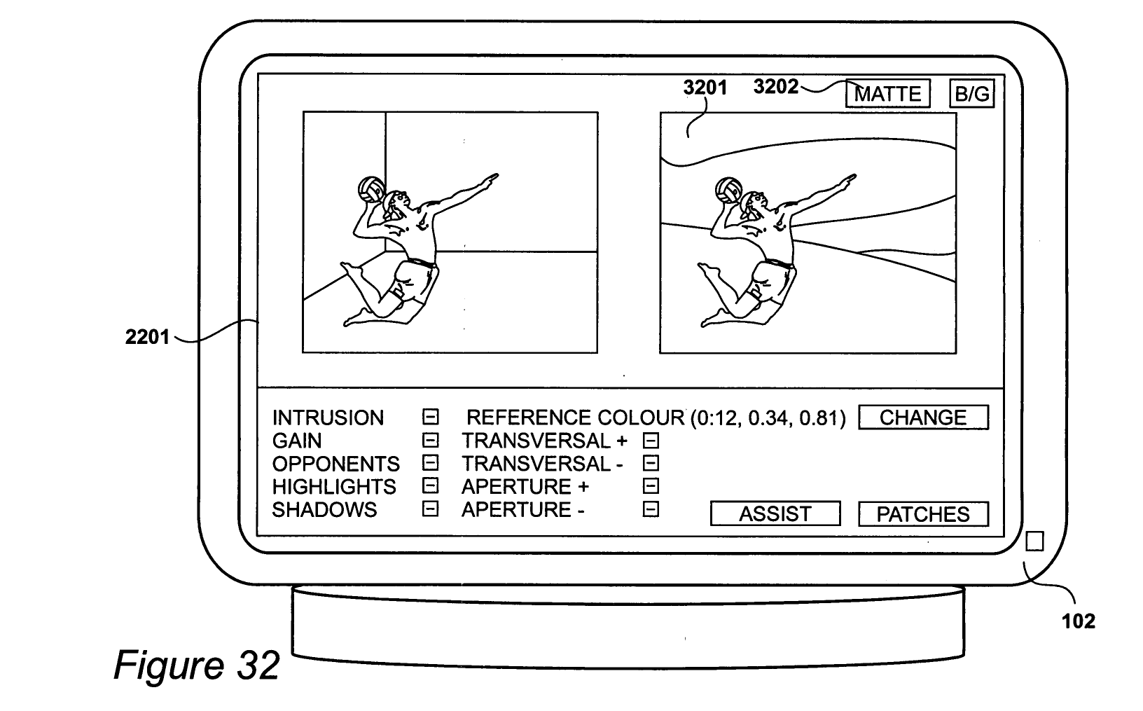

FIG. 22 shows a GUI 2201 displayed to the user on VDU 102 at the start of step 503. A GUI containing more information is displayed during step 503 and this is described with reference to FIGS. 31 and 32.

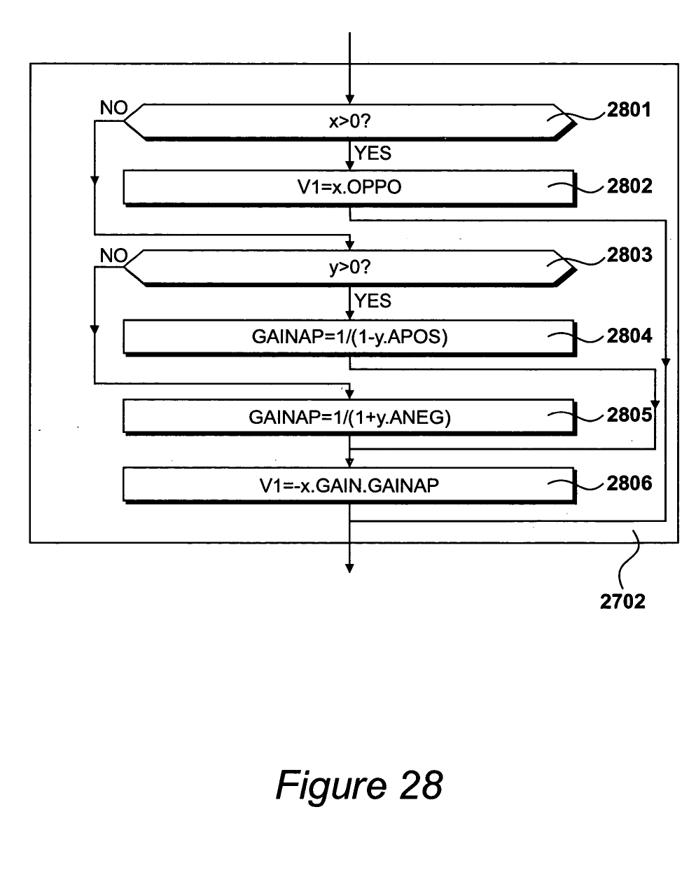

Similarly to GUI 601, it comprises a first area 2202 that includes a foreground image 602 and a background image 603. A second area 2203 contains control for adjusting a matte. A first user-defined parameter 2211 is called intrusion. This parameter defines a rough boundary in the color-space between pixels that should have a matte value of zero and those that should have a matte value of one. The remaining parameters 2212, 2213, 2214, 2215, 2216, 2217, 2218 and 2219, called gain, opponents, highlights, shadows, transversal positive, transversal negative, aperture positive and aperture negative respectively, are used to fine tune the keying. This wil be further described with reference to FIGS. 28 to 30. Each parameter is initially set to a default value of 0.5, except parameter 2211 which is set to a default value of zero, and all can accept values between zero and one.

When GUI 2201 is first displayed the user initiates the keying process by selecting a reference color from the blue screen of foreground 602 at step 2102. If the user accidentally selects a pixel of the talent the keying process will proceed but the results will be unusual.

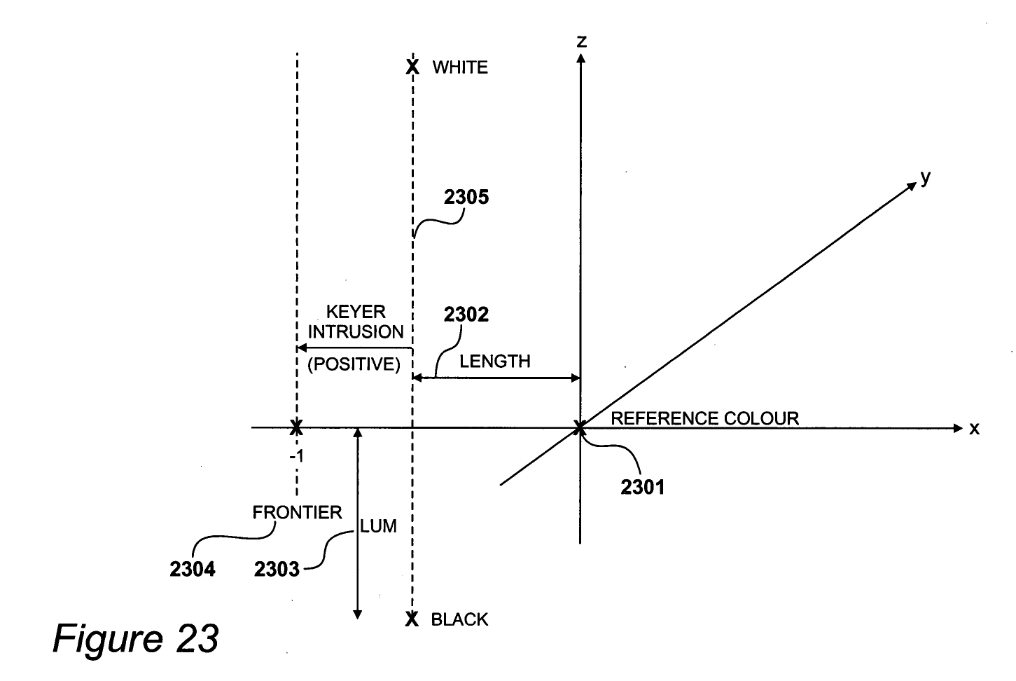

FIG. 23

FIG. 23 shows a transformed co-ordinate system which is used in the keyer. In this co-ordinate system, the selected reference color is at the origin and an intrusion frontier is at the point (−1, 0, 0). This co-ordinate system is obtained by first transforming the reference color from RGB color values to PbPrY color values.

The distance from the reference color to a grey of equal luminance is then measured and defined as its length 2302. The color is then rotated around the z-axis until it is on the x-axis and then is translated down the x-axis by its length until it is at the intersection of the x- and y-axes. It is also translated down the z-axis by its luminance 2303 until it is at the point (0, 0, 0).

The x-axis is then scaled such that the length of the reference color plus the intrusion parameter 2211 is equal to one, thus putting the intrusion frontier 2304 at −1 on the x-axis. Line 2305 is the line defined by all colors that are a shade of grey.

When a color is transformed in the same way as the reference color its measurements along the x-, y- and z-axes therefore give a distance from the reference color in terms of Pb, Pr and Y.

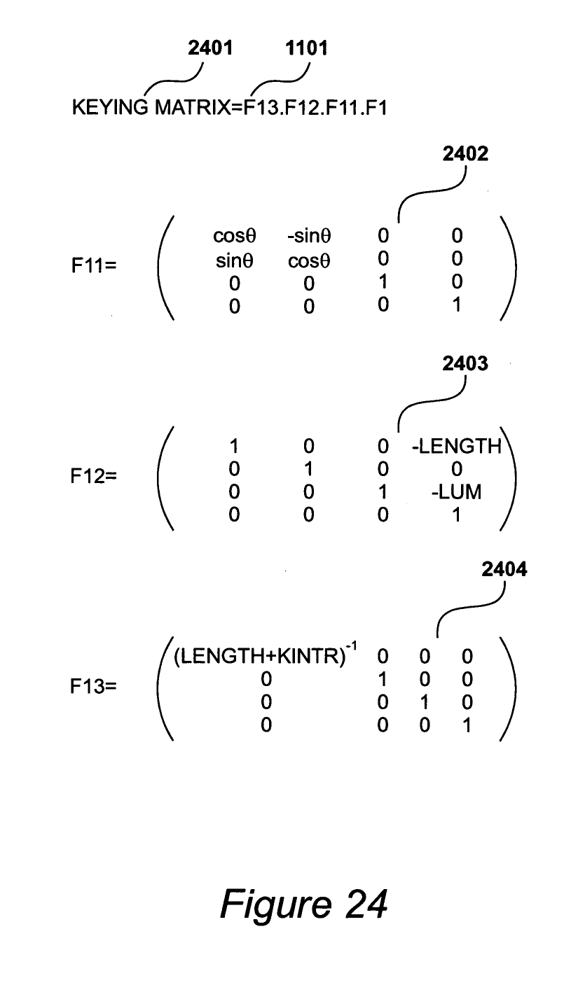

FIG. 24

FIG. 24 shows the concatenation of matrices necessary to obtain keying matrix 2401 which is applied to a pixel to transform it as shown in FIG. 23. Firstly matrix 1101 defines the transformation into PbPrY. Matrix F1, shown at 2402, then performs the rotation around the y-axis, matrix F12, shown at 2403, performs the translations and matrix F13, shown at 2404, scales the x-axis.

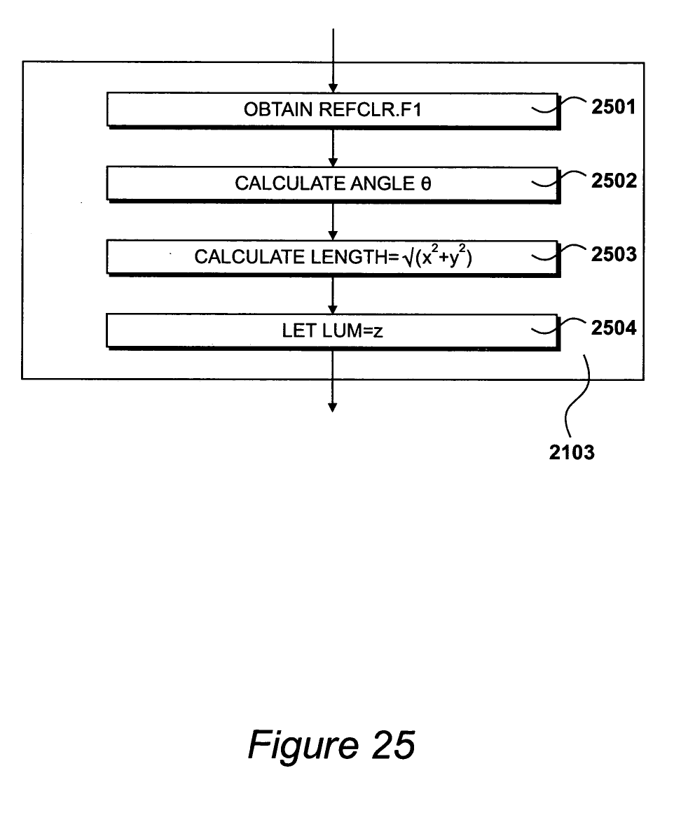

FIG. 25

FIG. 25 details step 2103 at which the necessary parameters to obtain the keying matrix are calculated. At step 2501 the reference color, which at this point has RGB values, is multiplied by matrix F1 to give it PbPrY values, and at step 2502 an angle theta is defined as the angle by which the reference color must be rotated around the z-axis in order to place it on the x-axis. This angle is used in matrix-2402.

At step 2503 the length 2302 of the line connecting the reference color to a grey of equal luminance is calculated using the x and y values of the products of step 2501. The length is defined as the square root of the sum of the square of each value. At step 2504 the third value of the product of step 2501 is set to be a variable LUM 2303. These two variables are used in matrix 2403.

The variables required in matrix 2404 are length 2302 and the value of intrusion parameter 2211, both of which are now known.

Thus at this point all of the parameters needed to produce keying matrix 2401 have been calculated. Unless the reference color is changed, the keying matrix is now only affected by the value of intrusion parameter 2211.

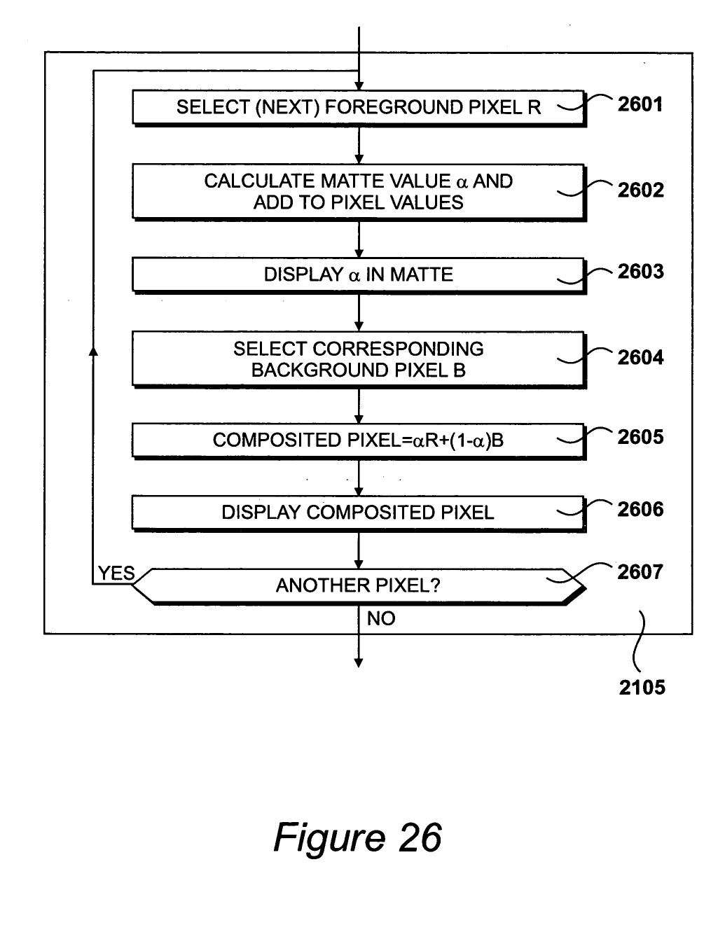

FIG. 26

FIG. 26 details step 2105 at which the matte of the foreground, and the composite of the foreground with the background according to the matte, are produced and displayed.

At step 2601 the first foreground pixel is selected and at step 2602 its matte value is calculated and stored as the fourth value of the pixel, replacing the value of one which was previously there. At step 2603 a shade of grey corresponding to the matte value is stored and displayed, if required, in that position in the matte. A value of zero means the position is black, a value of one indicates white and a value in between gives a shade of grey.

At step 2604 the pixel in the corresponding position in the background image is selected and at step 2605 a composite pixel is produced. This is obtained by multiplying the RGB values of the foreground pixel by its matte value and multiplying the RGB values of the background pixel by one minus the matte value. These two products are added together to produce the composite pixel. At step 2606 this pixel is stored and displayed, if required, in the corresponding position in the composite image.

At step 2107 a question is asked as to whether there is another pixel in the foreground image. If this question is answered in the affirmative then control is returned to step 2601 and the next pixel is selected. If the question is answered in the negative then a matte and a composite pixel has been calculated and displayed for every foreground pixel. Step 2105 is therefore concluded.

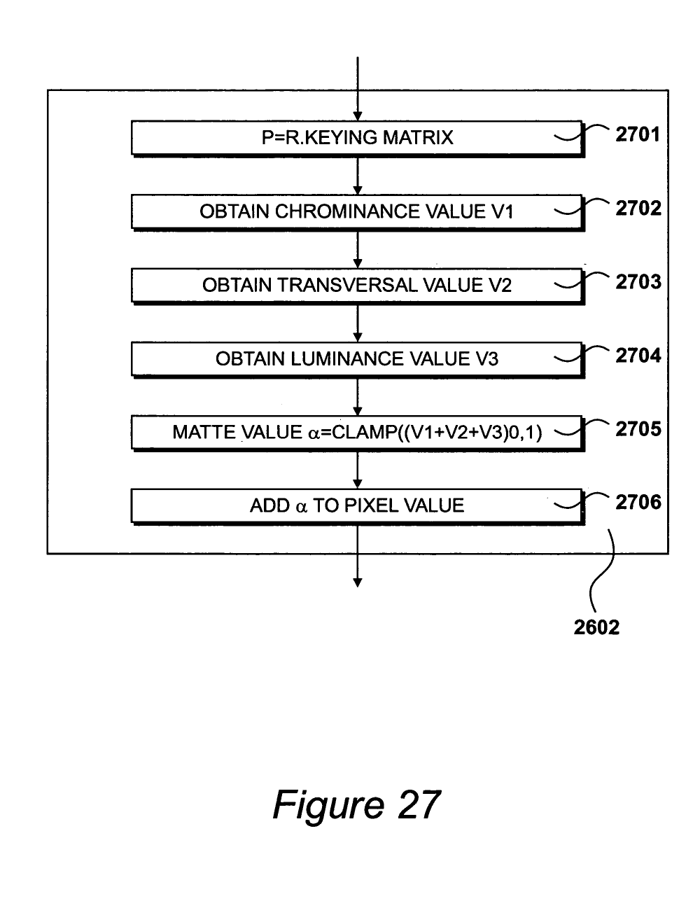

FIG. 27

FIG. 27 details step 2602 at which a matte value is calculated for a selected pixel. At step 2701 the pixel is transformed by applying keying matrix 2401 to it. Its transformed x, y and z values are used to obtain a chrominance value V1 at step 2702, a transversal value V2 at step 2703 and a luminance value V3 at step 2704. The matte value is then calculated at step 2705 as the sum of values V1, V2 and V3, with the result clamped between zero and one. At step 2706 the matte value is added to the RGB values of the pixel.

FIG. 28

FIG. 28 details 2702 at which the chrominance value is obtained. At step 2801 a question is asked as to whether the value along the x-axis of the transformed pixel is greater than zero. If this question is answered in the affirmative then at step 2801 value V1 is defined as the x value multiplied by opponents parameter 2213.

If this question is answered in the negative then at step 2803 a question is asked as to whether the pixel's transformed value on the y-axis is greater than zero. If this question is answered the affirmative then at step 2804 the value of a further parameter called gain aperture is set to be the reciprocal of one minus the y value multiplied by aperture positive parameter 2218. If it is answered in the negative then the value of the gain aperture parameter is set to be the reciprocal of one plus the y value multiplied by aperture negative parameter 2219 at step 2805.

Following either of steps 2804 or 2805 the value V1 is set as minus one multiplied by the x value multiplied by the gain parameter 2212 multiplied by the gain aperture parameter.

Thus, referring back to FIG. 23, if the transformed pixel has a positive x value, ie it is on the right of the reference color 2301, then value V1 is a function of parameter 2213 that increases the further away from the reference color the pixel is. However, if the pixel is to the left of the reference color then the value of V1 is a function of the parameter 2212 that increases the further away from the reference color the pixel is, further modified by the gain aperture parameter. This parameter is a function of the aperture parameters 2218 and 2219 which again increase the further away from the reference color the pixel is, however this time the distance is measured along the y-axis. Thus, the closer a pixel is to the frontier 2301 the more that value V1 will be affected by the parameters gain and gain aperture.

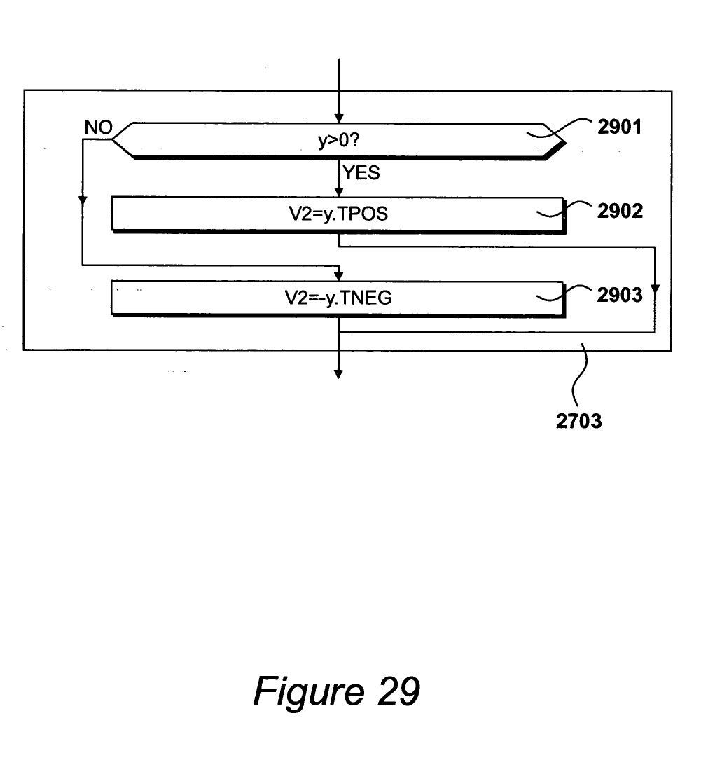

FIG. 29

FIG. 29 details step 2703 at which the transversal value is obtained. At step 2901 a question is asked to whether the y value of the transformed pixel is greater than zero. If this answered is in the affirmative then at step 2902 V2 is set to be the y value multiplied by transversal positive parameter 2216. If it is answered in the negative then at step 2903 the value V2 is set at minus one multiplied by the y value multiplied by the transversal negative parameter 2217. Thus, value V2 is affected by how far away along the y-axis from the reference color the pixel is and which side of the reference color it is on.

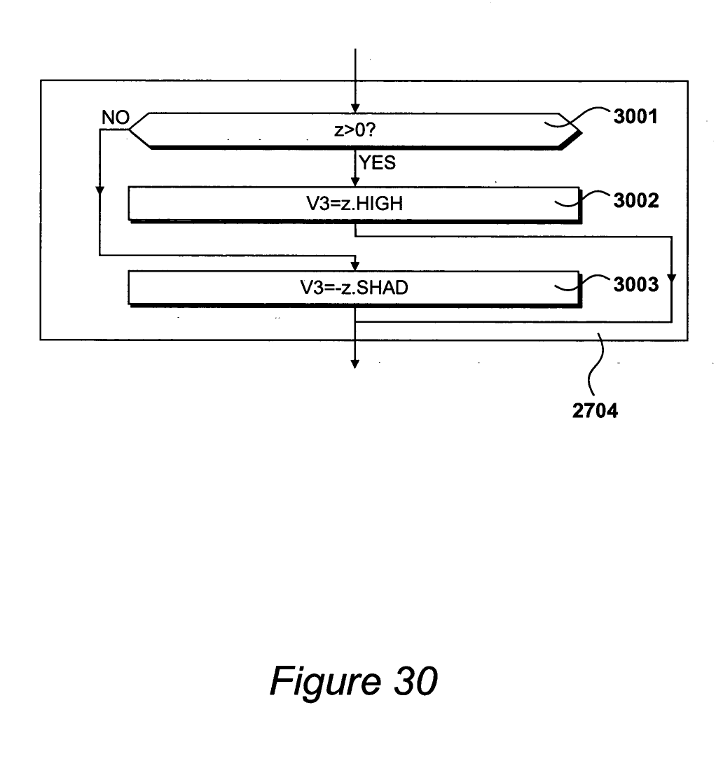

FIG. 30

FIG. 30 details step 2704 at which luminance value V3 is obtained.

At step 3001 a question is asked-as to whether the value along the z-axis is greater than zero. If this question is answered in the affirmative then at step 3002 the value V3 is set as the z value multiplied by highlights parameter 2213. If it is answered in the negative than at step 3003 the value V3 is set at minus one multiplied by the z value multiplied by shadows parameter 2215. Thus, V3 is affected by how far away from the reference color the pixel is along the z-axis and also which side of the reference color it is on.

FIG. 31

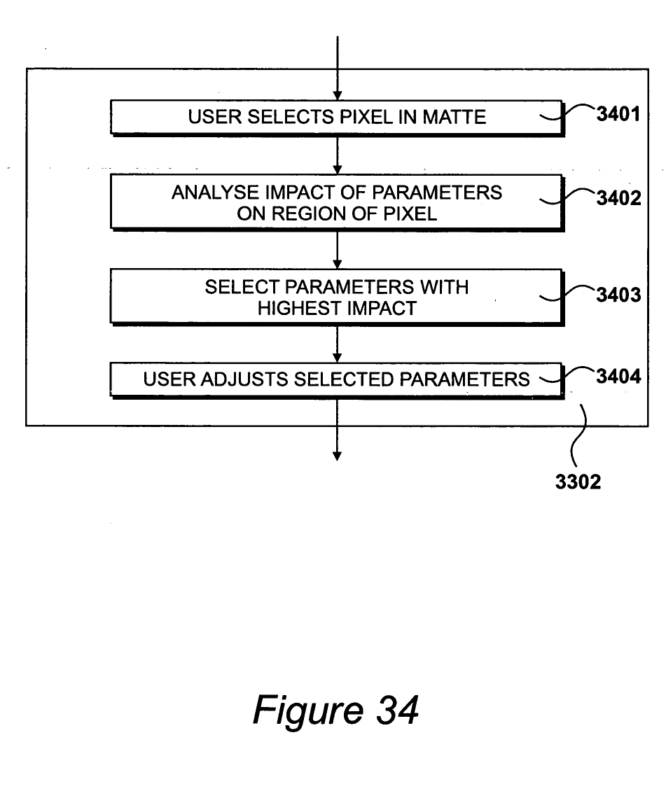

FIG. 31 shows GUI 2201 after the completion of step 2105. In addition to foreground image 602 a matte image 3101 is also displayed. Icons 3102 and 3103 indicate that the user may additionally view the composited image and the original background image if required. In addition to parameters 2211 to 2219, area 2203 now contains an indication 3111 of the selected reference color, a button 3112 allowing the user to change the reference color, a button 3113 which initiates a process called direct manipulation which will be explained further with reference to FIG. 34 and a button 3114 that indicates that the user has finished adjusting the parameters and wishes to proceed to step 504 of the keying application and apply patches.

Within GUI 2201 the user can adjust any of the parameters, each having a different impact on the matte. For example, increasing highlights parameter 2214 means that the matte value of pixels with a high luminance increases.

FIG. 32

FIG. 32 again illustrates GUI 2201 but instead of matte 3101 composite image 3201 is displayed. Icon 3202 allows the user to display the matte if required.

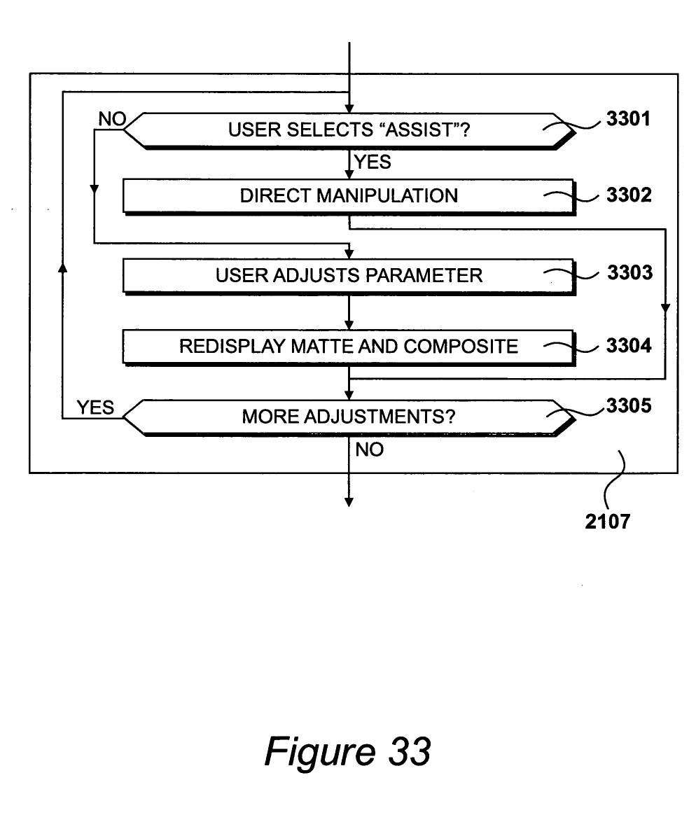

FIG. 33

FIG. 33 details step 2107 at which parameters 2211 to 2219 are adjusted if required. This step is initiated by the user either selecting one of the parameters or selecting button 3113. Thus, at step 3301 a question is asked as to whether button 3113 has been selected. If this question is answered in the affirmative then at step 3302 a process known as direct manipulation is carried out. This automatically selects parameters to be adjusted and redisplays the matte and composite accordingly.

If the question asked at step 3301 is answered in the negative then a parameter value has been selected and so at step 3303 the user changes the parameter. At step 3304 the matte and composite are recalculated and displayed. This step is identical to step 2105 detailed in FIG. 26.

At step 3305 a question is asked as to whether more adjustments are to be carried out. If this question is answered in the affirmative by the user selecting either a parameter or button 3113 control is returned to step 3301. If it is answered in the negative by the user selecting a different button step 2107 is completed. Thus whenever the user changes one of parameters 2211 to 2219, the matte and the composite image are immediately updated and displayed to the user in GUI 2201. The user is therefore able to immediately see the impact of any changes he makes.

FIG. 34

FIG. 34 details step 3302 at which the process known as direct manipulation is carried out. For any pixel in a foreground image, its matte value is affected by either three or four of the parameters 2212 to 2219. For example, if the transformed pixel has positive x, y and z values then its matte value is only affected by opponents parameter 2213, transversal positive parameter 2216 and highlights parameter 2214. Thus changing any of the other parameters will not affect its matte value at all. Additionally, out of the three or four parameters that affect a pixel's matte value it is usual that only two of them will make a perceptible difference. The user may therefore spend a lot of time adjusting the parameters-to-no avail because he does not have an intuitive understanding of how the keyer works. Direct manipulation assists the user by changing particular parameters depending upon a region of the matte that the user has specified as being incorrect.

Thus at step 3401 the user selects a single pixel in the matte by clicking on it. It would usually be in an area where the matte is not to the user's satisfaction, often at the edge of the talent or in unevenly lit portions of the blue screen. At step 3402 an impact is calculated for each parameter with respect to that pixel, the impact reflecting how much the pixel's matte value will be changed if that parameter is adjusted.

At step 3403 the two parameters with the highest impact are selected and at step 3404 the user adjusts the selected parameters.

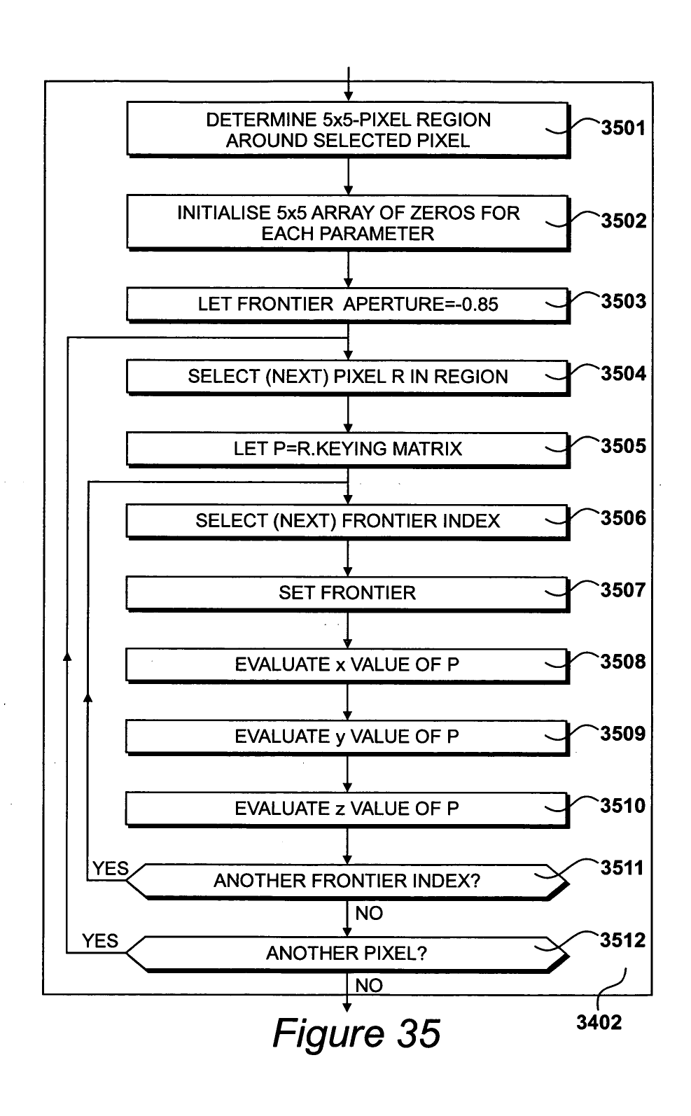

FIG. 35

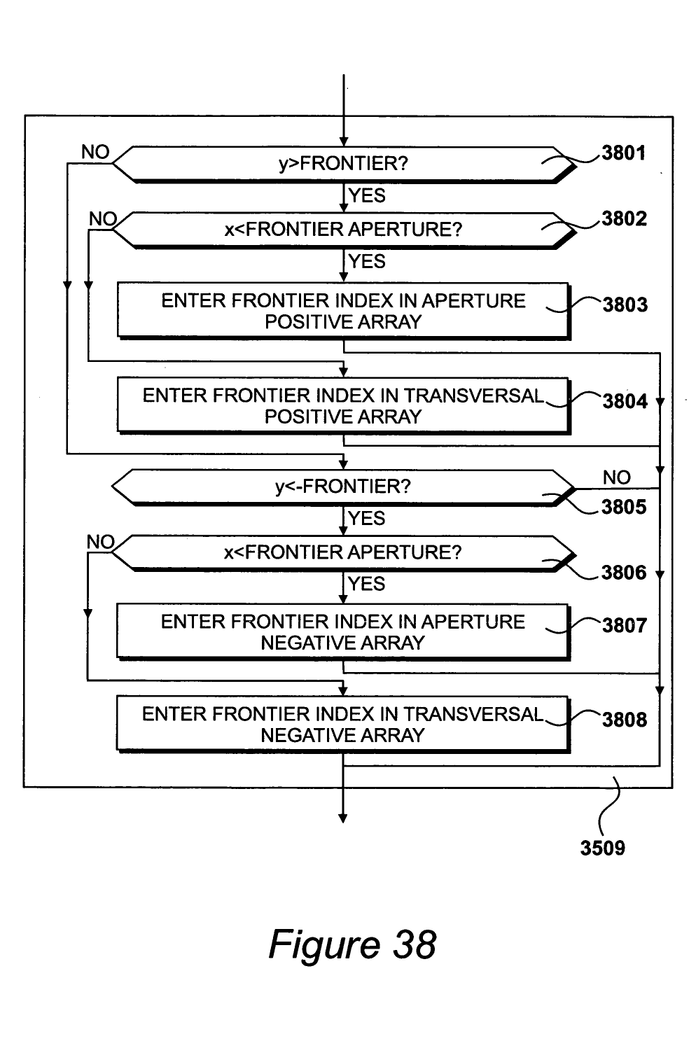

FIG. 35 details step 3402 at which the impact of each parameter on the selected pixel is analysed. At step 3501 a 5×5 pixel region of the foreground image is determined with the selected pixel in the centre and at step 3502 a 5×5 data array is initialised and stored for each parameter, each array consisting entirely of zeros. At step 3503 a parameter frontier aperture is set to be −0.85. This parameter is used during step 3509, which will be discussed with reference to FIG. 38.

At step 3504 the first pixel in the 5×5 region is selected and at step 3505 it is transformed by keying matrix 2401.

At step-3506 the first frontier index is selected. There are five frontiers with indices one to five. At step 3507 a frontier associated with the frontier index is set.

At step 3508 the pixel's transformed x value is assessed with respect to this frontier, at step 3509 its y value is assessed and at step 3510 its z value is assessed. Each assessment may result in the current index being entered in a parameter's array.

At step 3511 a question is asked as to whether there is another frontier index and if this question is answered in the affirmative then control is returned to step 3506 and the next index is selected. If it is answered in the negative then the pixel has been considered with respect to all the frontiers and so a question is asked at step 3512 as to whether there is another pixel in the region. If this question is answered in the affirmative then control is returned to step 3504 and the next pixel is selected. If it is answered in the negative then step 3402 is concluded.

At the end of this step each parameter array will either be still composed of zeros or have various entries of the numbers zero to five.

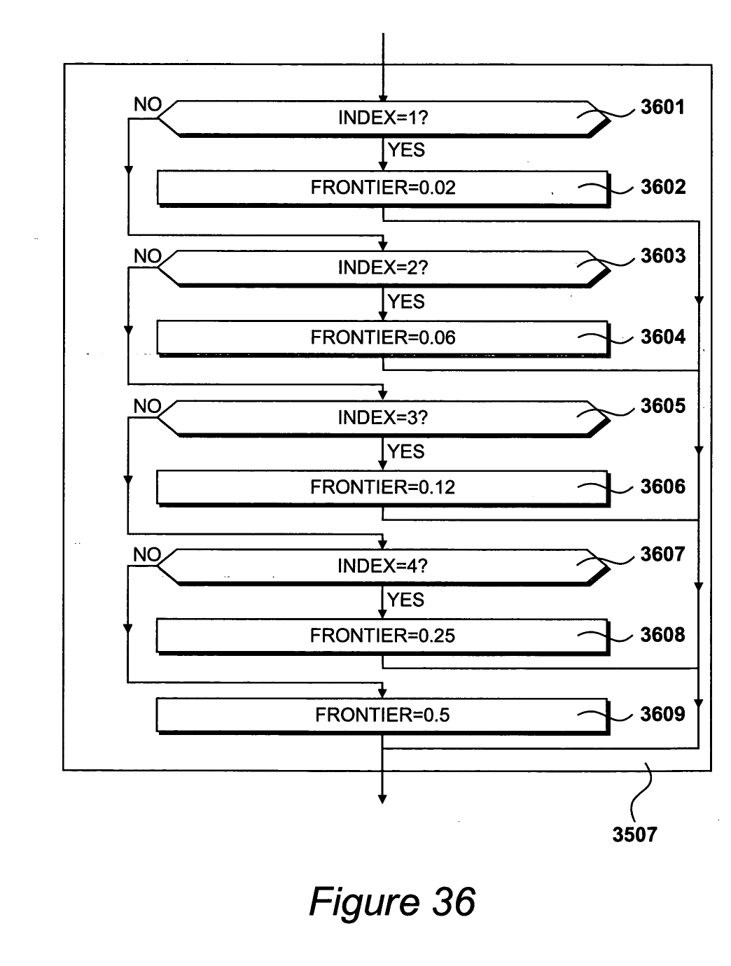

FIG. 36

FIG. 36 details step 3507 at which the frontier associated with the frontier index is set at step 3506.

At step 3601 a question is asked as to whether the index is equal to one. If this question is answered in the affirmative then at step 3602 the frontier is set to be 0.02. If it is answered in the negative then a question is asked at step 3603 as to whether the index is equal to two. If this question is answered in the affirmative then at step 3604 the frontier is set at 0.06, but if it is answered in the negative then at step 3605 a question is asked as to whether the index is equal to three. If this question is answered in the affirmative then at step 3606 the frontier is set to be 0.12. If it answered in the negative then a question is asked at step 3607 as to whether the index is equal to four. If this question is answered in the affirmative then at step 3608 the frontier is set to be 0.25 and if it is answered in the negative then the index must be equal to five and so the frontier is set to be 0.5 at step 3609.

These frontiers represent the distance of a pixel from the reference color. Thus, for example, if a pixel has a transformed x value of more than 0.5 then it has an index of five for the opponents parameter 2212. This means that adjusting that parameter would have a very high impact on the pixel.

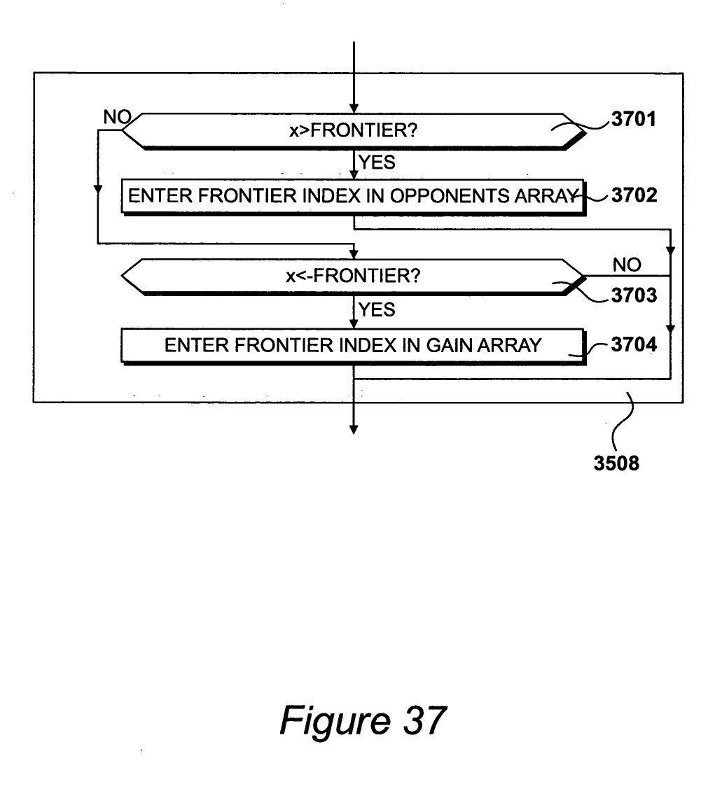

FIG. 37

FIG. 37 details step 3508 at which the pixel's transformed x value is evaluated. At step 3701 a question is asked as to whether the x value is higher than the current frontier. If this question is answered in the affirmative then at step 3702 the frontier index is entered in the array for the gain parameter 2212, in the same position as the pixel's position in the 5×5 region.

If the question asked at step 3701 is answered in the negative then at step 3703 a question is asked as to whether the value of x is less than the frontier value multiplied by minus one. If this question is answered in the affirmative then the frontier index is entered in the appropriate position in the array for gain parameter 2213 at step 3704.

If the question asked at step 3703 is also answered in the negative then step 3508 is concluded. Thus, if the absolute value of x is not greater than the frontier then no entry is made in an array. However, if the positive or negative value of x is higher than the frontier then an entry is made in either in the opponents or gain array respectively.

FIG. 38

FIG. 38 details step 3509 at which the transformed y value of the selected pixel is evaluated. Whereas the x value only was used to choose between gain parameter 2212 and opponent 2213, the x and y values are used to choose between both transversal parameters and both aperture parameters, that is parameters 2216 to 2219. If the y value is positive then only the transversal positive and aperture positive will be affected, and similarly if it is negative. However, the x value is then used to decide between these two.

Thus, at step 3801 a question is asked as to whether the transformed y value of the pixel is greater than the current frontier. If this question is answered in the affirmative then at step 3802 a further question is asked as to whether the x value is less than the frontier aperture value, which is normally set to −0.85 at step 3503. If the question is answered in the affirmative then at step 3803 the frontier index is entered in the appropriate position in the array for aperture positive parameter 2218. If it is answered in the negative then the index is entered in the array for transversal positive parameter 2216 at step 3804.

If the question asked at step 3801 is answered in the negative, to the effect that the value of y is not greater than the frontier, then at step 3805 a further question is asked as to whether the value of y is less than the frontier multiplied by minus one. If this question is answered in the negative then the absolute value of y is less than the frontier and so step 3509 is concluded with no entry being made in any array. However, if it is answered in the affirmative then at step 3806 a further question is asked as to whether the x value is less than the frontier aperture. If this question is answered in the affirmative then at step 3807 the frontier index is entered in the array for aperture negative parameter 2219. However, if it is answered in the negative then at step 3808 the index is entered in the array of transversal negative parameter 2217. At this point, and following steps 3803, 3804 and 3807, step 3509 is concluded.

Thus, if the absolute value of y is greater than the frontier then an entry is made in the array for either the transversal positive or transversal negative parameter, as appropriate. However, if additionally the pixel's transformed x value is within 0.15 of frontier 2304 then the entry is instead made in either the aperture positive or aperture negative array as appropriate.

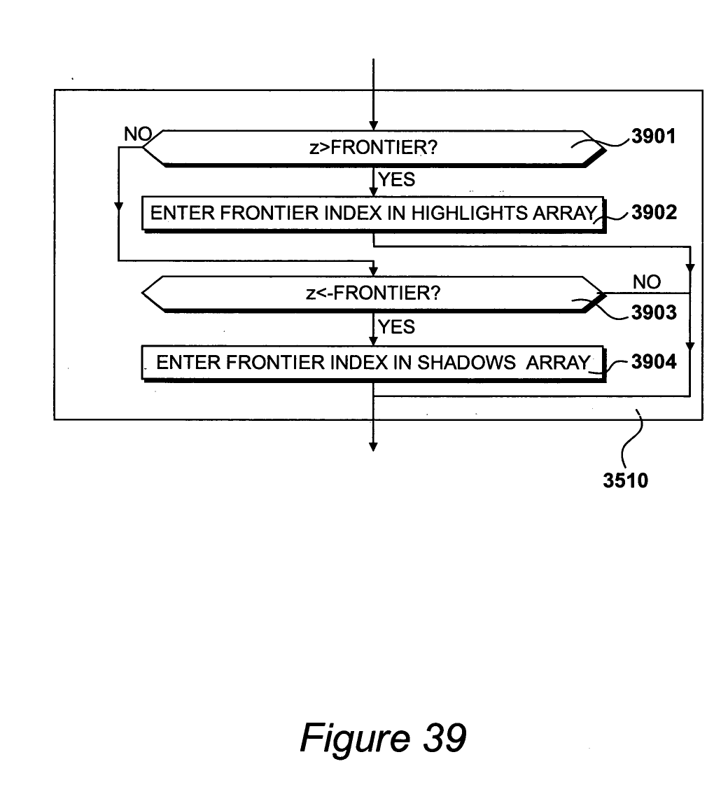

FIG. 39

FIG. 39 details step 3510 at which the transformed z value of the pixel is evaluated. At step 3901 a question is asked as to whether the z value is greater than the frontier and if this question is answered in the affirmative then at step 3902 the index is entered in the array for highlights parameter 2214. If it is answered in the negative then a further question is asked at step 3903 as to whether the transformed z value is less than the frontier multiplied by minus one. If this question is answered in the affirmative then at step 3904 the index is entered in the appropriate position in the array for shadows parameter 2215. If it is answered in the negative then 3510 is concluded with no entry being made.

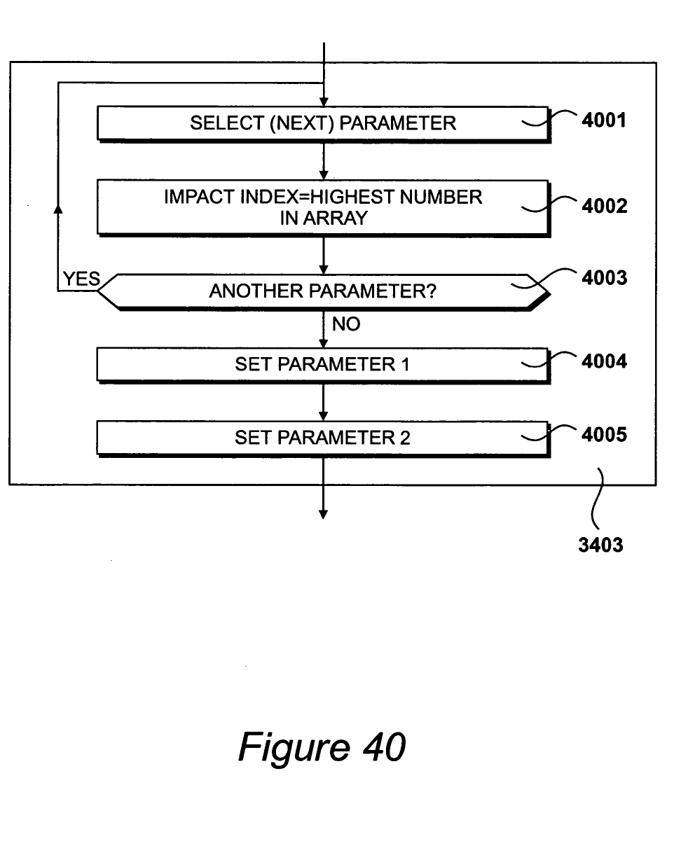

FIG. 40

FIG. 40 details step 3403 at which the two parameters that would have the highest impact on a selected pixel if changed are selected. At the conclusion of step 3402 each of the eight parameter arrays contains numbers relating to where the transformed pixels are in relation to the five frontiers. Thus, for example, if each of the pixels in the 5×5 region had a transformed x value that was higher than 0.25 and three of those pixels had a transformed x value of higher than 0.5, then the array for gain parameter 2212 would consist of twenty-two entries of the index four and three entries of the index five.

The overall index of the array is defined as the highest index in it, and so at step 4001 the first parameter is selected and at step 4002 an impact index is assigned to that parameter which is the highest value in its array. At step 4003 a question is asked as to whether there is another parameter and if this question is answered in the affirmative then control is returned to step 4001 and the next parameter is selected. If the question is answered in the negative then each parameter now has an impact index.

At step 4004 one of the parameters is set to be parameter 1 and another parameter is set to be parameter 2 at step 4005, according to the parameter impact indices.

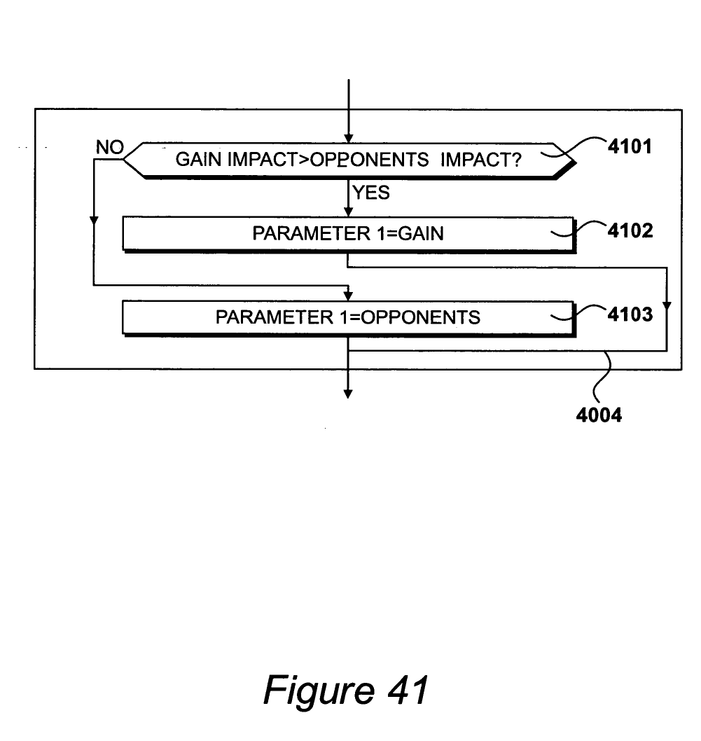

FIG. 41

FIG. 41 details step 4004 at which parameter 1 is set. At step 4101 a question is asked as to whether the impact index of gain parameter 2212 is greater than the impact index of opponents parameter 2213. If this question is answered in the affirmative then at step 4102 parameter 1 is set to be gain parameter 2212 and if it is answered in the negative then at step 4103 it is sets to be opponents parameter 2213. Thus parameter 1 is set to be whichever of gain or opponents has the highest impact index, with gain taking precedence if they are equal. This normally happens if both have an index of zero, in which case it does not matter which is selected.

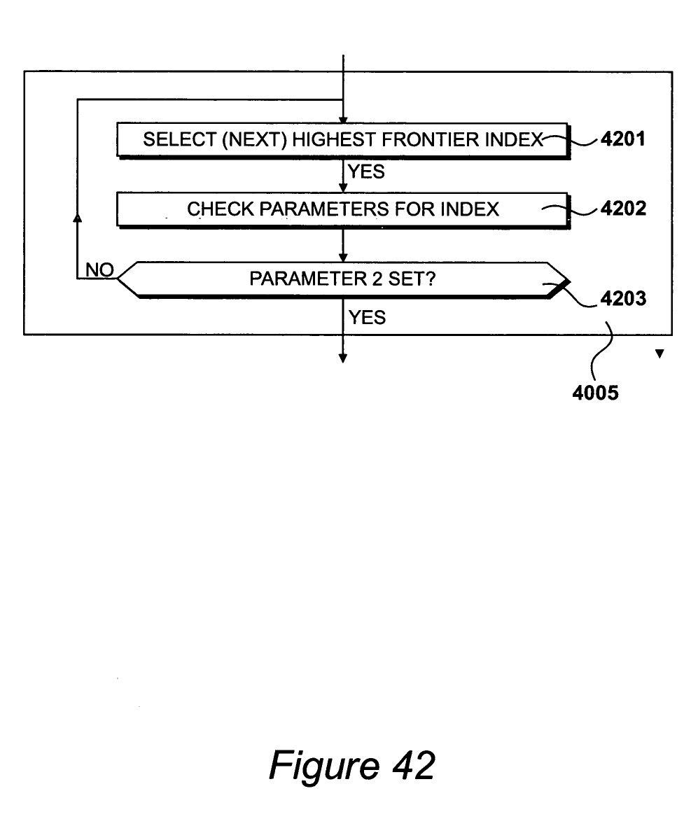

FIG. 42

FIG. 42 details step 4005 at which parameter 2 is set. At step 4201 the highest frontier index, that is index five, is selected and at step 4202 the remaining parameters are checked for that index. If one of them has that index then it is set to be parameter 2 and so at step 4203 a question is asked as to whether parameter 2 has been set. If it is answered in the negative then control is returned to step 4201 and the next highest frontier index is selected.

Eventually parameter 2 will be set, since each parameter has an index of at least zero, and the question asked at step 4203 will be answered in the affirmative. Step 4005 is then complete.

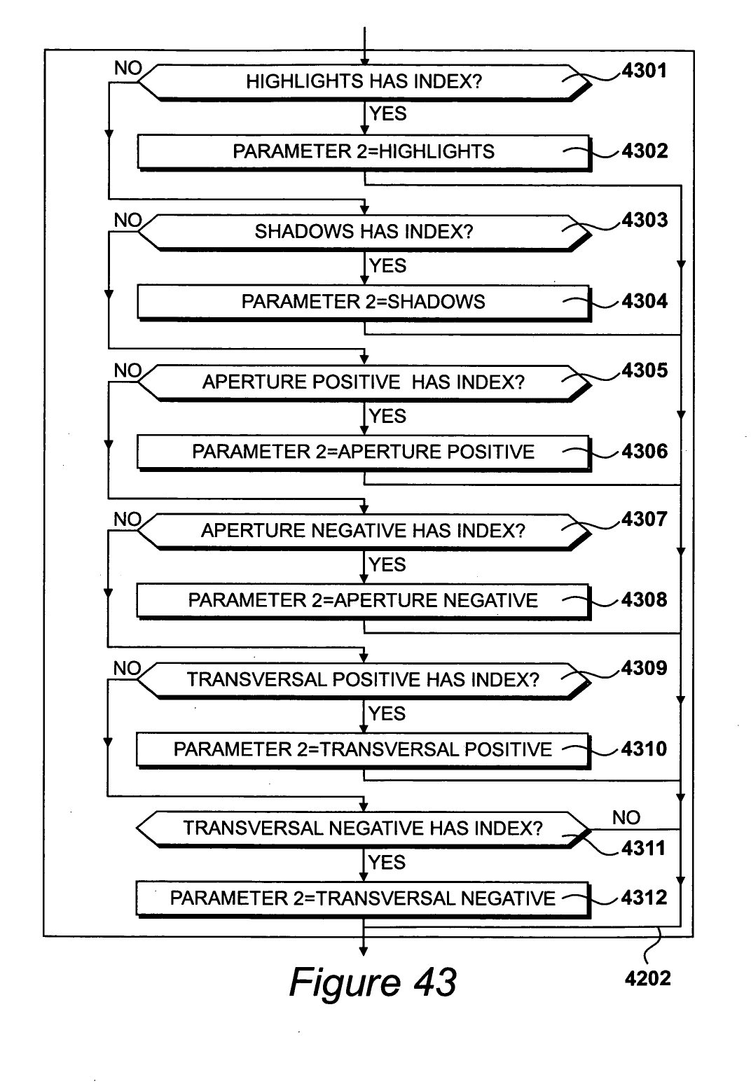

FIG. 43

FIG. 43 details step 4202 at which each of parameters 2214 to 2219 s checked to discover whether it has the frontier index selected at step 4201. Thus at step 4301 a question is asked as to whether highlights parameter 2214 has the index and if this question is answered in the affirmative then parameter 2 is set to be highlights parameter 2214 at step 4302. If the question is answered in the negative then at step 4303 a question is asked as to whether shadows parameter 2215 has the index and if this question is answered in the affirmative then at step 4304 parameter 2 is set to be shadows parameter 2215.

If the question asked at step 4303 is answered in the negative then at step 4305 a question is asked as to whether aperture positive parameter 2218 has the index and if this question is answered in the affirmative then at step 4306 parameter 2 is set to be aperture positive parameter 2218. However, if it is answered in the negative then at step 4307 a question is asked as to whether aperture negative parameter 2219 has the index. If the question is answered in the affirmative then at step 4308 parameter 2 is set to be aperture negative parameter 2219.

If the question asked at step 4307 is answered in the negative then at step 4309 a question is asked as whether transversal positive parameter 2216 has the index and if this is answered in the affirmative then at step 4310 parameter 2 is set to be transversal positive parameter 2216. If it is answered in the negative then at step 4311 a question is asked as to whether transversal negative parameter 2217 has the index. If this question is answered in the affirmative then at step 4312 parameter 2 is set to be transversal negative parameter 2217. If it is answered in the negative, and following any of steps 4302, 4304, 4306, 4308, 4310 or 4312, step 4202 is concluded, either with parameter two having been set or with none of the parameters having the required index.

Thus, if more than one of the parameters has the same index then the order of precedence is highlights or shadows, aperture and then transversal.

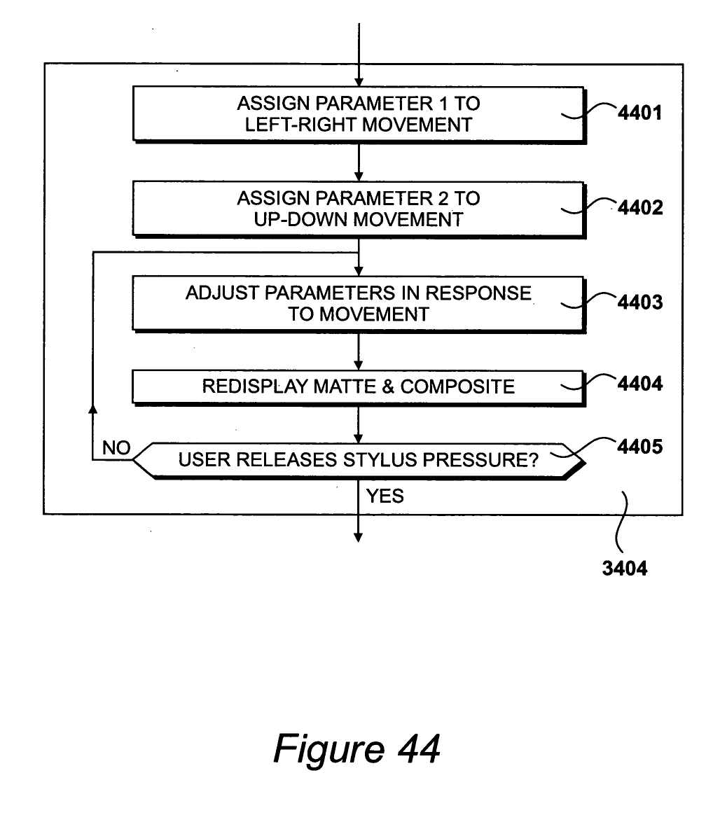

FIG. 44

FIG. 44 details step 3404 at which the user adjusts the parameters selected at step 3403 as having the highest impact on the selected pixel. At step 4401 the parameter set as parameter 1 is assigned to left-right movement of the stylus 105 and at step 4402 the parameter set as parameter 2 is assigned to up-down movement of the stylus. At this point the user still has the stylus pressed on the position of the pixel he selected at step 3401. (Similarly, if the user were using a mouse he would still have the button pressed). Releasing pressure on the stylus at any time during the previous calculations would cease the direct manipulation process.

Thus, at step 4403 the parameters set as 1 and 2 are adjusted in response to movement of the stylus. For example, if the user moves the stylus to the right then the parameter set as parameter 1 will be increased, while if he moves it diagonally down and to the left both parameters will be decreased. Movement of the stylus is incremented such that when a first increment is passed the matte and composite are recomputed and redisplayed at step 4404. At step 4405 a question is asked as to whether the user has released pressure on the stylus. If this question is answered in the affirmative then step 3404 is completed but if it is answered in the negative then control is returned to step 4403 and the parameters are adjusted in response to the next increment of movement.

Thus from the user's point of view, he places the stylus over an area of the matte which is unsatisfactory, puts pressure on the stylus to select it and immediately starts dragging the stylus in any direction to see how changing the parameters that affect his selected pixel will affect the entire matte. Thus he does not even have to consider how much a parameter should be changed, but can simply move the stylus around until the matte appears as he would wish. If he goes too far in one direction and the change in parameters starts to affect other, satisfactory areas of the matte then he can simply move the stylus back. When he is happy with the result he releases pressure on the stylus. Alternatively the direct manipulation process may show him instantly that there are no parameters that affect that pixel, by the fact that the matte is not changing as he moves the stylus. In this case he can consider changing intrusion parameter 2211 or applying patches. He can then repeat the process by selecting another pixel in the matte or adjusting the parameters manually.

Intrusion parameter 2211 must always be adjusted manually. It is not included in the direct manipulation process since adjusting the intrusion changes keying matrix 2401 and thus will always have an impact on the matte.

When the user has finished adjusting the parameters he proceeds to step 504 to apply patches. Each pixel now has RGB values that have been color warped and a matte value.

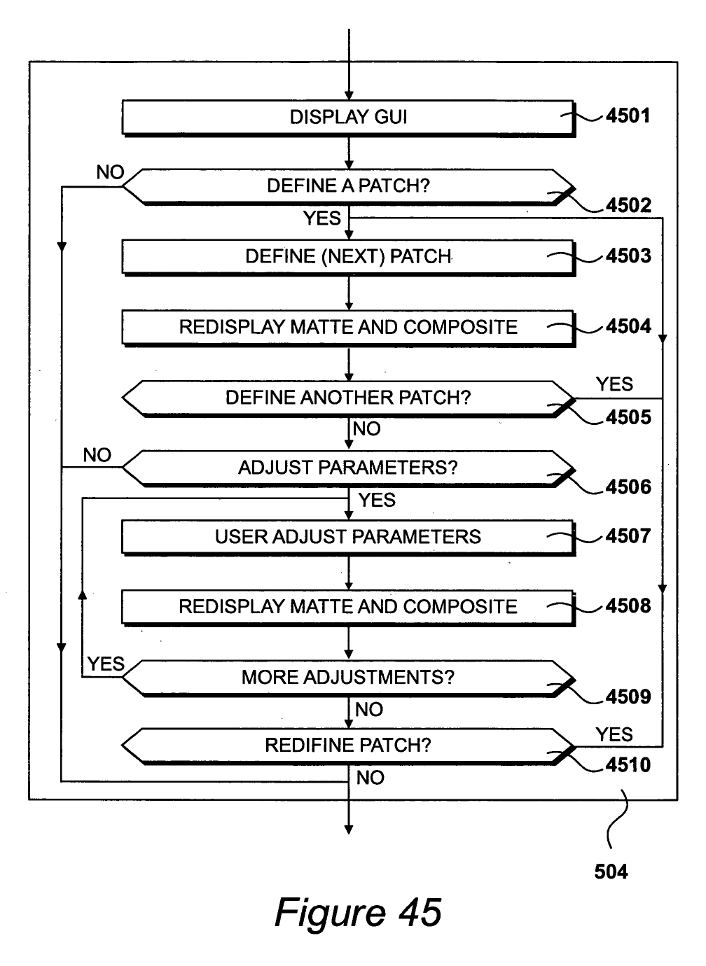

FIG. 45

FIG. 45 details step 504 at which the user applies patches to the matte if required. A patch defines a small volume within the RGB color-space and a rule to be applied to pixels having colors within that volume. Often this rule is in direct contradiction to what happens to those pixels according to the keyer. For example, if an area of the talent is colored blue then it may be very difficult to adjust parameters 2211 to 2219 such that the pixels belonging to the blue screen have a matte value of zero while the blue pixels belonging to the talent have a matte value of one. In this case, it may be easiest to set the keyer parameters such that the rest of the image is satisfactory but the blue pixels in the talent have a matte value of zero, and then apply a patch which rules that pixels of that very specific blue have a matte value set to one. This does not affect the matte value of pixels having any other color.

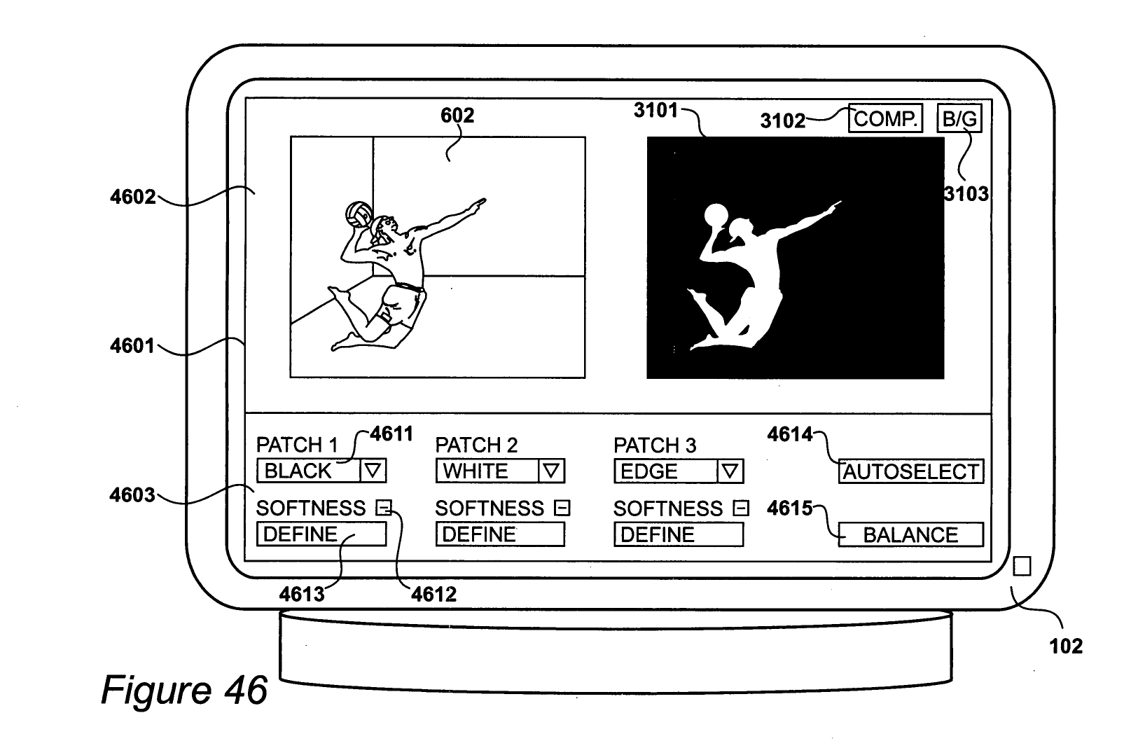

Thus at step 4501 a patch GUI is displayed to the user which will be discussed further with reference to FIG. 46. This GUI allows the user to define up to three patches, adjust the parameters for the patches or proceed to the edge balancing at step 505. Thus at step 4502 a question is asked as to whether the user wishes to define a patch. This is answered in the negative by the user indicating that he wishes to proceed to step 505 and in this case step 504 is concluded. Since no patches have yet been defined any other input from the user must be an indication that he wishes to define a patch and so at step 4503 a patch is defined. At step 4504 the matte and composite are recalculated and displayed.

At step 4505 a question is asked as to whether the user wishes to define another patch. User input at this point indicating the he does will return control to step 4503. Any other input will result in a negative answer and a second question being asked at step 4506 as to whether the user wishes to adjust the parameters. If the user has selected a parameter then this question is answered in the affirmative and control is directed to step 4507. However if this question is answered in the negative then the input must have been an indication that the user wishes to proceed to step 505 and so step 504 is completed.

At step 4507, if required, the user adjusts a parameter of an already defined patch and at step 4508 the matte and composite are again recalculated and displayed. At step 4509 a question is asked as to whether more adjustments are to be made. If this question is answered in the affirmative by the user selecting a parameter value control is returned to step 4507. Any other input will result in a negative answer and the question being asked at step 4510 as to whether he wishes to define a patch. This may also be a redefinition of an existing patch. A selection by the user to this effect returns control to step 4503. If the selection made by the user indicates that he neither wishes to adjust the parameters nor define a patch then it is an indication that he wishes to proceed to step 505 and so step 504 is concluded.

FIG. 46

FIG. 46 illustrates GUI 4601 as displayed to the user on VDU 102. It includes first area 4602 that comprises foreground image 602 and matte 3101, calculated according to the final parameters at the conclusion of step 503. Icons 3102 and 3103 again allow the user to display the composited image or the background image respectively.

The second area 4603 of the GUI includes controls for three patches. For each patch there is a dropdown box 4611 to indicate the type of patch required, a softness parameter 4612 and a button 4613 allowing the user to define the region in color-space to which the patch is to be applied. Each of the three patches is processed in exactly the same way and so the process will be described with reference only to patch one. After every definition of a patch or change to a parameter the matte value of every pixel is updated, it is not possible to change two patches at once and so no necessity in this document to distinguish between the three.

For each patch there are three rules that can be applied and dropdown box 4611 specifies this. A black patch specifies that all the pixels having colors within the defined color volume are to have their matte value reduced and a white patch indicates that every pixel with a color inside the specified color volume is to have its matte value increased. The decrease or increase in either case is set by softness parameter 4612. The third option, edge analysis, computes a pixel's position within the specified color volume and uses that position to determine how much of the softness parameter 4612 should be removed from the matte. Although in this example patch one applies the black rule, patch two applies the white rule and patch three applies edge analysis, there is no need for each of the three patches to apply a different rule.

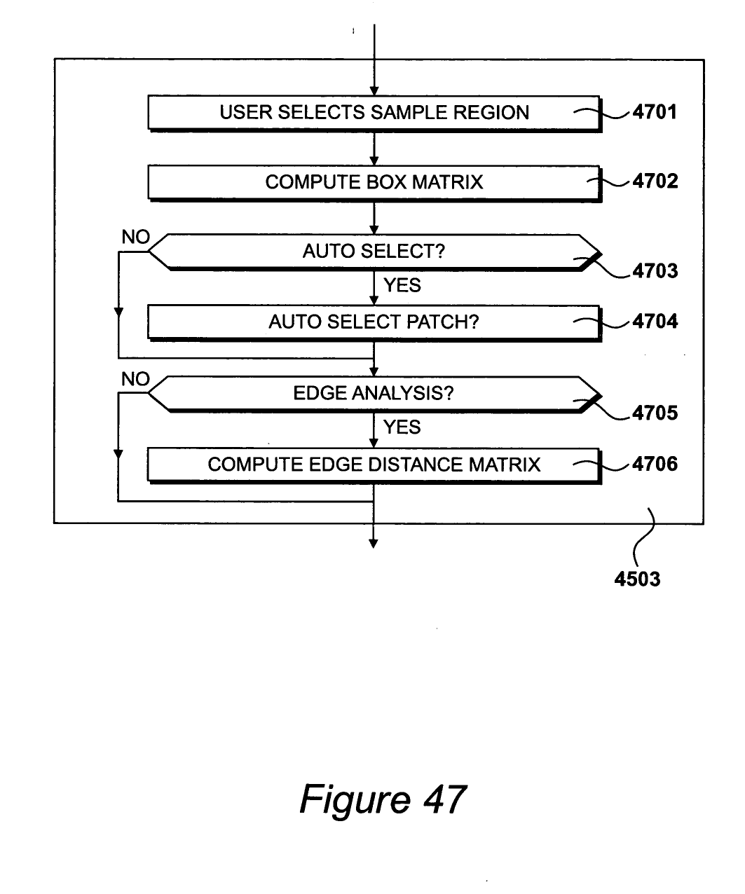

FIG. 47

FIG. 47 details step 4503 at which a patch is defined. At step 4701 the user selects a sample region within the foreground image, the matte, the composite image or even the background image. This region can be as large or as small as the user wishes and need not be continuous. For example, the user can select a region by using a drag box, selecting individual pixels or a combination of these by holding down a modifier key on the keyboard.

When the user has finished selecting his sample region a box matrix is computed at step 4702. The box matrix is a transformation that is used to find out whether a pixel in the foreground image has a color that is similar to those in the sampled region. It should be remembered that although the user makes a selection of pixels, the patch is not only applied to those pixels but to any pixel falling within the color volume that they define.

At step 4703 a question is asked as to whether the user wishes to allow the application to autoselect which patch rules should be applied. This is answered in the affirmative by the user selecting button 4614 and at step 4704 the sampled region is analysed to determine whether the patch should be black, white or edge analysis. The question asked at step 4703 is answered in the negative by the user determining himself which rule should be applied by a selecting one from the drop-down menu 4611.

Whichever method of determining the patch type is applied, at step 4705 a question is asked as to whether the patch is an edge analysis patch. If this question is answered in the affirmative then an edge distance matrix is computed at step 4706. This matrix is used in determining the position of a pixel's color within the defined volume. At this point, and if the question asked at step 4705 is answered in the negative, step 4503 is completed.

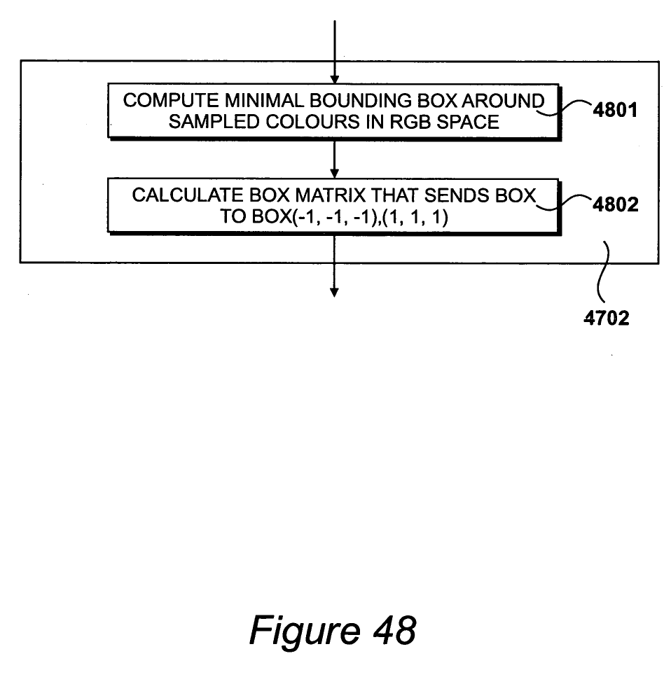

FIG. 48

FIG. 48 shows step 4702 at which the box matrix is computed. At step 4801 a minimal bounding box is defined around the sampled colors in the RGB color-space. A matrix is then calculated that transforms the box defined in step 4801 to the cube having defining points at (−1, −1, −1) and (1, 1, 1). This matrix is called the box matrix and the cube is called the standardised cube. The minimal bounding box is the defined color volume referred to previously.

The process of defining a convex hull around a cloud of points in color-space, computing a minimal cuboid around them and then transforming the cuboid into the standardised cube is described in United Kingdom Patent No. 2 336 054, which is incorporated herein by reference, and so will not be discussed further here.

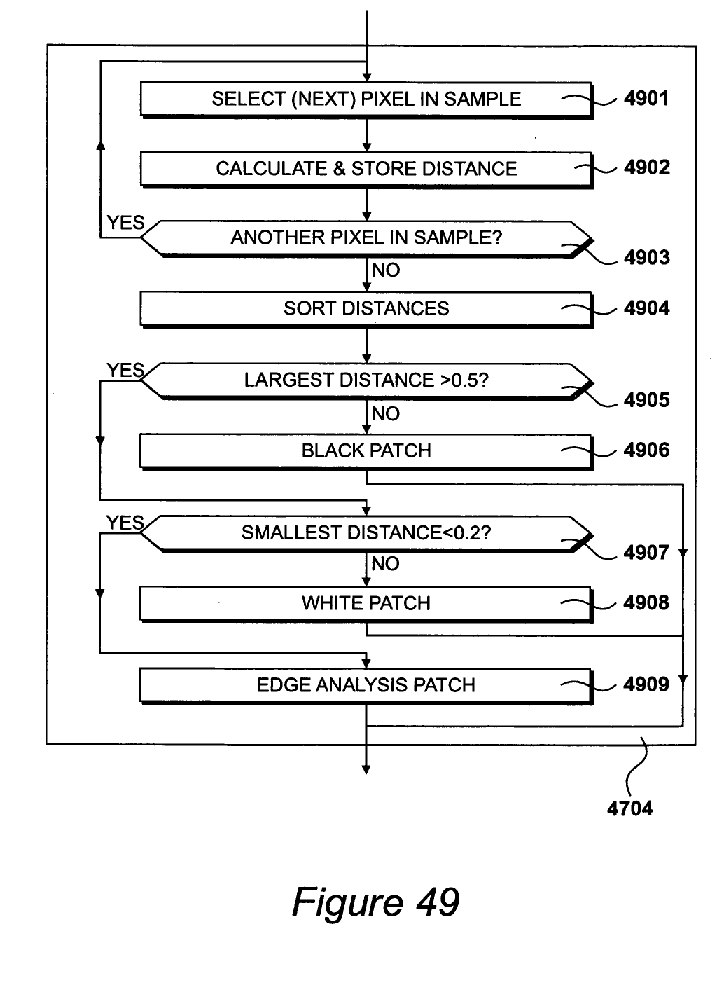

FIG. 49

FIG. 49 details step 4704 at which the autoselect determines whether the patch should be black, white or edge analysis. This is decided by the distances between the colors of the pixels selected at step 4701 and the reference color. Thus at step 4901 the first pixel in the sample is selected and at step 4902 a distance is calculated and stored for that pixel. At step 4903 a question is asked as to whether there is another pixel in the sample and if this question is answered in the affirmative then control is returned to step 4901 and the next pixel is selected.

If the question asked at step 4903 is answered in the negative, to the effect that all the pixels have been processed, then at step 4904 the stored distances are sorted by magnitude in order to obtain a smallest distance and a largest distance. At step 4905 a question is asked to whether the largest distance is greater than 0.5. If this is answered in the negative then the patch is set to be a black patch at step 4906 and this is indicated by an alteration of drop-down box 4611.

If the question asked at step 4905 is answered in the affirmative then at step 4906 a question is asked as to whether the smallest distance is less than 0.2. If this question is answered in the negative then the patch is set to be a white patch at step 4908 and if it is answered in the affirmative then it is set to be an edge analysis patch at step 4909.

Therefore, if the sample contains no pixels that are at a distance greater than 0.5 from the reference color then the patch is black. Subject to this, if the sample contains no pixels having a distance of less then 0.2 from the reference color then the patch is set to be white. However, if the sample contains both pixels that are a distance of greater than 0.5 and pixels that are at a distance less than 0.2 from the reference color then the user has selected pixels that have colors very different from each other and so are probably on an edge. Thus an edge analysis patch is automatically selected. The user can, of course, change the patch manually if required.

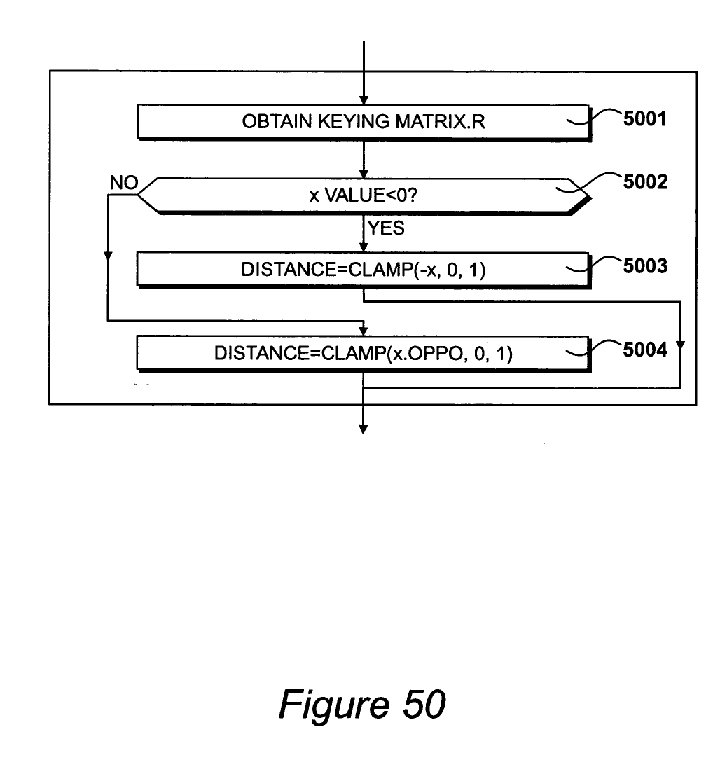

FIG. 50

FIG. 50 details step 4902 at which the distance of the color of the pixel from the reference color is calculated. The reference color is the reference color specified during the matte extraction step 503. If the reference color was changed during this step then it is the last specified reference color. It is thus the reference color that the current matte values have been calculated with respect to. It will be recalled that applying keying matrix 2401 to the reference color takes it to the point (0, 0, 0, 1). The distance calculated at step 4902 is computed within this transformation. Thus at step 5001 the pixel value is multiplied by keying matrix 2401.

A question is then asked at step 5002 as to whether the x value of the product of step 5001 is less than zero. If this question is answered in the affirmative then at step 5003 the distance of that pixel is set to be its transformed x value multiplied by minus 1, clamped between zero and one.

If the question asked at step 5002 is answered in the negative then at step 5004 the distance of the pixel is set to be its transformed x value multiplied by opponents parameter 2213, again clamped between zero and one.

Thus, referring to FIG. 3, if the transformed pixel is on the left of the reference color then its distance is its absolute x value. However, if it is on the right-hand side its distance is modified by the opponents parameter 2213, this being the final value of the parameter when step 503 was concluded.

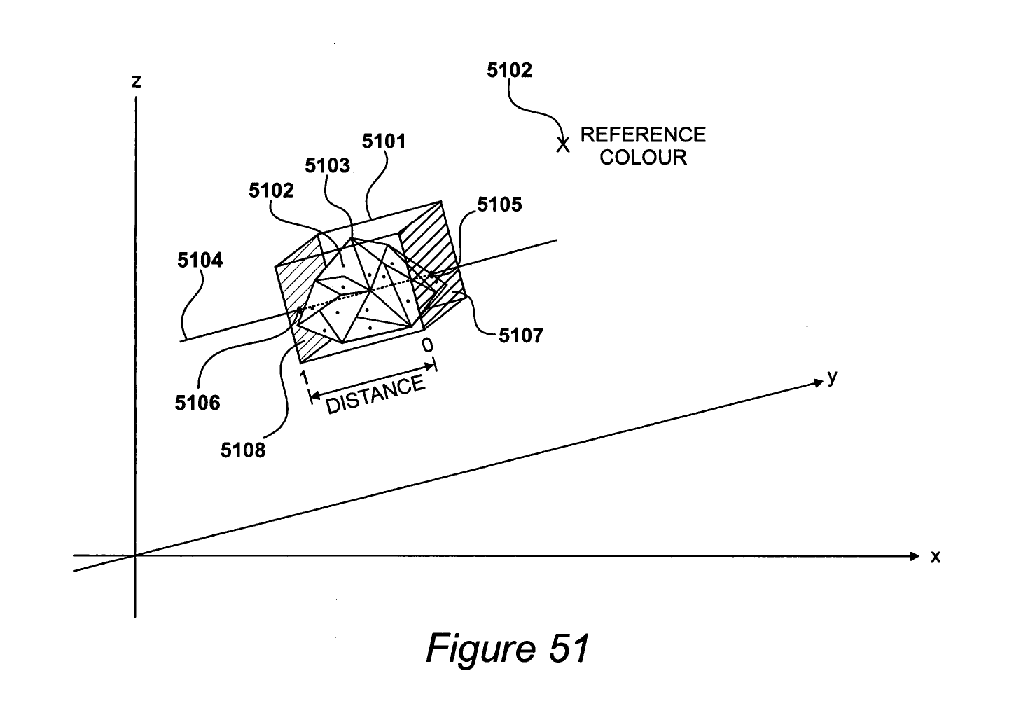

FIG. 51

FIG. 51 shows a color volume 5101 and a reference color 5102. Volume 5101 is the smallest cuboid that can fit around the cloud of points 5103, defined by a convex hull. The box is in RGB space and so the pixel's x value represents red, its y value represents green and its z value represents blue. It can be seen that the edges of box 5101 are not parallel to any of the axes. This is not a rule but is usually the case when computing minimal bounding boxes.

For an edge analysis patch it is necessary to compute an idea of distance within box 5101. This is done by extending an imaginary line 5104 through the middle of box 5101, running parallel to the longest edges. This line extends through the centres 5105 and 5106 respectively of the shaded faces 5107 and 5108 of box 5101. These are the faces that are perpendicular to line 5104. By determining which of these faces is closest to reference color 5102 the distance can be orientated. In this example, face 5107 is closer to reference color 5102 and therefore any pixels having a color point on face 5107 have a distance of zero, while any pixels having a color point on face 5108 have a distance of one. All other pixels having color points within volume 5101 have a distance measurement that is proportional to its distance from face 5107, measured parallel to line 5104.

Thus, the edge distance of a pixel represents how far away it is from the reference color but is measured according to color volume 5101.

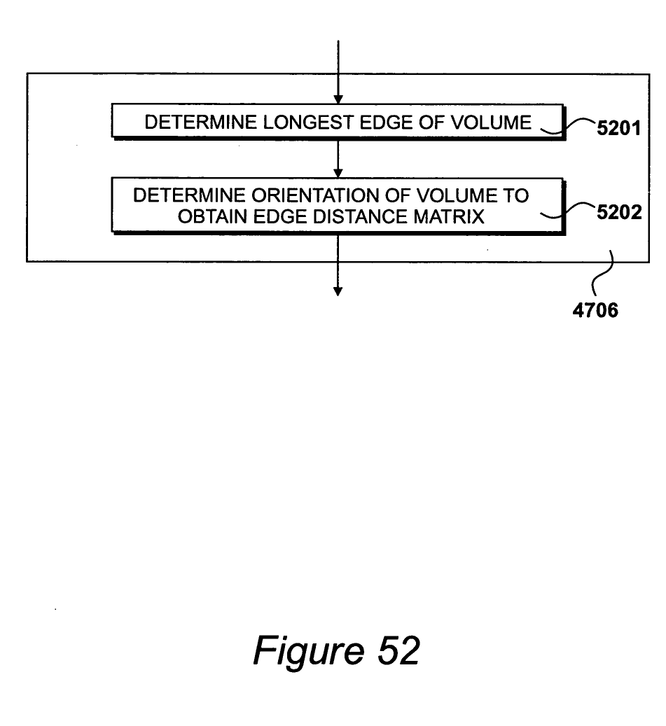

FIG. 52

FIG. 52 shows step 4706 at which the edge distance matrix is computed if the patch is an edge analysis patch. At step 5201 the longest edge of the color volume 5101 is determined and at step 5202 the orientation of the volume is determined. This gives a single-column matrix called the edge distance matrix. Multiplying any color point by this matrix will give its edge distance within volume 5101.

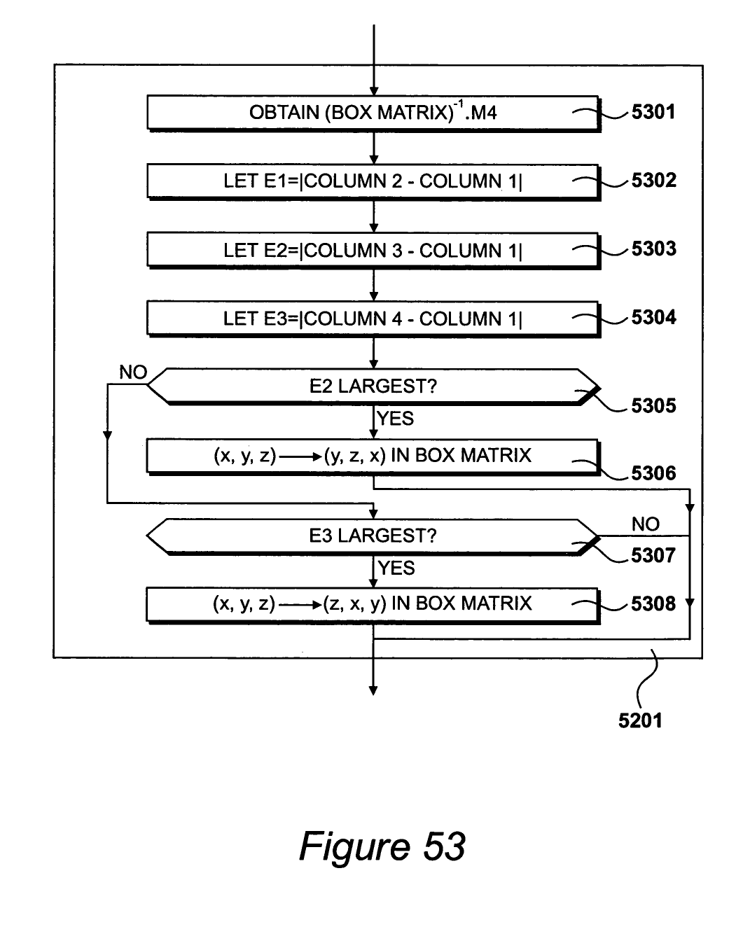

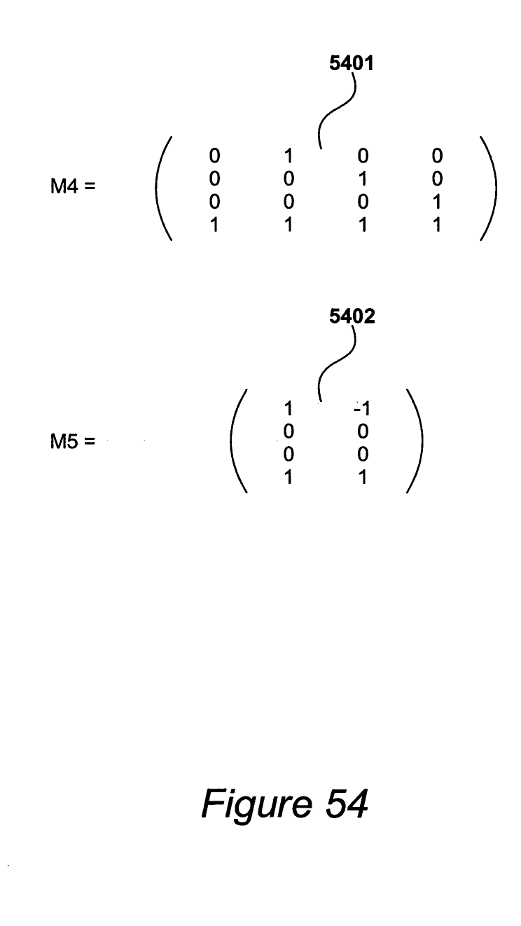

FIGS. 53 and 54

FIG. 53 details step 5201 at which the longest edge of volume 5101 is determined. At step 5301 a matrix M4 is multiplied by the inverse of the box matrix computed at 4702. M4 is shown in FIG. 54 at 5401. It contains the points (0, 0, 0, 1), (1, 0, 0, 1), (0, 1, 0, 1) and (0, 0, 1, 1). Referring back to FIG. 48, applying the box matrix to volume 5101 transforms that volume to the standardised cube. The four points in matrix 5301 are the centre of the cube and the centres of three of its faces, none of the faces being opposite to either of the others. Applying the inverse of the box matrix to these points therefore transforms them to the points in the centre and on the faces of volume 5101.

Thus each column in the matrix that is the product of step 5301 represents a point. The point in column one is the centre of box 5101 and the other three are centre points of three of the faces of box 5101. One of these is either face 5107 or 5108, and the other two are two faces that are adjacent to it and also to each other. Thus at step 5301 a value E1 is set to be the distance between the point in column 2 and the point in column 1, at step 5302 a value E2 is set to be the distance between the point in column 3 and the point in column 1 and at step 5303 a value E3 is set to be the distance between the point in column 4 and the point in column 1. Whichever of these is largest shows which column contains the point that is furthest away from the centre of the volume 5101. In the example shown in FIG. 51, this will be whichever one of points 5105 or 5106 appears in the matrix obtained at step 5301.

The object of step 5201 is to obtain a reorientated box matrix such that when it is used to transformed volume 5101, line 5104 lies on the x-axis. Therefore, if value E1 is largest then this is already the case. However, if E2 or E3 is larger then the box matrix needs to be reorientated. Thus, at step 5304 a question is asked as to whether E2 is the largest of the three values. If this question is answered in the affirmative then at step 5305 the first three columns of the box matrix are reordered. The first becomes the third, the second becomes the first and the third becomes the second. The fourth column is unaltered.

If the question asked at step 5304 is answered in the negative then at step 5306 the question is asked as to whether value E3 is the largest of the three. If this question is answered in the affirmative then at step 5307 the box matrix is orientated such that the first column becomes the second, the second becomes the third and the third becomes the first. The fourth column is unaltered. If the question asked at step 5304 is answered in the negative then no reorientation needs take place and so at this point, and following steps 5405 and 5407, step 5202 is completed.

Although the box matrix has been reorientated this does not affect its use to decide whether a pixel is inside the volume. Since every edge in the standardised cube is of the same length it is unimportant for that test which axis is which.

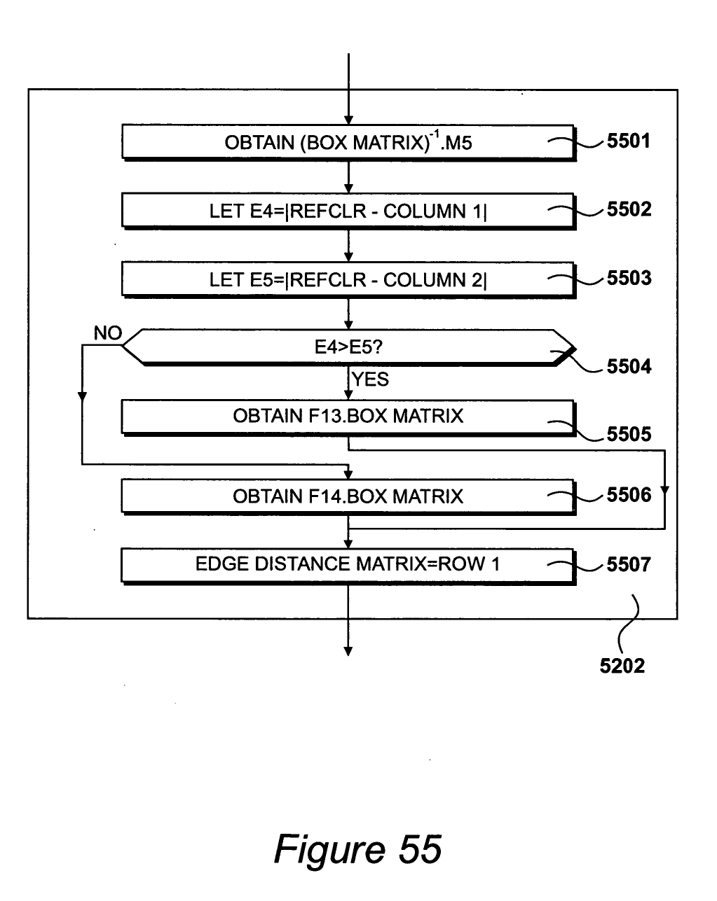

FIG. 55

FIG. 55 details step 5202 at which the edge distance matrix is obtained. At step 5501 a matrix M5 (shown in FIG. 54 at 5401) is multiplied by the inverse of the box matrix, as reorientated at step 5201. Matrix 5601 contains the points (1, 0, 0, 1) and (−1, 0, 0, 1). These points are the centres of the faces of the standardised cube that intercept the x-axis. Thus, transforming them by the inverse of the box matrix will take them to the centres of the faces of box 5101 that are at either end of line 5104.

It is thus possible to obtain the edge distance matrix by deciding which of these points is closer to the reference color. This determines which end of the line 5104 represents a zero distance and which end represents a distance of one.

The product of step 5501 is a matrix of two columns, each being at one of the two interceptions of line 5104 with box 5101. In the example shown in FIG. 51 these are points 5105 and 5106. In order to decide which end of the line should represent zero it is necessary to determine which of these two points is closest to the reference color. Thus, at step 5502 a variable E4 is set as the distance between the reference color and the first column of the matrix, and at step 5503 a variable E5 is set to be the distance between the reference color and the second column of the input matrix. At step 5504 a question is asked as to whether E4 is greater than E5. If this is answered in the affirmative then a matrix F13 is applied to the box matrix at step 5505 and if answered in the negative then a matrix F14 is applied to it at step 5506. Following either of these steps the edge distance matrix required is set to be the first row of the output at step 5507.

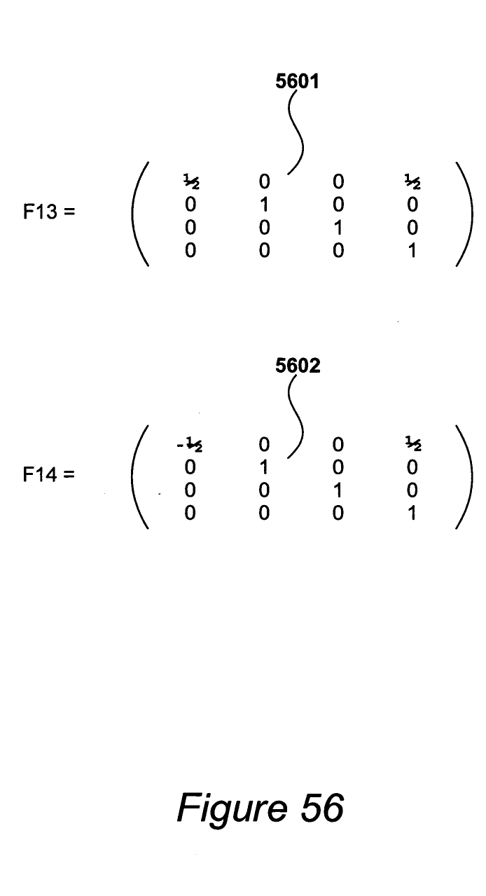

Matrices F13 and F14 are defined in FIG. 56 as matrices 5601 and 5602 respectively. Matrix F13 performs the successive transformations of translating along the x-axis by one and then scaling down the x-axis by a half. Applying F13 to the standardised cube has the effect of making the x values that fall within the cube run from zero to one instead of from minus one to one. F13 is applied to the box matrix if the value E4 is greater than E5, which means that the box matrix transforms the point that is furthest away from the reference color, in this example point 5106, to the value one on the x-axis. Thus, in this case, in order to measure a pixel's edge distance it is only necessary to apply the box matrix to it, apply matrix 5601 to it and then take the x value.

Matrix F14 is applied to the box matrix if the value of E4 is less than the value of E5. This means that, in our example, point 5106 is translated to minus one on the x-axis by the box matrix. Thus matrix 5602 is simply a scale of minus one applied to the x-axis before the translation and scaling applied by matrix F13. In this case, to find a pixel's edge distance it must be transformed by box matrix and then by matrix F14 and the x value of the product taken.

Thus, whichever of steps 5505 or 5506 is performed, the first row of the output is the edge distance matrix. The box matrix itself is left unchanged (except for the reorientation of step 5201) to be used to test whether a pixel's color is inside the color volume 5201.

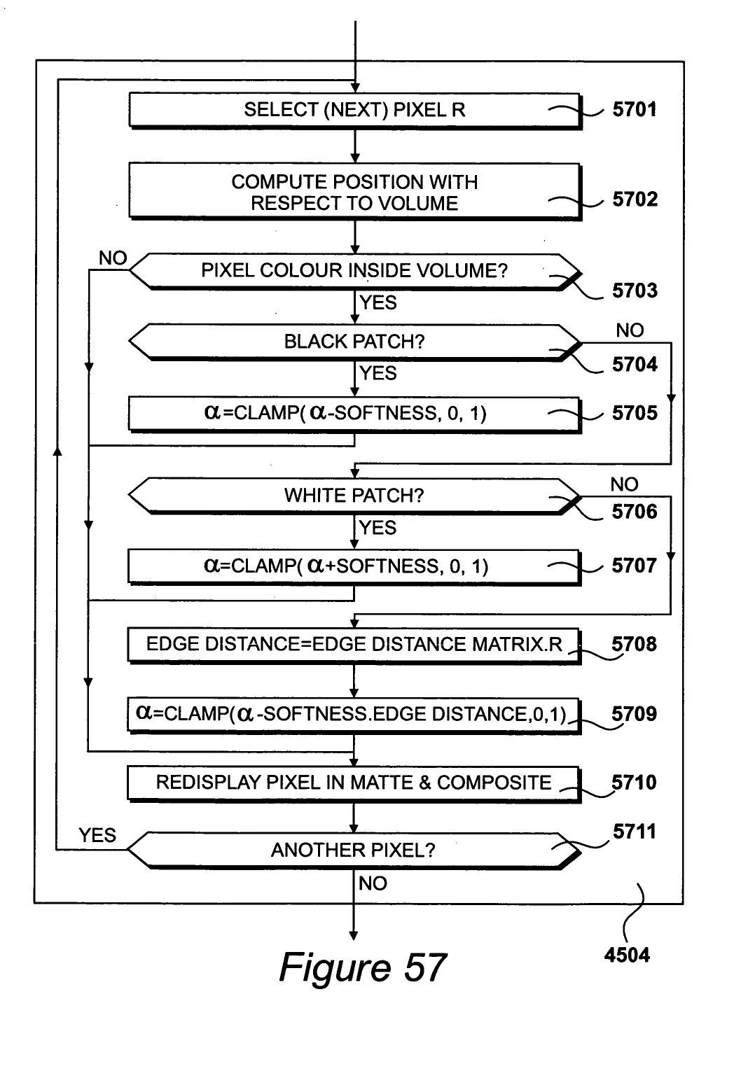

FIG. 57

FIG. 57 details step 4504 at which the matte and composite are recalculated and displayed. Step 4508 is performed in an identical manner.

At step 5701 the first pixel is the foreground is selected and at step 5702 its position with respect to the minimal volume 5101, that is whether it is inside or outside the box, is calculated. At step 5703 a question is asked as to whether the pixel is inside the box and if this question is answered in the negative then control is directed to step 5710 at which a question is asked as to whether there is another pixel in the foreground, since this pixel does not require any further processing.

If the question asked at step 5703 is answered in the affirmative, to the effect that the color of the pixel is inside the volume, then at step 5704 a question is asked as to whether the patch is a black patch. If this question is answered in the affirmative then at step 5705 a new matte value for the pixel is calculated as the softness parameter 4612 subtracted from the existing matte value, with the result clamped between zero and one.

If the question asked at step 5704 is answered in the negative, to the effect that the patch is not a black patch, then at step 5706 a question is asked as to whether it is a white patch. If this question is answered in the affirmative then the new matte value for the pixel is set to be the old value added to the softness parameter 4612, with the result clamped between zero and one at

If the question asked at step 5706 is answered in the negative, to the effect that the patch is not a white patch either, then it is an edge analysis patch. In this case the edge distance of the pixel is obtained by multiplying the pixel value by the edge distance matrix obtained at step 5507. At step 5709 the new matte value is set to be the softness parameter 4612 multiplied by the edge distance of the pixel, all subtracted from the current matte value, with the result clamped between zero and one. Thus for an edge analysis patch more of the softness contribution is subtracted from the matte if a color is closer to the reference color. Thus

At this point, and also following steps 5705 and 5707, a question is asked at step 5710 as to whether there is another pixel in the foreground. If this question is answered in the affirmative then control is returned to step 5701 and the next pixel is selected. If it is answered in the negative then all the pixels have been processed and step 4504 is concluded.

Thus at the completion of step 4504 each pixel that has a color inside the minimal volume defined by pixels sampled at step 4701 have had their matte value altered depending on what type of patch is applied.

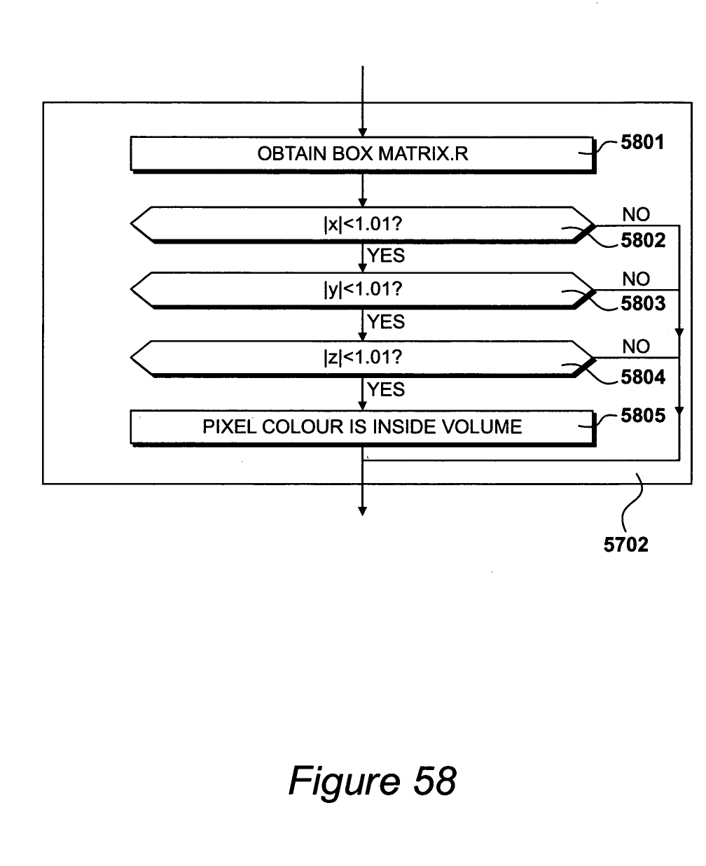

FIG. 58

FIG. 58 details step 5702 at which a pixel's position with respect to the minimal volume is calculated. It will be recalled that the box matrix transforms the minimal volume 5101 to the standardised cube. This is a cube containing all points that have values on all three axes of one or less. Thus, in order to discover whether a pixel's color is within the minimal volume it is only necessary to multiply it by the box matrix at step 5801 and ask successive questions at step 5802, 5803 and 5804 as to whether the absolute x, y and z values of the transformed point are all less than 1.01. An affirmative answer to each of these will result in the decision at step 5805 that the pixel is inside the volume. A negative answer to any of the questions will result in step 5701 being concluded and a negative answer being given to the question asked at step 5703.

This concludes the discussion of step 504, at the end of which the matte values of some or all of the foreground pixels have been altered using patches.

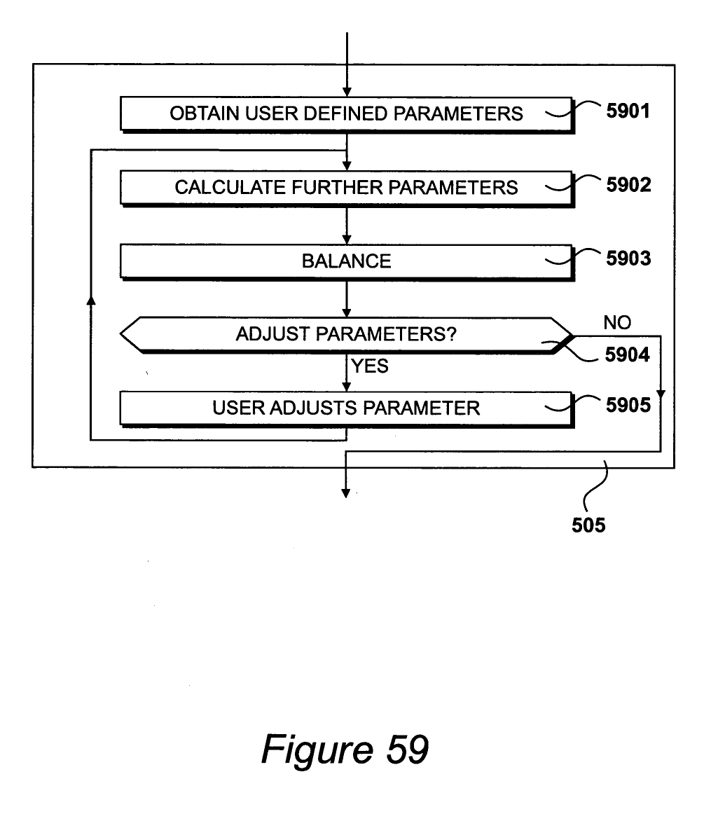

FIG. 59

FIG. 59 details step 505 at which an edge balancing process is performed. During this process the user can change the appearance in the composited image of the edge between the talent and the background. This can be done by adjusting either the luminance of the pixels in the edge, their color or both.

If the talent was filmed in much lighter or much darker conditions than are suitable for compositing with the background then a light or dark halo may appear around the edge of the talent in the composited image. The user may thus wish to alter the luminance of the pixels at the edge. Regarding the chrominance of the edge pixels, very often the blue screen is reflected onto the hair and skin of the talent in a way which is very obvious in the composited image. Thus the color of these pixels is altered to remove the spill.

Thus at step 5901 user-defined parameters are obtained from a GUI and at step 5902 further parameters are calculated. At step 5903 the edge balancing is performed and at step 5904 a question is asked as to whether the user wishes to adjust the parameters. This question is answered in the affirmative by the user selecting a parameter. The parameter is then altered at step 5905, after which control is returned to step 5902. The questions is answered in the negative by the user selecting a button indicating that the edge balancing is complete, in which case step 505 is concluded. The final composited image data can then saved at step 506 and the keying application is finished.

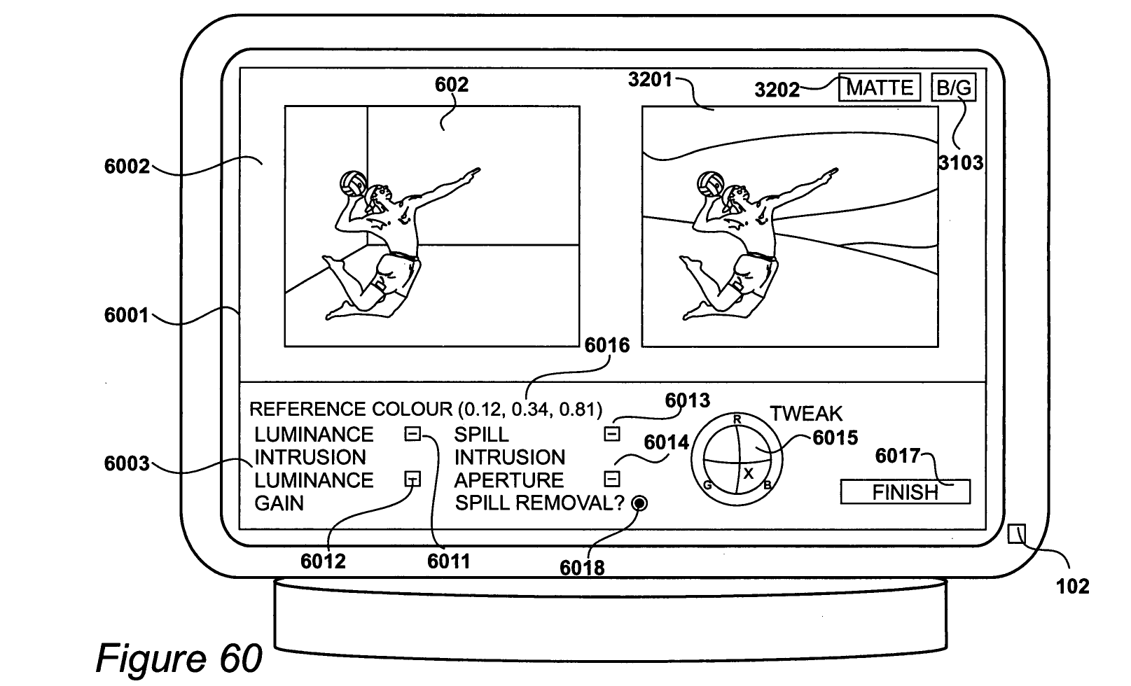

FIG. 60

FIG. 60 shows a GUI 6001 displayed to the user during edge balancing step 505. As usual, it contains a first area 6002 that includes foreground data 602 and composite image 3201. Icons 3202 and 3103 allow the user to display the matte or background image respectively.

The second area 6003 of the GUI includes user defined parameters 6011 representing luminance intrusion, 6012 representing luminance gain, 6013 representing spill intrusion and 6014 representing aperture. Tweak parameter 6015 comprises two-dimensional chrominance data that is used for the chrominance edge balancing. It is provided by a user-controlled widget. The reference color is specified at 6016 and a button 6017 allows the user to indicate that he has completed the edge balancing step and thus the keying application.

Parameters 6011 and 6012 control the luminance edge balancing while parameters 6013 to 6015 control the blue spill removal and chrominance edge balancing. A value of zero for luminance gain parameter 6012 means that no luminance edge balancing is carried out. Spill removal radar button 6018 is deselected to indicate that luminance balancing only should be performed. If that occurs then parameters 6013, 6014 or 6015 are set to zero and the user is unable to change this unless the radar button 6018 is reselected.

Luminance intrusion parameter 6011 specifies a frontier in the color space to determine by how much a pixel should be luminance edge balanced and chrominance edge balanced, with the spill intrusion parameter 6013 providing a similar frontier for spill removal. The luminance frontier is specified relative to the spill frontier and so a luminance intrusion of zero indicates that the luminance and spill frontiers are identical.

Blue spill removal involves de-saturating, to a greater or lesser extent, colors that are close to the reference color. Thus the effect of the blue spill removal is to transform the reference color to the grey having the same luminance. However, it is possible for the user to specify a slightly different chrominance for the transformed reference color, as this sometimes provides a more natural effect. Tweak parameter 6015 provides this input.

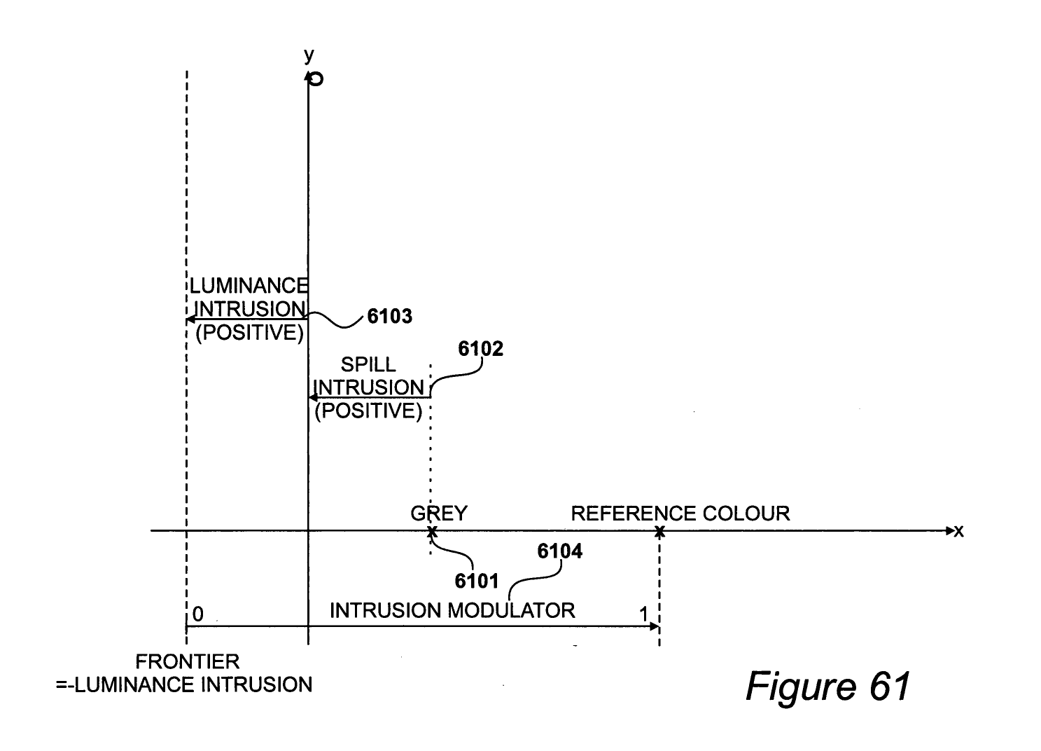

FIG. 61

The transformation used during edge balancing is illustrated in FIG. 61. In this illustration the co-ordinate system is viewed down the z-axis which is thus not visible. Firstly, the reference color is transformed into PbPrY co-ordinates and then rotated such that it is on the x-axis. However unlike the matte extraction, where the reference color is moved to the origin, it is moved along the x-axis by the value of the spill intrusion parameter 6013. Thus the line representing shades of grey, which comes out of the page as shown at 6101, is on the x-axis but no longer at the origin. The transformation has the effect of placing the spill frontier on the y-axis. A pixel's transformed x and y positions determine how much spill removal is applied to it.

The luminance intrusion parameter 6011 is an offset from the spill intrusion. As shown by arrows 6102 and 6103, increasing the value of either intrusion parameter moves the frontiers away from the reference color.

An absolute frontier is defined as the leftmost of the luminance frontier and the spill frontier. In the example shown in FIG. 61 this is the luminance frontier, which has the value of the luminance intrusion parameter 6011 multiplied by minus-one. Only pixels having transformed x values to the right of this frontier are edge balanced.

A further parameter, intrusion modulator parameter 6104, is a measurement along the x-axis from the luminance frontier to the reference color, scaled such that the luminance frontier is at zero and the reference color is at one. This is used to affect how much luminance edge balancing and chrominance edge balancing is carried out.

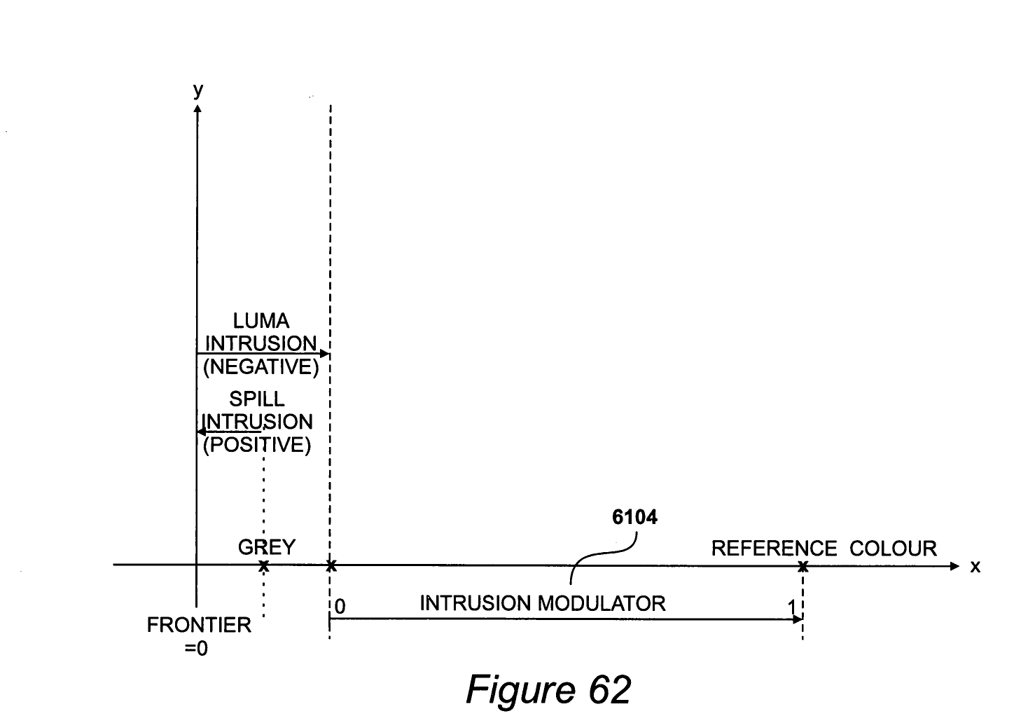

FIG. 62

FIG. 62 illustrates another example of the transformation used in the edge balancing. In this example, the luminance intrusion parameter 6011 is negative and spill intrusion parameter 6013 is positive. Again the spill frontier is placed on the y-axis and the luminance frontier is therefore at minus one multiplied the luminance intrusion parameter 6011. However, since in this case the spill frontier is on the left of the luminance frontier the absolute frontier is the spill frontier, which has an x value of zero. Again the intrusion modulator 6104 measures from the luminance frontier, where it takes the value zero, to the reference color, where it takes the value one.

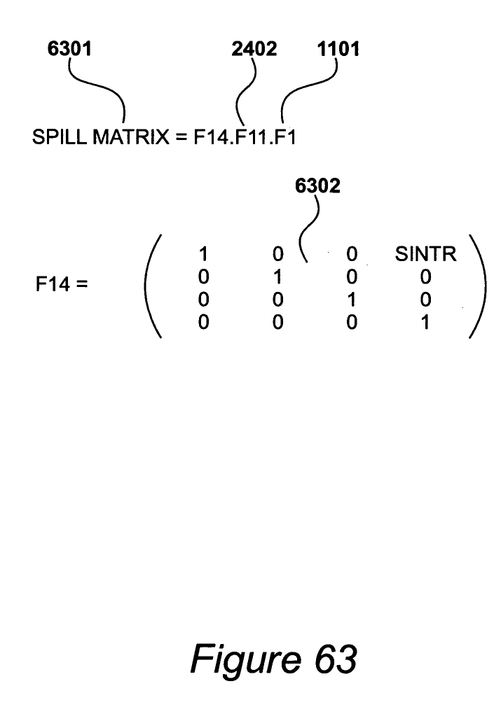

FIG. 63

FIG. 63 shows the construction of spill matrix 6301, which is the transformation that when applied to the reference color places it as shown in FIGS. 61 and 62.

Matrix 6301 is a concatenation of firstly matrix 1101, which transforms RGB into PbPrY values, then matrix 2402 which is a rotation about the z-axis that places the reference color on the x-axis. Finally, matrix 6302 is applied which is a translation along the x-axis by the spill intrusion parameter 6013.

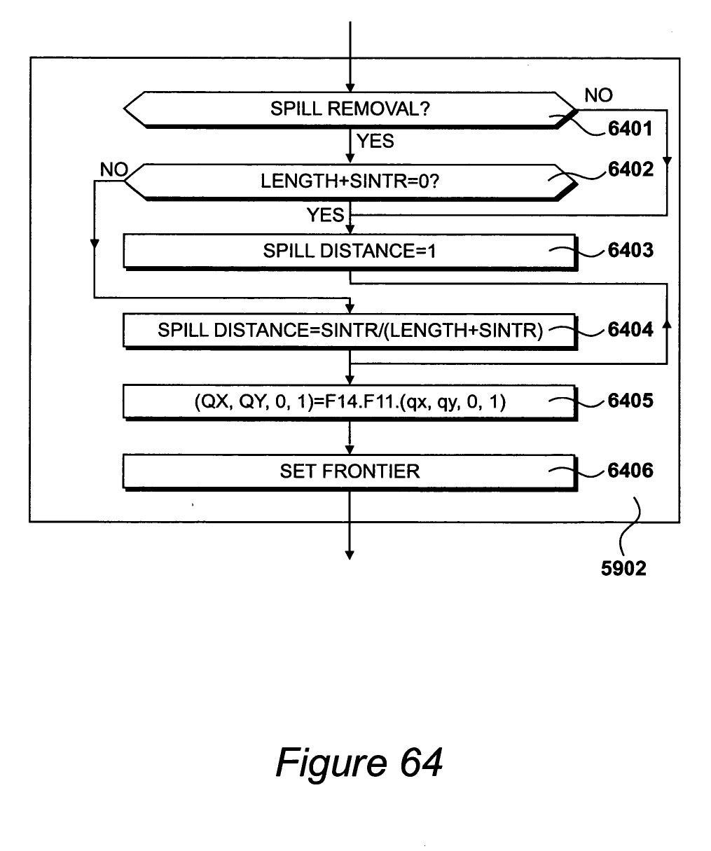

FIG. 64

FIG. 64 details step 5902 at which further parameters required for edge balancing are calculated. At step 6401 a question is asked as to whether spill removal is to be carried out, according to the state of radar button 6018. If this is answered in the negative then a further parameter known as spill distance need not be calculated and is set to one at step 6403. If it is answered in the affirmative then at step 6402 a further question is asked as to whether the sum of spill intrusion parameter 6013 and the length 2302 of the reference color, calculated at step 2503, is equal to zero. If this question is answered in the affirmative then spill distance is again set to one at step 6403. If it is answered in the negative then at step 6404 the spill distance is set to the value of spill intrusion parameter 6013 divided by the sum of length 2302 and the value of spill intrusion parameter 6013. The spill distance is therefore the value by which the x value of the reference color must be multiplied in order to make the reference color grey (it already has a y value of zero). If the sum of the length and the spill intrusion is zero then the reference color is at the origin. Thus it does not matter what the spill distance is and so it is set to one at step 6403.

After the spill distance is set then at step 6405 tweak parameter 6015 is transformed. The parameter has two values provided by the two-dimensional widget. Therefore qx and qy are set as the x and y values of a point that is transformed first by rotation matrix 2402 and then by translation matrix 6302. There is no need for them to be first transformed by matrix 1101 since they are already PbPrY co-ordinates. The x and y values of this output are set as QX and QY.

Finally, at step 6406 the frontier is set to be the leftmost of the luminance frontier and the spill frontier, which is the y-axis.

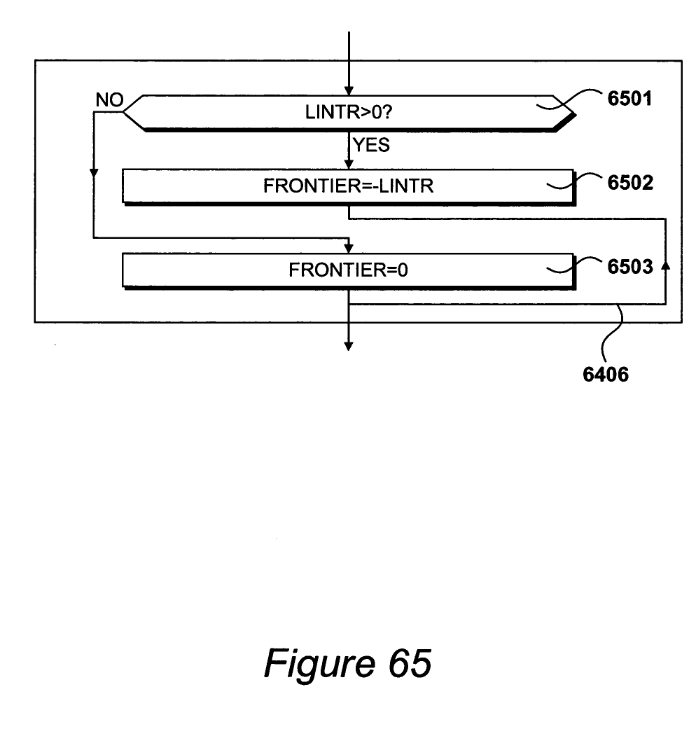

FIG. 65

FIG. 65 details step 6406 at which the frontier is set. At step 6501 a question is asked as to whether the luminance intrusion parameter 6011 is greater than zero. If this question is answered in the affirmative then the luminance frontier is on the left of the y-axis and so at step 6502 the frontier is set to be the luminance intrusion parameter 6011 multiplied by minus one, ie the luminance frontier. If the question asked at step 6501 is answered in the negative then the luminance frontier is on the right of the y-axis and so at step 6503 the frontier is set to zero.

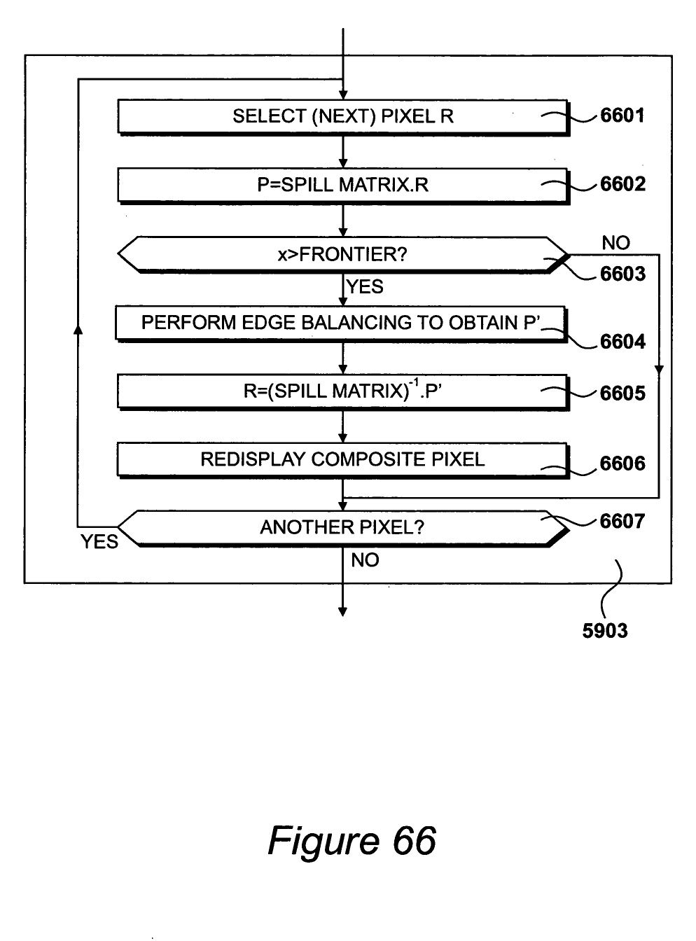

FIG. 66

FIG. 66 details step 5903 at which the edge balancing is carried out on the composite image. At step 6601 a first pixel in the foreground image is selected and at step 6602 it is transformed by spill matrix 6301. At step 6603 a question is asked as to whether its transformed x value is greater than the frontier set at step 6406. If this question is answered in the negative then no edge balancing is to be carried out and control is directed to step 6607 where a question is asked as to whether there is another pixel in the foreground image. If it is answered in the affirmative then at step 6604 the transformed pixel is modified by performing edge balancing. At step 6605 the modified pixel is multiplied by the inverse of matrix 6301 to return it to RGB values and at step 6606 the new pixel value is used to redisplay the pixel in that position in the composite image.

At step 6607 a question is asked as to whether there is another pixel in the foreground image. If this question is answered in the affirmative then control is returned to step 6601 and the next pixel is selected, while if it is answered in the negative then step 5903 is concluded since all the pixels have been processed.

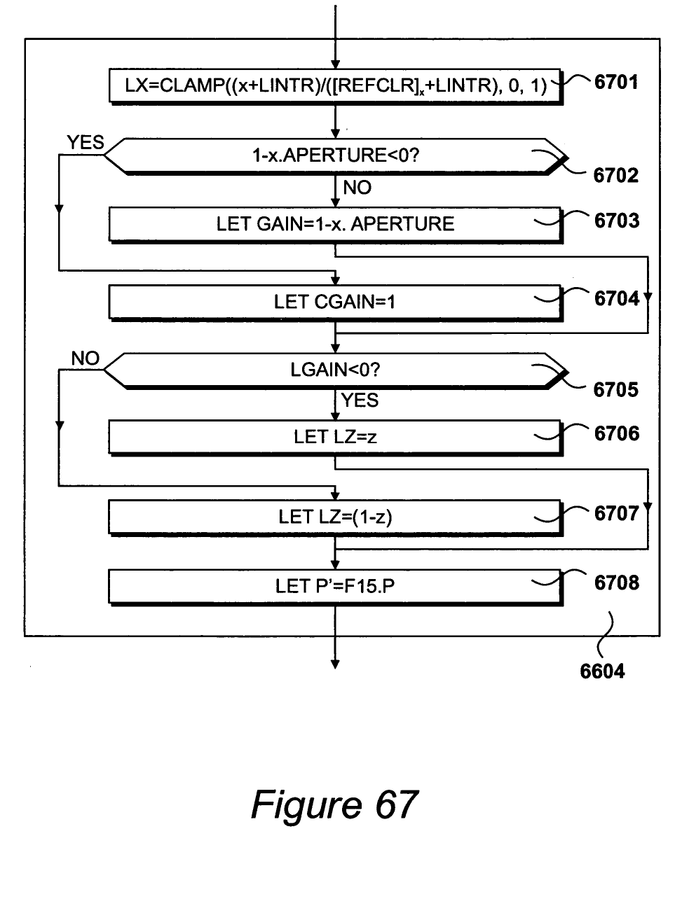

FIG. 67

FIG. 67 details step 6604 at which the edge balancing is performed on a transformed selected pixel. At step 6701 the pixel's intrusion modulator 6104 is measured. This is defined as the transformed x value of the pixel added to luminance intrusion parameter 6011, all divided by the x value of the transformed reference color added to luminance intrusion parameter The result is clamped between zero and one. Thus this parameter measures how far a pixel is along the x-axis between the luminance frontier and the reference color.

At step 6702 a question is asked as to whether the transformed x value of the pixel multiplied by the aperture, all subtracted from one, is less than zero. If this question is answered in the negative then at step 6703 a parameter CGAIN is set to be the transformed x value multiplied by aperture parameter 6014, all subtracted from one. If it is answered in the affirmative then the parameter cgain is set to one at step 6704. Clearly, this parameter will also be one if aperture parameter 6014 is zero (which it is if no blue spill is to be removed).

At step 6705 a question is asked as to whether luminance gain parameter 6012 is less than zero. If this is answered in the affirmative then a value LZ is set to be the transformed z value of the pixel, whereas if it is answered in the negative then at step 6707 it is set to be one minus the transformed z value.

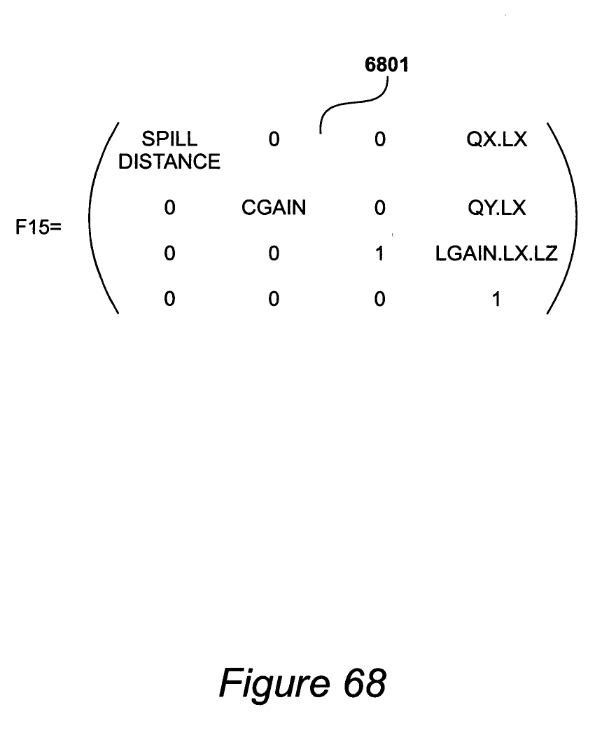

At step 6708 the edge balancing is finally performed on the transformed pixel by multiplying it by matrix F15, which is shown in FIG. 68 as matrix 6801.

FIG. 68

FIG. 68 shows matrix 6801. This is the edge balancing transformation performed on a pixel that has been transformed into the space shown in FIG. 61. As can been seen, the pixel's x value is multiplied by the spill distance and its y value is multiplied by the parameter CGAIN. The parameter QX multiplied by the intrusion modulator 6104 is added to the x value and the value of QY multiplied by the intrusion modulator 6104 is added to the y value. To the z value is added the product of luminance gain parameter 6012, intrusion modulator 6104 and the parameter LZ.

Thus if the luminance gain parameter 6012 is set to zero no edge balancing is carried out. Likewise, if no spill removal is to be performed then the parameters of spill distance and CGAIN are set to one, and QX and QY are zero, leading to no modification of a pixel's chrominance data.

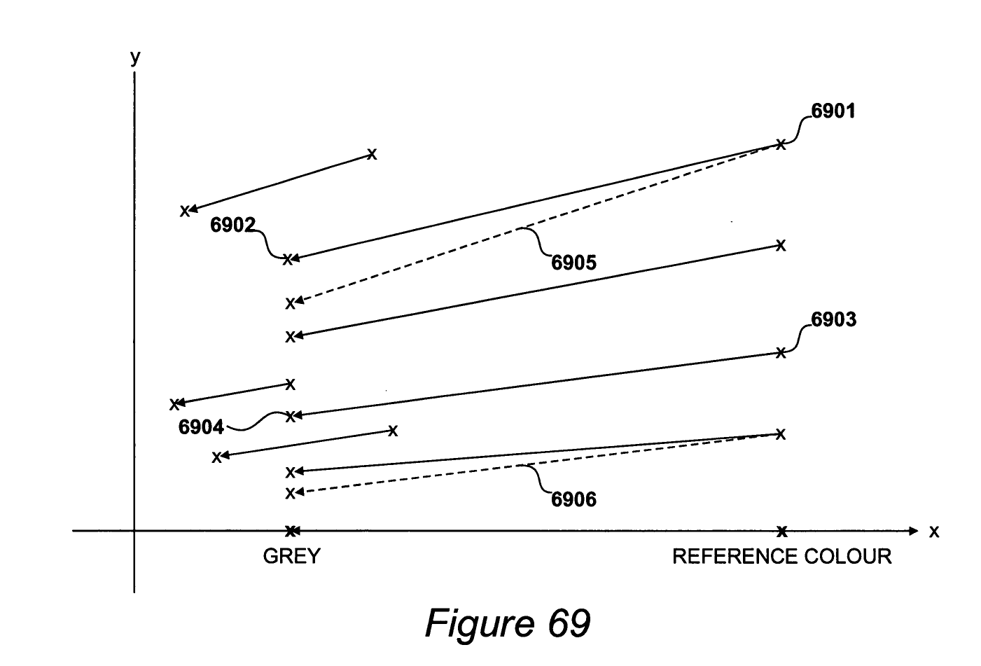

FIG. 69

FIG. 69 shows the effect of spill removal on pixels that have been transformed using spill matrix 6301. Each transformed pixel is moved to a new position as shown by the unbroken arrows. As can be seen, the chrominance values of the pixel change by being moved down the x-axis by the factor spill distance and down the y-axis by the factor CGAIN. The higher a pixel's transformed x and y values, the further it moves. For example, pixel 6901 is moved to pixel 6902 which is clearly further down the y-axis from pixel 6901 than the distance between pixels 6903 and 6904.

Dotted lines 6905 and 6906 show the effect of increasing aperture parameter 6014. As can be seen, it affects pixels with larger transformed y values by more than those with smaller transformed y values. Since, after spill matrix 6301 is applied to a pixel, its x value gives a rough indication of how much blue is in the color and its y value a rough indication of how much red, the spill removal removes a large amount of blue, depending on how blue the pixel is, and a smaller amount of red.

The effect of the chrominance edge balancing is not shown in FIG. 69, but it is to move a pixel slightly from its balanced position depending upon how far along the x axis it is.

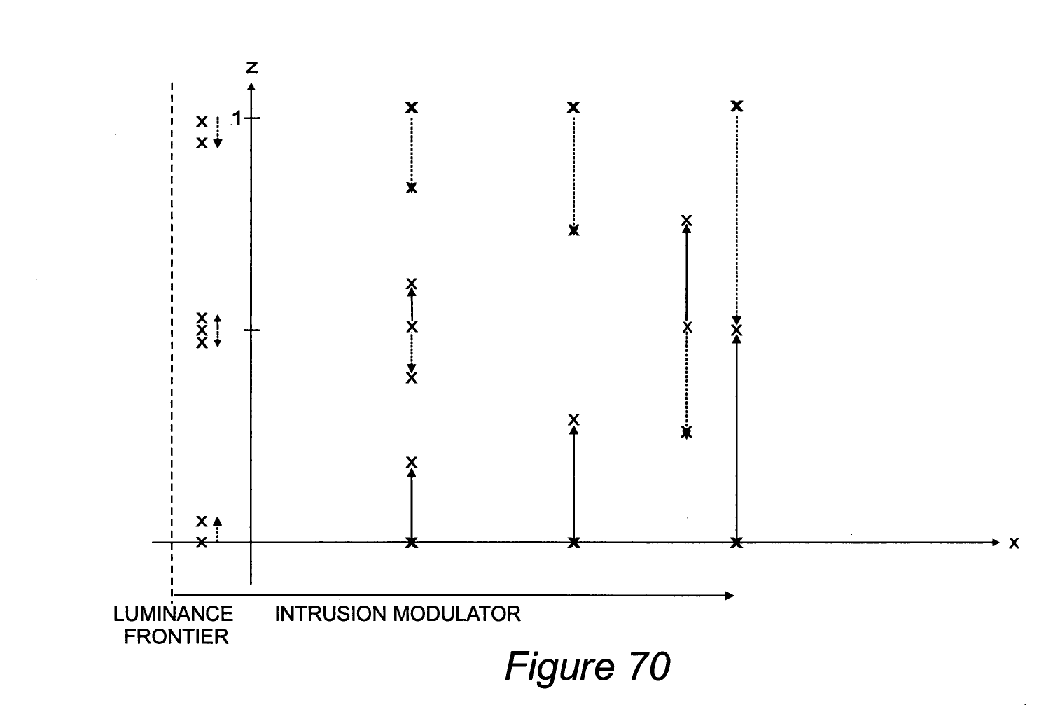

FIG. 70

FIG. 70 shows the effect of the luminance edge balancing on pixels. The unbroken arrows indicate, for example, a luminance gain parameter 6012 value of 0.5, while the dashed arrows indicate a value of −0.5. Thus it can be seen that when the luminance gain parameter 6012 is positive the pixels with higher luminance are affected less than those with lower luminance, and vice versa when it is negative. Also, a pixel's luminance is changed more if it has a higher transformed x value.

This concludes the discussion of edge balancing step 505 and thus the discussion of the keying application 401.

I claim:

1. An apparatus for processing image data comprising processing means, display means and input means, wherein said image data comprises pixel values defined in a three-dimensional space, wherein said processing means is configured to:
receive, from said input means, a parameter value indicating a color transformation to be applied to image data;
concatenate said transformation with previous transformations applied to said image data;
apply said concatenated transformations to said pixel values;
obtain first updated values by evaluating the values of further parameters; and
display, on said display means, said first updated values.

2. Apparatus according to claim 1, wherein said processing means is configured to concatenate said transformation with said previous transformations by applying a first matrix containing said transformation to a second matrix containing said previous transformations.

3. Apparatus according to claim 1, wherein said processing means is configured to concatenate said transformation with said previous transformations by applying a first matrix containing said concatenated transformations to a second matrix containing said transformation, and said processing means is further configured to:
obtain second updated values by evaluating the values that certain of said further parameters would take if said previous transformations were applied to said pixel values; and
modify said second matrix using said second updated values before applying said concatenated transformations to said pixel values.

4. Apparatus for extracting a matte from image data comprising processing means, display means and input means, wherein said image data comprises a plurality of pixels, each pixel having three values that define it in three-dimensional space, wherein said processing means is configured to:
receive, from said input means, an indication of a reference color; and
calculate a transformation that transforms said reference color to the origin of said three-dimensional space; and
apply said transformation to each of said plurality of pixels, such that each said pixel can be assigned a matte value according to its transformed values, and therefore according to its position with respect to the specified reference color.

5. Apparatus according to claim 4, wherein said processing means is additionally configured to:
receive, from said input means, an indication of a first parameter value, and
calculate said transformation such that, in addition to said reference color being transformed to the origin, the point that is on the line joining said specified reference color and the grey of equal luminance, and is at a distance specified by said first parameter value from said grey, is transformed to a point on one of the axes of said three-dimensional space at a distance of one from the origin.

6. Apparatus for extracting a matte from image data comprising processing means, display means and input means, wherein said image data comprises a plurality of pixels, each pixel having three values that define it in three-dimensional space, wherein said processing means is configured to:
receive, from said input means, an indication of a reference color and parameter values;
calculate, using certain of said parameter values, a transformation that transforms said reference color to a specified point in said space;
apply said transformation to every pixel in said image data to obtain a first, second and third transformed value; and, for each pixel:
calculate a first number that is a function of said first transformed value and a first selection of said parameters,
calculate a second number that is a function of said first and second transformed values and a second selection of said parameters,
calculate a third number that is a function of said third transformed value and a third selection of said parameters, and
sum said first, second and third numbers to calculate a matte value for said pixel.

7. Apparatus for processing image data comprising processing means, display means and manual input means, wherein said image data comprises a plurality of pixels, each pixel having three values that define it in three-dimensional space and a fourth value that defines a matte and is a function of a plurality of parameters, wherein said processing means is configured to:
receive, from said manual input means, an indication of at least one of said plurality of pixels;
calculate, for certain of said parameters, the impact that a change in said parameter will have on said pixel;
select a specified number of said parameters that have the highest impact; and
provide an indication, on said display means, of said selected parameters.

8. Apparatus for processing image data comprising processing means, display means and manual input means, wherein said image data comprises pixels, each pixel having three values that define it in three-dimensional space and a fourth value that defines a matte calculated with respect to a specified reference color, wherein said processing means is configured to:
receive an indication, via said manual input means, of a plurality of pixels;
calculate a volume in the space that includes all of the three-dimensional values of said plurality of pixels;
for each of said pixels in said image data, determine whether it is inside said volume; and
for each pixel inside said volume, modify the matte value of said pixel according to a specified rule.

9. Apparatus according to claim 8, wherein said processing system is further configured to select said specified rule from a plurality of rules according to the positions of said plurality of pixels within said three-dimensional space.

10. Apparatus according to claim 9, wherein said processing system is configured to select said specified rule by calculating a distance from said specified reference color to each of said plurality of pixels.

11. Apparatus according to claim 8, wherein said specified rule reduces the matte value of said pixel according to its position within said volume.

12. Apparatus for processing image data comprising processing means, display means and manual input means, wherein said image data comprises a plurality of pixels, each pixel having three values that define it in three-dimensional space, wherein said processing means is configured to:
apply a first transformation, if necessary, to each of said pixels to obtain transformed pixel values, such that a first and second of said transformed pixel values indicate chrominance of the pixel;
define a first frontier in said three-dimensional space using a first parameter;
for each transformed pixel, calculate a first distance variable that indicates its position in said space with respect to said first frontier;
determine a second transformation that must be applied to the first and second transformed values of a specified reference color in order to change its color to a grey of equal luminance;
obtain further transformed pixels by applying said second transformation to each of said transformed pixels in a proportion determined by its first distance variable; and
apply the inverse of said first transformation to each of said further transformed pixels if said first transformation was applied.

13. Apparatus according to claim 12, wherein said first transformation is calculated such that the second transformed value of said specified reference color is zero, and wherein for each pixel said first distance variable is a function of its first transformed value only.

14. Apparatus according to claim 12, wherein said second transformation additionally transforms each of said transformed pixel values according to its chrominance values, a second parameter and a third parameter.

15. Apparatus according to claim 12, wherein said processing system is additionally configured to:
define a second frontier according to a fourth parameter,
for each transformed pixel, calculate a second distance variable that indicates its position in said space with respect to said second frontier and the transformed values of said specified reference color; and
obtain still further transformed pixels by applying a third transformation to said further transformed pixels, wherein said third transformation changes said first and second further transformed values according to a fifth parameter and said second distance, wherein said fifth parameter comprises two-dimensional data,
before applying said inverse of said first transformation to said still further transformed pixels.

16. Apparatus for processing image data comprising processing means, display means and manual input means, wherein said image data comprises a plurality of pixels, each pixel having three values that define it in three-dimensional space, wherein said processing means is configured to:
apply a first transformation, if necessary, to each of said pixels to obtain transformed pixel values, such that a first of said transformed pixel values indicates luminance of the pixel;
define a frontier in said three-dimensional space using a first parameter;
for each transformed pixel, calculate a distance variable that indicates its position with respect to said frontier and the transformed values of a specified reference color,
obtain further transformed pixels by applying a second transformation to each of said transformed pixels according to its first transformed value, a second parameter and said distance variable; and
apply the inverse of said first transformation to each of said further transformed pixels if said first transformation was applied.

17. Apparatus according to claim 16, wherein said first transformation is calculated such that a second transformed value of said specified reference color is zero, said and wherein for each pixel said distance variable is a function of its third transformed value only.

18. Apparatus for processing image data comprising processing means, display means and manual input means, wherein said image data comprises pixels, each pixel having three values that define it in three-dimensional space, wherein said processing means is configured to:
apply a first transformation, if necessary, to each of said pixels in said image data to obtain transformed pixel values, such that a first and second of said transformed pixel values indicate chrominance of the pixel and a third indicates luminance;
define a first frontier in said three-dimensional space using a first parameter and a second frontier in said three-dimensional space using a second parameter;
define one of said first and second frontiers as an absolute frontier;
for each of said plurality of transformed pixels, calculate a first distance variable that indicates its position in space with respect to said first frontier;
and calculate a second distance variable that indicates its position in said space with respect to said second frontier and the transformed values of said specified reference color;
determine a second transformation that must be applied to the first and second transformed values of a specified reference color in order to change its color to a grey of equal luminance;
determine a third transformation that has the effect of:
applying said second transformation in a proportion determined by said first distance variable,
additionally transforming a pixel's chrominance values according to its first distance variable, its chrominance values, a second parameter and a third parameter, and
transforming a pixel's luminance value according to its luminance value, a fourth parameter and said second distance variable;
obtain further transformed pixels by applying said third transformation to each transformed pixel depending on its position with respect to said absolute frontier;
apply the inverse of said first transformation, if said first transformation was applied, to each of said further transformed pixels.

19. Apparatus according to claim 18, wherein said first transformation is calculated such that the second transformed value of said specified reference color is zero, said and wherein for each pixel said first distance variable is a function of its first transformed value only.

20. Apparatus according to claim 18, wherein said processing system is additionally configured to:
obtain still further transformed pixels by applying a fourth transformation to each further transformed pixel depending on its position with respect to said absolute frontier, wherein said fourth transformation further changes said chrominance values according to a fifth parameter and said second distance, wherein said fifth parameter comprises two-dimensional data,
before applying said inverse of said first transformation to said still further transformed pixels.
